(19) United States
(12) Patent Application Publication
(10) Pub. No.: US 2016/0326271 A1
(43) Pub. Date: Nov. 10, 2016

(54) HYDROGENATED NITRILE RUBBER CONTAINING PHOSPHINE SULFIDE OR DIPHOSPHINE SULFIDE

(71) Applicant: ARLANXEO DEUTSCHLAND GMBH, Dormagen (DE)

(72) Inventor: WERNER OBRECHT, MOERS (DE)

(21) Appl. No.: 15/108,935

(22) PCT Filed: Dec. 29, 2014
(86) PCT No.: PCT/EP2014/079377

§ 371 Date: Jun. 29, 2016

(30) Foreign Application Priority Data
Dec. 30, 2013 (EP) 13199839.5

(51) Int. Cl. C08C 2/04; C08J 3/24; C08C 19/02

(52) U.S. Cl. CPC C08C 2/04; C08C 19/02; C08J 3/24; C08J 2315/00

(57) ABSTRACT

The invention relates to novel hydrogenated nitrile rubbers containing phosphine sulphides and/or diphosphate sulphides, to a process for production thereof, vulcanizable mixtures based on the hydrogenated nitrile rubbers, and to vulcanizates obtained in that way. The hydrogenated nitrile rubbers feature a very good profile of properties, especially with regard to the stress values at different elongations and the compression set after storage at high temperatures.

The invention relates to hydrogenated nitrile rubbers which have either zero contents or a reduced contents of phosphines or diphosphines and additionally contain phosphine sulphide or diphosphine sulphide, to a process for production thereof, to vulcanizable mixtures based on these hydrogenated nitrile rubbers, and to vulcanizates obtained in that way.

Nitrile rubbers are co- and terpolymers of at least one unsaturated nitrile monomer, at least one conjugated diene and optionally one or more copolymerizable monomers. Processes for producing nitrile rubber and processes for hydrogenating nitride rubber in suitable organic solvents are known from the literature (e.g. Ullmann's Encyclopedia of Industrial Chemistry, VCH Verlagsgesellschaft, Weinheim, 1993, p. 255-261 and p. 320-324).

Hydrogenated nitrile rubber, abbreviated to “HNBR”, as understood to mean rubbers which are obtained from nitrile rubbers, abbreviated to “NBR” by hydrogenation. Correspondingly, in HNBR, the C═C double bonds of the copolymerized diene units are fully or partly hydrogenated. The hydrogenation level of the copolymerized diene units is typically within a range from 50 to 100%. Those skilled in the art refer to “fully hydrogenated types” even when the residual double bond content (“RDB”) is not more than about 0.9%. The HNBR types commercially available on the market typically have a Mooney viscosity (ML 1+4 at 100° C.) in the range from 10 to 120 Mooney units.

Hydrogenated nitrile rubber is a specialty rubber having a very good heat resistance, very good resistance to ozone and chemicals and excellent oil resistance. The aforementioned physical and chemical properties of HNBR are combined with very good mechanical properties, especially a high abrasion resistance.

Because of this profile of properties, HNBR has found wide use in a wide variety of different areas of application. HNBR is used, for example, for seals, hoses, drive belts, cable sheaths, roller coverings and damping elements in the automotive sector, and also for stators, well seals and valve seals in the oil production sector, and for numerous parts in the aviation industry, the electrical industry, in mechanical engineering and in shipbuilding.

A major role is played by vulcanizates of hydrogenated nitrile rubber having a high modulus level (measured as the stress value at various elongations) and low compression set, especially after long storage periods at high temperatures. This combination of properties is important in fields of use in which high resilience forces are required to ensure that the rubber articles will function both under static and under dynamic stress, including after long periods and possibly high temperatures. This applies especially to different seals such as O-rings, flange seals, shaft sealing rings, stators in rotor/stator pumps, valve shaft seals, gasket sleeves such as axle, boots, hose seals, engine bearings, bridge bearings and well seals (blowout preventers). In addition, vulcanizates having a high modulus are important, for example, for articles under dynamic stress, especially for belts such as drive belts and control belts, for example toothed belts, and also for roller coverings.

The level obtained to date in the mechanical properties of HNBR-based vulcanizates, especially in relation to the modulus level and compression set, is still unsatisfactory.

For the hydrogenation of nitrite rubber with homogeneously soluble rhodium and/or ruthenium hydrogenation catalysts, the addition of phosphines or diphosphines as a cocatalyst has been found to be useful. Preference is given to the use of triphenylphosphine (“TPP”). This use of a cocatalyst has a number of positive effects: a reduction in the pressure needed for the hydrogenation is enabled; in addition, an increase, in the hydrogenation rate (space/time yield) and a reduction in the amount of hydrogenation catalyst needed for the hydrogenation can be achieved. However, residual amounts of the phosphine or diphosphine remaining in the hydrogenated nitrite rubber have adverse effects on the vulcanizate properties, especially the modulus level and compression set.

DE 25 39 132 A describes a process for hydrogenating random acrylonitrile/butadiene copolymers. For the hydrogenation, the complex of a mono- or trivalent rhodium(I) halide is used in combination with 5 to 25% by weight of triphenylphosphine, with use of 10 phr of triphenylphosphine in each of the examples. DE 25 39 132 A does not vary the amount of triphenylphosphine. Nor are any vulcanizates produced on the basis of these hydrogenated nitrile rubbers or characterized with respect to the properties. DE 25 39 132 A does not give any figures for the contents of triphenylphosphine that remain in the worked-up hydrogenated nitrile rubber after the hydrogenation. Nor is there any examination, moreover, of whether and, if so, what influence TPP has on the properties, especially the modulus level and compression set of vulcanizates produced therefrom. Furthermore, there is no indication whatsoever as to the removal of the TPP used in the hydrogenation.

In U.S. Pat. No. 4,965,323, the compression set of HNBR-based vulcanizates which are obtained by peroxidic vulcanization or by sulphur vulcanization is improved by contacting the nitrile rubber after the polymerization or after the hydrogenation with an aqueous alkali solution or the aqueous solution of an amine. In example 1, rubber crumbs that are obtained after removal of the solvent are washed in a separate process step with aqueous sodium carbonate solutions of different concentration. The pH of an aqueous THF solution obtained by dissolving 3 g of the rubber in 100 ml of THF and adding 1 ml of water while stirring is used as a measure of the alkali content. The pH is determined by means of a glass electrode at 20° C. For the production of vulcanizates of the hydrogenated nitrile rubber having low compression set, the pH of aqueous THF solution should be >5, preferably >5.5, more preferably >6. In U.S. Pat. No. 4,965,323, there is no pointer to the dependence of compression set on the amount of TPP used in the hydrogenation, or any teaching as to improvement of the compression set by removal of TPP after the hydrogenation.

U.S. Pat. No. 4,503,196 describes a process for hydrogenating nitrile rubber using rhodium catalysts of the (H)Rh(L)₃ or (H)Rh(L)₄ type. L represents phosphine or arsine ligands. It is a feature of the hydrogenation process that no additions of the ligands as cocatalysts are required for the hydrogenation, although the hydrogenation is effected with relatively high amounts of catalyst (2.5 to 40% by weight). For the isolation of the hydrogenated nitrite rubber from the chlorobenzene solution, the hydrogenated solution is cooled and the rubber is coagulated by addition of isopropanol. U.S. Pat. No. 4,503,196 does not give any information about the vulcanizate properties of the hydrogenated nitrile rubbers that result in this process. For this reason, U.S. Pat. No. 4,503,196 does not give any teaching about the production of hydrogenated nitrile rubber, by which vulcanizates having a high modulus level and low compression set are obtained.

DE-A-3 921 264 describes the production of hydrogenated nitrile rubber which, after peroxidic crosslinking, gives vulcanizates having low compression set. For this purpose, ruthenium catalysts of a wide variety of different chemical constitutions are used for the hydrogenation, with use of a solvent mixture of a C₃-C₅ ketone and a secondary or tertiary C₃-C₆ alcohol in the hydrogenation. The proportion of the secondary or tertiary alcohol in the solvent mixture is said to be 2 to 60% by weight. According to DE-A-3 921 264, two phases can be formed during the hydrogenation or in the course of cooling of the hydrogenated solution. As a consequence, the desired hydrogenation levels are not attained and/or the hydrogenated nitrile rubber gelates during the hydrogenation. The process described in DE-A-3 921 264 is not broadly applicable, since the phase separation which takes place in the course of the hydrogenation and the gelation depends on various parameters in an unpredictable manner. These include the acrylonitrile content and the molar mass of the nitrile rubber feedstock, the composition of the solvent mixture, the solids content of the polymer solution in the hydrogenation, the hydrogenation level and the temperature in the hydrogenation. In the course of cooling of the polymer solution after the hydrogenation or in the course of storage of the polymer solution too, there may be unexpected phase separation and contamination of the corresponding plant components or vessels.

WO-A-2004/101671 shows that hydrogenated carboxylated nitrile/butadiene rubber containing TPP in molecular dispersion can be used advantageously as a crosslinker for elastomers or plastics and as adhesives. On the basis of WO-A-2004/101671, in which the necessity of the presence of TPP is explicitly pointed out, no teaching as to the improvement of compression set and moduli of vulcanizates can be inferred.

EP-A-1 894 946 describes a process for metathesis degradation of NBR, in which the activity of the metathesis catalyst is enhanced by TPP additions. Based on the metathesis catalyst, 0.01 to 1 equivalent of phosphine, for example TPP, is used. Nitrile rubbers of reduced molecular weight prepared in this way can, according to EP-A-1 894 946, be hydrogenated using methods known from the prior art. The catalyst used may, for example, be the Wilkinson catalyst in the presence of cocatalysts such as TPP. There is no information about the vulcanizate properties and the optimization thereof, especially with regard to the level of modulus and compression set of the hydrogenated nitrile robbers obtained in the hydrogenation.

Nor does EP-A-1 083 197 describe any measures for reducing the compression set for vulcanizates which are used for production of roller coverings. The aim is achieved by using the methacrylates of polyhydric alcohols, e.g. trimethylolpropane trimethacrylate, in the production of the rubber mixtures. Nor does EP-A-1 083 197 give any pointer to improvement of the compression set or moduli by eliminating the harmful influence caused by triphenylphosphine.

EP-A-1 524 277 describes an ultrafiltration process for removing low molecular weight constituents from rubbers. For this purpose, the rubbers are dissolved in an organic solvent and subjected to an ultrafiltration process. The process is suitable both for removal of emulsifier residues from nitrile rubber and for removal of catalyst residues from hydrogenated nitrile rubber. According to Example 2 of EP-A-1 524 277, it is possible with the aid of this method to reduce the phosphorus content of hydrogenated nitrile rubber from 1300 mg/kg to 120 mg/kg, EP-A-1 524 277 does not give any information as to whether this process, which is additionally costly in economic terms, enables an improvement in the modulus level and compression set of vulcanizates of hydrogenated nitrile rubbers.

EP-A-0 134 023 describes a process for hydrogenating NBR with 0.05 to 0.6% by weight, based on rubber solids, of tris(triphenylphosphine)rhodium(I) halide as catalyst, in which not more than 2% by weight, likewise based on rubber solids, of triphenylphosphine is added. The examples in Table 3) show that an increase in the amount of triphenylphosphine to up to 5% by weight leads to a deterioration in important properties of peroxidically vulcanized hydrogenated nitrile rubbers. For instance, there is a decrease in the modulus values at 100%, 200% and 300% elongation, and in the hardness at 23° C. There is an increase in the elongation at break and compression set values after storage at 23° C. for 70 h, at 125° C. for 70 h and at 150° C. for 70 h. In order to limit the harmful influence of triphenylphosphine, according to the teaching of EP-A-134 023, the amount of TPP used in the hydrogenation is restricted. Disadvantageously, it is then necessary in this hydrogenation, for the purpose of achieving equal hydrogenation times, to use higher amounts of catalyst and hence of costly rhodium metal EP-A-0 134 023 does not give any teaching as to the removal of the TPP after the hydrogenation.

In U.S. Pat. No. 5,244,965, nitrile rubber is hydrogenated using tetrakis(triphenylphosphine)hydridorhodium in the presence of considerable molar excesses of TPP. Because of suspected adverse effects of TPP on the properties of the vulcanized rubber (page 1 lines 26-28: “Furthermore, there is some indication that phosphines cause problems with polymer vulcanization”), TPP is removed after the hydrogenation of the rubber solution. For this purpose, TPP is converted to the corresponding phosphonium salts with addition of equimolar amounts of organic halogen compounds suitable for formation of triphenylphosphonium salts, especially methyl bromide, ethyl bromide, benzyl chloride or benzyl bromide, at temperatures of 70° C.-320° C. within a period of 4-8 h. In the course of cooling of the polymer solution down to 20° C. to 40° C., the phosphonium salts precipitate out and are subsequently separated mechanically from the polymer solution by filtration or by sedimentation. It is shown that triphenylphosphine oxide is present both in the hydrogenated nitrile rubber produced in accordance with the invention and in the corresponding comparative experiment, which has been produced without additions of organic halides. The process described in U.S. Pat. No. 5,244,965 is disadvantageous from an economic point of view, since long tank occupation times are required for the conversion of the TPP to the triphenylphosphonium salt. Moreover, the separation of the phosphonium salt from the high-viscosity polymer solution by sedimentation or filtration is complex in terms of process technology. Secondly, it is not advantageous that the mixture has to be cooled and also diluted in order to separate out the triphenylphosphonium salt formed. Triphenylphosphonium halide additionally crystallizes in an irreproducible manner. It is often obtained in very finely divided form, which complicates the removal from the solution and causes an incomplete removal from the polymer solution, such that relatively large residual amounts of the triphenylphosphonium halides inevitably remain in the hydrogenated nitrile rubber. This becomes clear in Example 2, Experiments 1) and 2) (Table 1) of U.S. Pat. No. 5,244,965. According to Example 2, for each of Experiments 1) and 2), 5.5 g (20.87 mmol) of TPP are used per 100 g of rubber; the further addition of TPP likewise described in Example 2 is incomprehensible in quantitative terms and cannot be taken into account in a quantitative assessment. In Example 2, Experiment 1), 20.87 mmol of TPP are reacted with 4 ml of methyl bromide. Given a density of 3.97 g/cm³, this corresponds to 35.88 g or 167.3 mmol of methyl bromide (molar mass of methyl bromide: 94.94 g/mol); in other words, in Experiment 1, a good 8-fold molar excess of methyl bromide based on TPP is used. Given quantitative conversion of TPP to triphenylmethylphosphoninm bromide (molar mass: 356.8 g/mol), the result is a theoretical yield of 7.5 g of triphenylmethylphosphoninm bromide. Since, according to Experiment 1), only 3.2 g of triphenylmethylphosphonium bromide are isolated, this corresponds to a yield of 43%. Taking account of the further TPP addition, which reacts with the excess of methyl bromide, the overall yield of isolated triphenylphosphonium bromide according to Example 2, Experiment 1) is well below 40%. According to Example 2, Experiment 2), based on 5.5 g (20.87 mmol) of TPP, 3 ml of ethyl bromide (density: 1.46 g/cm³), corresponding to 4.38 g (40.2 mmol), are used. Likewise without taking account of an unquantifiable further TPP addition, 7.8 g of triphenylethylphosphoninm bromide (molar mass: 371.3 g/mol) are theoretically obtained from 5.5 g of TPP. The yield of 3.7 g described in Example 2, Experiment 2) thus corresponds at most to 47.4% of the theoretical yield. Because of the poor separation efficiency of the triphenylphosphonium bromide in the two experiments in Example 2. In the method for removing TPP described in U.S. Pat. No. 5,244,965, considerable amounts of triphenylphosphonium halides remain in the hydrogenated nitrile rubber, which lead to a deterioration in the vulcanizate properties, especially the corrosivity of seals produced therefrom. In U.S. Pat. No. 5,244,965, no positive influence of the TPP removal on the vulcanizate properties is detected.

In U.S. Pat. No. 5,244,965, Example 3, Table 2, figures are also given for contents of triphenylphosphine and triphenylphosphine oxide (“TPP═O”) in the hydrogenated nitrile rubber, which are summarized in the following table:

| | TPP used in | | TPP in the | TPP═O in the |
|---|---|---|---|---|
| Exper- | hydrogenation | | HNBR isolated | HNBR isolated |
| iment | [% by wt.] | Reagent | [% by wt.] | [% by wt.] |
| 3-1 | 5.5 | C₂H₅Br | 0.75 | 1.41 |
| 3-2 | 5.5 | benzyl | undetected | 0.94 |
| | | bromide | | |
| 3-3 | 5.5 | — | 1.33 | 2.17 |

In U.S. Pat. No. 5,244,965, it remains unclear whether the removal or removability of the triphenylphosphonium salts is connected to the formation of triphenylphosphine oxide, how triphenylphosphine oxide is formed and whether this can be influenced. Furthermore, it remains unclear what influence TPP, triphenylphosphine oxide, phosphonium halides and residual amounts of the organic halides used for the removal have on the vulcanizate properties of hydrogenated nitrile rubbers. Overall, it is not possible to infer from the teaching of U.S. Pat. No. 5,244,965 how vulcanizates of the hydrogenated nitrile rubber having high modulus values and having a low compression set are to be produced.

In spite of extensive literature relating to production of hydrogenated nitrile rubbers, there are no hydrogenated nitrile rubbers available to date that firstly give vulcanizates having a good modulus level and good compression set values and can nevertheless at the same time be produced via hydrogenation processes having short reaction times using phosphine or diphosphine-based cocatalysts with small amounts of catalyst. There are no known hydrogenated nitrile rubbers to date in which the adverse effects of the phosphine or diphosphine cocatalysts used in the hydrogenation on the respective vulcanizate properties, especially on the modulus level and compression set values after storage at high temperatures, can be avoided.

### Problem Addressed by the Present Invention

The problem addressed by the present invention was thus that of providing hydrogenated nitrile rubbers which give rise to vulcanizates having very good moduli and compression set values, the latter especially after storage at high temperatures. The problem addressed by the present invention was also that of providing these hydrogenated nitrile rubbers by an economically viable production process, in which phoshines or diphosphines are used as a cocatalyst in the hydrogenation, but can then be rendered harmless in a suitable manner, without having to remove any great amounts of halides or entrainment thereof into the hydrogenated nitrile rubber.

### Solution

It has been found that, surprisingly, the improved properties of vulcanizates based on hydrogenated nitrile rubbers in the form of very good modulus values and improved compression set values, especially after storage at relatively high temperature, can be achieved when the hydrogenated nitrile rubber has a zero or reduced phosphine or diphosphine content and a particular phosphine sulphide or diphosphine sulphide content. These hydrogenated nitrile rubbers can be obtained in an economic manner by converting the phosphine or diphosphine used in the hydrogenation to phosphine sulphides or diphosphine sulphides after the hydrogenation by reaction with particular sulphur donors. It is surprising that the phosphine sulphide or diphosphine sulphide content does not have any adverse effect on the vulcanizate properties, but actually gives vulcanizates having very good modulus and compression set values.

The present invention provides hydrogenated nitrile rubbers containing
i) a content of phosphines, diphosphines or mixtures thereof, preferably triphenylphosphine, within the range from 0 to 1.0% by weight, preferably from 0 to 0.8% by weight, more preferably from 0 to 0.6% by weight, even more preferably from 0 to 0.5% by weight and especially from 0 to 0.4% by weight, based on the hydrogenated nitrile rubber, and
ii) a content of phosphide sulphides, diphosphine sulphides or mixtures thereof, preferably triphenylphosphine sulphide, in the range from 0.075 to 10% by weight, preferably from 0.1 to 9% by weight, more preferably from 0.2 to 8% by weight, even more preferably 0.3 to 6% by weight and especially from 0.4 to 5% by weight, based on the hydrogenated nitrile rubber.

The present invention further provides vulcanizable mixtures of these hydrogenated nitrile rubbers and processes for producing vulcanizates based thereon, and also the vulcanizates obtainable therewith, especially in the form of shaped bodies.

The present invention further provides a process for producing the inventive hydrogenated nitrile rubbers containing
i) a content of phosphines, diphosphines or mixtures thereof, preferably triphenylphosphine, within the range from 0 to 1.0% by weight, preferably from 0 to 0.8% by weight, more preferably from 0 to 0.6% by weight, even more preferably from 0 to 0.5% by weight and especially from 0 to 0.4% by weight, based on the hydrogenated nitrile rubber, and
ii) a content of phosphine sulphides, diphosphine sulphides or mixtures thereof, preferably triphenylphosphine sulphide, in the range from 0.075 to 10% by weight, preferably from 0.1 to 9% by weight, more preferably from 0.2 to 8% by weight, even more preferably 0.3 to 6% by weight and especially from 0.4 to 5% by weight, based on the hydrogenated nitrile rubber,
   by reacting a hydrogenated nitrile rubber having a content of phosphines, diphosphines or mixtures thereof within a range of 0.15-5% by weight, preferably within the range of 0.25-4.75% by weight, more preferably within the range of 0.3-4.5% by weight, even more preferably within the range of 0.4-4.25% by weight and especially within the range of 0.5-4% by weight, based on the hydrogenated nitrile rubber, with at least sulphur donor having at least two sulphur atoms covalently bonded directly to one another.

Where the term “substituted” is used in the context of this application, this means that a hydrogen atom on a given radical or atom is replaced by one of the groups specified in each case, with the proviso that the valency of the given atom is not exceeded and the substitution leads to a stable compound.

Because of the multitude of chemical formulae used, radicals given the same name or abbreviation are present in various formulae, but have, for the respective formula, only the general, preferred, more preferred or especially preferred meanings mentioned in each case in connection with this formula. If exceptions from the aforementioned principal are to apply, this is mentioned explicitly. Apart from this topic of radicals given the same abbreviation in different formulae, it is possible within the context of this application and invention to combine all the definitions given, in general terms or given within areas of preference, for parameters, definitions or elucidations with one another in any desired manner, i.e. including between the respective areas and areas of preference, and they are considered to be disclosed within this scope.

### Inventive Hydrogenated Nitrile Rubber

The inventive hydrogenated nitrile rubber has
i) a content of phosphines, diphoshines or mixtures thereof, preferably triphenylphosphine, within the range from 0 to 1.0% by weight, preferably from 0 to 0.8% by weight, more preferably from 0 to 0.6% by weight, even more preferably from 0 to 0.5% by weight and especially from 0 to 0.4% by weight, based on the hydrogenated nitrile rubber, and
ii) a content of phosphine sulphides, diphosphine sulphides or mixtures thereof, preferably triphenylphosphine sulphide, in the range from 0.075 to 10% by weight, preferably from 0.1 to 9% by weight, more preferably from 0.2 to 8% by weight, even more preferably 0.3 to 6% by weight and especially from 0.4 to 5% by weight, based on the hydrogenated nitrile rubber.

The inventive hydrogenated nitrile rubber typically has a high hydrogenation degree, customarily in the range from 80 to 100%, preferably from 90 to 100%, more preferably from 92 to 100%, even more preferably from 94 to 100%. Alternatively preferred is a fully hydrogenated nitrile rubber which has a hydrogenation degree of 99.1% or greater.

The content of the phosphine/diphosphine component (i) as well as of the phosphine oxide/diphosphine sulphide component (ii) is determined by means of gas chromatography in accordance with the method described in the example section with regard to the determination of the content of triphenylphosphane (“TPP”) and triphenylphosphane sulphide (“TPPS”).

The phosphine component (i) typically has the general formula (1-a)

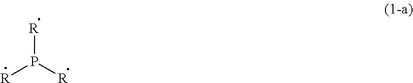

where
R′ are the same or different and are each alkyl, alkenyl, alkadienyl, alkoxy, aryl, heteroaryl, cycloalkyl, cycloalkenyl, cycloalkadienyl, halogen or trimethylsilyl, and the diphosphine component (i) typically has the general formula (1-b)

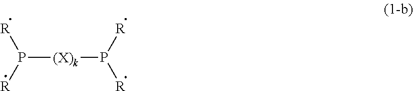

in which
R′ are the same or different and have the same definitions as in the general formula (1-a),
k is 0 or 1 and
X is a straight-chain or branched alkanediyl, alkenediyl or alkynediyl group.

The R radicals in both of these formulae (1-a) and (1-b) may be unsubstituted or mono- or polysubstituted.

Such phosphines or diphosphines of the general formulae (1-a) and (1-b) are preparable by methods known to those skilled in the art or else are commercially available.

Alkyl radicals in the R′ radicals of the phosphines or diphosphines of the general formulae (1-a) and (1-b) are typically understood to mean straight-chain or branched C₁-C₃₀-alkyl radicals, preferably C₁-C₂₄-alkyl radicals, more preferably C₁-C₁₈-alkyl radicals. C₁-C₁₈-Alkyl comprises, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, n nonyl, n-decyl, n-undecyl, n-dodecyl, n-tridecyl, n-tetradecyl, n-hexadecyl and n-octadecyl.

Alkenyl radicals in the R′ radicals of the phosphines or diphosphines of the general formulae (1-a) and (1-b) are typically understood to mean C₂-C₃₀-alkenyl radicals, preferably C₂-C₂₀-alkenyl radicals. More preferably, an alkenyl radical is a vinyl radical or an allyl radical.

Alkadienyl radicals in the R′ radicals of the phosphines or diphosphines of the general formulae (1-a) and (1-b) are typically understood to mean C₄-C₃₀-alkadienyl radicals, preferably C₄-C₂₀-alkadienyl radicals. More preferably, an alkadienyl radical is butadienyl or pentadienyl.

Alkoxy radicals in the R radicals of the phosphines or diphosphines of the general formulae (1-a) and (1-b) are typically understood to mean C₁-C₃₀-alkoxy radicals, preferably C₁-C₃₀-alkoxy radicals, more preferably methoxy, ethoxy, n-propoxy, isopropoxy, n-butoxy, sec-butoxy, tert-butoxy, n-pentoxy and n-hexoxy.

Aryl radicals in the R′ radicals of the phosphines or diphosphines of the general formulae (1-a) and (1-b) are typically understood to mean C₅-C₂₄-aryl radicals, preferably C₆-C₁₄-aryl radicals, more preferably C₆-C₁₂-aryl radicals. Examples of C₅-C₂₄-aryl are phenyl, o-, p- or m-tolyl, naphthyl, phenanthrenyl, anthracenyl and fluorenyl.

Heteroaryl radicals in the R radicals of the phosphines or diphosphines of the general formulae (1-a) and (1-b) have the same definition as given above for aryl radicals, except that one or more of the skeleton carbon atoms are replaced by a heteroatom selected from the group of nitrogen, sulphur and oxygen. Examples of such heteroaryl radicals are pyridinyl, oxazolyl, benzofuranyl, dibenxofuranyl and quinolinyl.

All the aforementioned alkyl, alkenyl, alkadienyl and alkoxy radicals may be unsubstituted or mono- or polysubstituted, for example by C₅-C₂₄-aryl radicals, preferably phenyl (in the case of alkyl radicals, this results, for example, in arylalkyl, preferably a phenylalkyl radical), halogen, preferably fluorine, chlorine or bromine, CN, OH, NH₂ or NR″₂ radicals where R″ in turn is C₁-C₃₀-alkyl or C₅-C₂₄-aryl.

Both the aryl radicals and the heteroaryl radicals are either unsubstituted or mono- or polysubstituted, for example by straight-chain or branched C₁-C₃₀-alkyl (resulting in what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or N(R″)₂ radicals, where R″ in turn is straight-chain or branched C₁-C₃₀-alkyl or C₅-C₂₄-aryl, or by further C₅-C₂₄-aryl or -heteroaryl radicals, which results in bisaryl radicals, preferably biphenyl or binaphthyl, heteroarylaryl radicals, arylheteroaryl radicals or bisheteroaryl radicals. These C₅-C₂₄-aryl or -heteroaryl substituents too are again in turn either unsubstituted or mono- or polysubstituted by all the aforementioned substituents.

Cycloalkyl radicals in the R radicals of the phosphines or diphosphines of the general formulae (1-a) and (1-b) are typically understood to mean a C₃-C₂₀-cycloalkyl radical, preferably a C₃-C₈-cycloalkyl radical, more preferably cyclopentyl and cyclohexyl.

Cycloalkenyl radicals in the R radicals of the phosphides or diphosphines of the general formulae (1-a) and (1-b) are the same or different, have one C═C double bond in the ring skeleton and are typically C₅-C₈ cycloalkenyl, preferably cyclopentenyl and cyclohexenyl.

Cycloalkadienyl radicals in the R radicals of the phosphines or diphosphines of the general formulae (1-a) and (1-b) are the same or different, have two C═C double bonds in the ring skeleton and are typically C₅-C₈ cycloalkadienyl, preferably cyclopentadienyl or cyclohexadienyl.

The aforementioned cycloalkyl, cycloalkenyl and cycloalkadienyl radicals too are either unsubstituted or mono- or polysubstituted, for example by straight-chain or branched C₁-C₃₀-alkyl (the result is then what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or NR″₂ radicals, where R″ in turn is straight-chain or branched C₁-C₃₀-alkyl or C₅-C₂₄-aryl, or by C₅-C₂₄-aryl or -heteroaryl radicals, which are in turn either unsubstituted or mono- or polysubstituted by all the aforementioned substituents.

The halogen radicals in the R′ radicals of the phosphines or diphosphines of the general formulae (1-a) and (1-b) are the same or different and are each fluorine, chlorine or bromine.

Particularly preferred phosphines of the general formula (1-a) are trialkyl-, tricycloalkyl-, triaryl-, trialkaryl-, triaralkyl-, diarylmonoalkyl-, diarylmonocycloalkyl-, dialkylmonoaryl-, dialkylmonocycloalkyl- or dicycloalkylmonoarylphosphines, where all the aforementioned radicals in turn are either unsubstituted or mono- or polysubstituted by the aforementioned substituents.

Especially preferred phosphines are those of the general formula (1-a) in which the R radicals are the same or different and are each phenyl, cyclohexyl, cyclohexenyl, cyclopentyl, cyclopentadienyl, phenylsulphonate or cyclohexylsulphonate.

Most preferably, the phosphines of the general formula (1-a) used are PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(iso-Pr)₃, P(CHCH₃(CH₂CH₃))₃, P(cyclopentyl)₃, P(cyclohexyl)₃, P(neopentyl)₃, P(C₆H₅CH₂)(C₆H₅)₂, P(NCCH₂CH₂)₂(C₆H₅), P[(CH₃)₃C]₂Cl, P[((CH₃)₃C]₂(CH₃), P(tert-Bu)₂(biph), P(C₆H₁₁)₂Cl, P(CH₃)(OCH₂CH₃)₂, P(CH₂═CHCH₂)₃, P(C₄H₃O)₃, P(CH₂OH)₃, P(m-CH₃OCH₅H₄)₃, P(C₆F₅)₃, P[((CH₃)₃Si]₃, P[(CH₃O)₃C₆H₂]₃, where Ph is phenyl, Tol is tolyl, biph is biphenyl, Bu is butyl and Pr is propyl. Triphenylphosphine is especially preferred.

In the diphosphines of the general formula (1-b), k is 0 or 1, preferably 1.

X in the general formula (1-b) is a straight-chain or branched alkanediyl, alkenediyl or alkynediyl group, preferably a straight-chain or branched C₁-C₂₀-alkanediyl, C₂-C₂₀-alkenediyl or C₂-C₂₀-alkynediyl group, more preferably a straight-chain or branched C₁-C₈-alkanediyl, C₂-C₆-alkenediyl or C₂-C₆-alkynediyl group.

C₁-C₈-Alkanediyl is a straight-chain or branched alkanediyl radical having 1 to 8 carbon atoms. Particular preference is given to a straight-chain or branched alkanediyl radical having 1 to 6 carbon atoms, especially having 2 to 4 carbon atoms. Preference is given to methylene, ethylene, propylene, propane-1,2-diyl, propane-2,2-diyl, butane-2,2-diyl, butane-1,3-diyl, butane-2,4-diyl, pentane-2,4-diyl and 2-methylpentane-2,4-diyl.

C₂-C₆-Alkenediyl is a straight-chain or branched alkenediyl radical having 2 to 6 carbon atoms. Preference is given to a straight-chain or branched alkenediyl radical having 2 to 4, more preferably 2 to 3, carbon atoms. Preferred examples include: vinylene, allylene, prop-1-ene-1,2-diyl and but-2-ene-1,4-diyl.

C₂-C₆-Alkynediyl is a straight-chain or branched alkynediyl radical having 2 to 6 carbon atoms. Preference is given to a straight-chain or branched alkynediyl radical having 2 to 4, more preferably 2 to 3, carbon atoms. Preferred examples include: ethynediyl and propynediyl.

Very particularly preferred diphosphines of the general formula (1-b) are Cl₂PCH₂CH₂PCl₂, (C₆H₁₁)₂PCH₂P(C₆H₁₁), (CH₃)₂PCH₂CH₂P(CH₃)₂, (C₆H₅)₂PCCP(C₆H₅)₂, (C₆H₅)₂PCH═CHP(C₆H₅)₂, (C₆F₃)₂P(CH₂)₂P(C₆F₅)₂, (C₆H₅)₂P(CH₂)₂P(C₆H₅)₂, (C₆H₅)₂P(CH₂)₃P(C₆H₅)₃, (C₆H₅)₂P(CH₂)₄P(C₆H₅)₂, (C₆H₅)₂P(CH₂)₅P(C₆H₅)₂, (C₆H₅)₂PCH(CH₃)CH(CH₃)P(C₆H₅)₂ and (C₆H₅)₂ and (C₆H₅)₂PCH(CH₃)CH₂P(C₆H₅)₂.

Particular diphosphines likewise usable in accordance with the invention are also published in Chem. Eur. J. 2008, 14, 9491-9494. Examples include:

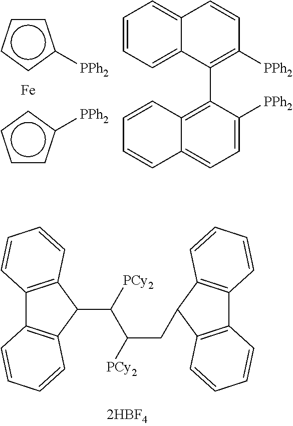

The phosphine sulphide of diphosphine sulphide component (ii) in the inventive hydrogenated nitrile rubber typically comprises sulphides of the above-defined phosphines or diphosphines. Particularly component (i) represents a phosphine, most preferably triphenylphosphine, and correspondingly component (ii) represents a phosphine sulphide, most preferably triphenylphosphine sulphide.

The inventive hydrogenated nitrile rubbers have repeating units of at least one α,β-unsaturated nitrile monomer and at least one conjugated diene monomer. They may additionally have repeating units of one or more further copolymerizable monomers.

The inventive hydrogenated nitrile rubber comprises fully or partly hydrogenated nitrile rubbers. The hydrogenation level may be within a range from at least 50% and up to 100%, or from 75% to 100%. Typically the inventive hydrogenated nitrile rubber has a high hydrogenation level, customarily from 80% to 100%, preferably from 90% to 100%, more preferably from 92 to 100% and especially from 94 to 100%. Those skilled in the art refer to “fully hydrogenated types” which shall also be encompassed by the present invention even when the residual C═C double bond content (also abbreviated to “RDB”) is not more than about 0.9%, meaning that the hydrogenation level is greater than or equal to 99.1%.

The repeating units of the at least one conjugated diene are preferably based on (C₄-C₆) conjugated dienes or mixtures thereof. Particular preference is given to 1,2-butadiene, 1,3-butadiene, isoprene, 2,3-dimethylbutadiene, piperylene and mixtures thereof. Especially preferred are 1,3-butadiene, isoprene and mixtures thereof. Even more preferred is 1,3-butadiene.

The α,β-unsaturated nitrile used for production of the inventive nitrile rubbers may be any known α-β-unsaturated nitrile, preference being given to (C₃-C₅)-α,β-unsaturated nitriles such as acrylonitrile, methacrylonitrile, ethacrylonitrile or mixtures thereof. Particular preference is given to acrylonitrile.

If one or more further copolymerizable monomers are used, these may, for example, be aromatic vinyl monomers, preferably styrene, α-methylstyrene and vinylpyridine, fluorinated vinyl monomers, preferably fluoroethyl vinyl ether, fluoropropyl vinyl ether, o-fluoromethylstyrene, vinyl pentafluorobenzoate, difluoroethylene and tetrafluoroethylene, or else coplymerizable antiageing monomers, preferably N-(-4-anilinophenyl)acrylamide, N-(4-anilinophenyl)methacrylamide, N-(4-anilinophenyl)cinnamides, N-(4-anilinophenyl)crotonamide, N-phenyl-4-(3-vinylbenzyloxy)aniline and N-phenyl-4-(4-vinylbenzyloxy)aniline, and also nonconjugated dienes, such as 4-cyanocyclohexene and 4-vinylcyclohexene, or else alkynes such as 1- or 2-butyne.

In addition, the copolymerizable termonomers used may be monomers containing hydroxyl groups, preferably hydroxyalkyl (meth)acrylates. It is also possible to use correspondingly substituted (meth)acrylamides.

Examples of suitable hydroxyalkyl acrylate monomers are 2-hydroxyethyl (meth)acrylate, 2-hydroxypropyl (meth)acrylate, 3-hydroxypropyl (meth)acrylate, 3-chloro-2-hydroxypropyl (meth)acrylate, 3-phenoxy-2-hydroxypropyl (meth)acrylate, glyceryl mono(meth)acrylate, hydroxybutyl (meth)acrylate, 3-chloro-2-hydroxypropyl (meth)acrylate, hydroxyhexyl (meth)acrylate, hydroxyoctyl (meth)acrylate, hydroxymethyl(meth)acrylamide, 2-hydroxypropyl (meth)acrylate, 3-hydroxypropyl(meth)acrylamide, di(ethylene glycol) itaconate, di(propylene glycol) itaconate, bis(2-hydroxypropyl) itaconate, bis(2-hydroxyethyl) itaconate, bis(2-hydroxyethyl) fumarate, bis(2-hydroxyethyl) maleate and hydroxymethyl vinyl ketone.

In addition, the copolymerizable termonomers used may be monomers containing epoxy groups, preferably glycidyl (meth)acrylates.

Examples of monomers containing epoxy groups are diglycidyl itaconate, glycidyl p-styrenecarboxylate, 2-ethylglycidyl acrylate, 2-ethylglycidyl methacrylate, 2-(n-propyl)glycidyl acrylate, 2(n-propyl)glycidyl methacrylate, 2-(n-butyl)glycidyl acrylate, 2-(n-butyl)glycidyl methacrylate, glycidyl methyl methacrylate, glycidylmethyl methacrylate, glycidyl acrylate, (3′,4′-epoxyheptyl)-2-ethyl acrylate, (3′,4′-epoxyheptyl)-2-ethyl methacrylate, 6′,7′-epoxyheptyl acrylate, 6′,7′-epoxyheptyl methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Alternatively, further copolymerizable monomers used may be copolymerizable termonomers containing carboxyl groups, for example α,β-unsaturated monocarboxylic acids, esters thereof, α,β-unsaturated dicarboxylic acids, mono- or diesters thereof or the corresponding anhydrides or amides thereof.

The α,β-unsaturated monocarboxylic acids used may preferably be acrylic acid and methacrylic acid.

It is also possible to use esters of the α,β-unsaturated monocarboxylic acids, preferably the alkyl esters and alkoxyalkyl esters thereof. Preference is given to the alkyl esters, especially C₁-C₁₈alkyl esters, of the α,β-unsaturated monocarboxylic acids, particular preference to alkyl esters, especially C₁-C₁₈ alkyl esters of acrylic acid or of methacrylic acid, especially methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, particular preference to alkoxyalkyl esters of acrylic acid or of methacrylic acid, especially C₂-C₁₂-alkoxyalkyl esters of acrylic acid or of methacrylic acid, even more preferably methoxymethyl acrylate, ethoxyethyl (meth)acrylate and methoxyethyl (meth)acrylate. It is also possible to use mixtures of alkyl esters, for example those mentioned above, with alkoxyalkyl esters, for example in the form of those mentioned above. It is also possible to use cyanoalkyl acrylate and cyanoalkyl methacrylates in which the number of carbon atoms in the cyanoalkyl group is 2-12, preferably α-cyanoethyl acrylate, β-cyanoethyl acrylate and cyanobutyl methacrylate. It is also possible to use hydroxyalkyl acrylates and hydroxyalkyl methacrylates in which the number of carbon atoms of the hydroxyalkyl groups is 1-12, preferably 2-hydroxyethyl acrylate, 2-hydroxyethyl methacrylate and 3-hydroxypropyl acrylate; it is also possible to use acrylates or methacrylates containing fluorine-substituted benzyl groups, preferably fluorobenzyl acrylate and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Further monomers used may be α,β-unsaturated dicarboxylic acids, preferably maleic acid, fumaric acid, crotonic acid, itaconic acid, citraconic acid and mesaconic acid.

It is additionally possible to use α,β-unsaturated dicarboxylic anhydrides, preferably maleic anhydride, itaconic anhydride, citraconic anhydride and mesaconic anhydride.

It is additionally possible to use mono- or diesters of α,β-unsaturated dicarboxylic acids. These α,β-unsaturated dicarboxylic mono- or diesters may, for example, be alkyl, preferably C₁-C₁₀-alkyl especially ethyl, n-propyl, isopropyl, n-butyl, tert-butyl, n-pentyl or n-hexyl, alkosyalkyl, preferably C₂-C₁₂-alkoxyalkyl, more preferably C₃-C₈-alkoxyalkyl, hydroxyalkyl, preferably C₁-C₁₂-hydroxyalkyl, more preferably C₃-C₈-hydroxyalkyl, cycloalkyl, preferably C₅-C₁₂-cycloalkyl, more preferably C₆-C₁₂-cycloalkyl, alkylcycloalkyl, preferably C₆-C₁₂-alkylcycloalkyl, more preferably C₇-C₁₀-alkylcycloalkyl, aryl, preferably C₆-C₁₄-aryl, mono- or diesters, where any diesters may also be mixed esters.

Particularly preferred alkyl esters of α,β-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propylheptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxyethyl (meth)acrylate. In particular, methoxyethyl acrylate is used.

Other esters of the α,β-unsaturated monocarboxylic acids used are additionally, for example, polyethylene glycol (meth)acrylate, polypropylene glycol (meth)acrylate, M-(2-hydroxyethyl)acrylamides, N-(2-hydroxymethyl)acrylamides and urethane (meth)acrylate.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconates, preferably monobenzyl citraconate;
monoalkyl itaconates, preferably monomethyl itaconate, monoethyl itaconate, monopropyl itaconate and mono-n-butyl itaconate;
monocycloalkyl itaconates, preferably monocyclopentyl itaconate, monocyclohexyl itaconate and monocycloheptyl itaconate;
monoalkylcycloalky itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The α,β-unsaturated dicarboxylic diesters used may be the analogous diesters based on the aforementioned monoester groups, where the ester groups may also be chemically different groups.

Useful further copolymerizable monomers are also free-radically polymerizable compounds containing at least two olefinic double bonds per molecule. Examples of polyunsaturated compounds are acrylates, methacrylates or itaconates of polyols, for example ethylene glycol diacrylate, diethylene glycol dimethacrylate, triethylene glycol diacrylate, butanediol 1,4-diacrylate, propane-1,2-diol diacrylate. butane-1,3-diol dimethacrylate, neopentyl glycol diacrylate, trimethylolpropane di(meth)acrylate. trimethylolethane di(meth)acrylate, glyceryl di- and triacrylate, pentaerythrityl di-, tri- and tetraacrylate or -methacrylate, dipentaerythrityl tetra-, penta- and hexaacrylate or -methacrylate or -itaconate, sorbityl tetraacrylate, sorbityl hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes with terminal hydroxyl groups. The polyunsaturated monomers used may also be acrylamides, for example methylenebisacrylamide, hexamethylene-1,6-bisacrylamide, diethylenetriammetrismethacrylamide, bis(methacrylamidopropoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate or triallyl phosphate.

The proportions of conjugated diene and α,β-unsaturated nitrile in the hydrogenated nitrile rubbers to be used in the process of the invention or the inventive hydrogenated nitrile rubbers may vary within wide ranges. The proportion of, or of the sum total of, the conjugated diene(s) is typically in the range from 20 to 93% by weight, preferably in the range from 45 to 90% by weight, more preferably in the range from 50 to 85% by weight, based on the overall polymer. The proportion of, or of the sum total of, the α,β-unsaturated nitrile(s) is typically in the range from 5 to 80% by weight, preferably 10 to 55% by weight, more preferably 15 to 50% by weight, based on the overall polymer. The proportions of the repeating units of conjugated diene and α,β-unsaturated nitrile in the hydrogenated nitrile rubbers to be used in accordance with the invention or the inventive hydrogenated nitrile rubbers add up to 100% by weight in each case.

The additional monomers may be present in amounts of 0 to 40% by weight, preferably 0 to 30% by weight, more preferably 0 to 26% by weight, based on the overall polymer. In this case, corresponding proportions of the repeating units of the conjugated diene(s) and/or of the repeating units of the unsaturated nitrile(s) are replaced by the proportions of these additional monomers, where the proportions of all the repeating units of the monomers must also add up to 100% by weight in each case.

If esters of (meth)acrylic acid are used as additional monomers, this is typically done in amounts of 1 to 25% by weight. If α,β-unsaturated mono- or dicarboxylic acids are used as additional monomers, this is typically done in amounts of less than 30% by weight.

Preference is given to hydrogenated inventive nitrile rubbers having repeating units derived from acrylonitrile and 1,3-butadiene. Preference is further given to inventive hydrogenated nitrile rubbers having repeating units of acrylonitrile, 1,3-butadiene and one or more further copolymerizable monomers. Preference is likewise given to hydrogenated nitrile rubbers having repeating units of acrylonitrile, 1,3-butadiene and one or more α,β-unsaturated mono- or dicarboxylic acids or esters or amides thereof, and especially repeating units of an alkyl ester of an α,β-unsaturated carboxylic acid, most preferably of methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate or lauryl (meth)acrylate.

In a preferred embodiment, the inventive hydrogenated nitrile rubbers are essentially filler-free. “Essentially filler-free” in the context of this application means that the inventive hydrogenated nitrile rubbers contains less than 5% by weight of fillers, based on 100% by weight of hydrogenated nitrile rubber.

In a particularly preferred embodiment, the inventive hydrogenated nitrile rubbers contain, based on 100% by weight of hydrogenated nitrile rubber, less than 5% by weight of fillers selected from the group consisting of carbon black, silica, barium sulphate, titanium dioxide, xinc oxide, calcium oxide, calcium carbonate, magnesium oxide, aluminium oxide, iron oxide, aluminium hydroxide, magnesium hydroxide. aluminium silicates, diatomaceous earth, talc, kaolins, bentonites, carbon nanotubes, Teflon (the latter preferably in powder form), silicates and mixtures of the aforementioned.

The nitrogen content is determined in the nitrile rubbers for use in accordance with the invention or the inventive hydrogenated nitrile robbers to DIN 53 625 according to Kjeldahl. Due to the content of polar comonomers, the nitrile rubbers are typically ≧85% by weight soluble in methyl ethyl ketone at 20° C.

The glass transition temperatures of the inventive hydrogenated nitrile rubbers are within the range of −70° C. to +10° C., preferably within the range of −60° C. to 0° C.

The hydrogenated nitrile rubbers have Mooney viscosities ML 1+4 at 100° C. of 10 to 150 Mooney units (MU), preferably of 20 to 100 MU. The Mooney viscosity of the hydrogenated nitrile rubbers is determined in a shearing disc viscometer to DIN 53523/3 or ASTM D 1646 at 100° C.

In an alternative embodiment the inventive hydrogenated nitrile rubbers contains
i) a content of phosphines, diphosphates or mixtures thereof, preferably triphenylphosphine, within the range from greater than 0 to 1.0% by weight, preferably from greater than 0 to 0.8% by weight, more preferably from greater than 0 to 0.6% by weight, even more preferably from greater than 0.05 to 0.5% by weight and especially from 0.1 to 0.4% by weight, based on the hydrogenated nitrile rubber, and
ii) a content of phosphine sulphides, diphosphate sulphides or mixtures thereof, preferably triphenylphosphine sulphide, in the range from 0.075 to 10% by weight, preferably from 0.1 to 9% by weight, more preferably from 0.2 to 8% by weight, even more preferably 0.3 to 6% by weight and especially from 0.4 to 5% by weight, based on the hydrogenated nitrile rubber.

In said alternative embodiment the hydrogenation degree of the hydrogenated nitrile rubber is in the range from 80 to 100%, preferably from 90 to 100%, more preferably from 92 to 100%, even more preferably from 94 to 100%.

### Process for Producing the Inventive Hydrogenated Nitrile Rubbers

The inventive hydrogenated nitrile rubbers having
i) a content of phosphides, diphosphates or mixtures thereof, preferably triphenylphosphine, within the range from 0 to 1.0% by weight, preferably from 0 to 0.8% by weight, more preferably from 0 to 0.6% by weight, even more preferably from 0 to 0.5% by weight and especially from 0 to 0.4% by weight, based on the hydrogenated nitrile rubber, and
ii) a content of phosphine sulphides, diphosphine sulphides or mixtures thereof, preferably triphenylphosphine sulphide, in the range from 0.075 to 10% by weight, preferably from 0.1 to 9% by weight, more preferably from 0.2 to 8% by weight, even more preferably from 0.3 to 6% by weight and especially from 0.4 to 5% by weight, based on the hydrogenated nitrile rubber, can be produced by reacting a hydrogenated nitrile rubber having a content of phosphines, diphosphines or mixtures thereof within a range of 0.15-5% by weight, preferably within the range of 0.25-4.75% by weight, more preferably within the range of 0.3-4.5% by weight, most preferably within the range of 0.4-4.25% by weight and especially within the range of 0.5-4% by weight, based on the hydrogenated nitrile rubber, with at least one sulphur donor having at least two sulphur atoms covalently bonded directly to one another.

This analogously applies to the preparation of the alternative inventive hydrogenated nitrile rubbers which differ from the ones described in the preceding paragraph only in that (i) the content of phosphines, diphosphine or mixtures thereof is in the range from greater than 0 to 1.0% by weight, preferably from greater than 0 to 0.8 % by weight, more preferably from greater than 0 to 0.6% by weight, even more preferably from 0.05 to 0.5% by weight, and especially from 0.1 to 0.4% by weight, based on the hydrogenated nitrile rubber.

The inventive reaction of the phosphine- and/or diphosphine-containing hydrogenated nitrile rubber with at least one sulphur donor having at least two sulphur atoms covalently bonded directly to one another can be conducted in various variants.

The following method has been found to be useful:
(1) a nitrile rubber is first subjected to a catalytic hydrogenation in organic solution and in the presence of a phosphine and/or diphosphine as defined above, the phosphine and/or diphosphine (a) being present as a ligand in the hydrogenation catalyst without further addition of phosphine and/or diphosphine as a cocatalyst or (b) being present as a ligand in the hydrogenation catalyst and additionally being added as a cocatalyst, or (c) being added as a cocatalyst, but with no phosphine or diphosphine present as ligand(s) in the hydrogenation catalyst, and
(2) then the hydrogenated nitrile rubber obtained, before, during or after the isolation, preferably before or during the isolation, especially in the course of a steam distillation, or alternatively preferably after isolation, is contacted with and reacted with the at least one sulphur donor having at least two sulphur atoms covalently bonded directly to one another in a separate mixing operation.

### Step 1:

It has been found to be useful to produce the hydrogenated nitrile rubber having a content of phosphines, diphosphines or mixtures thereof in the range of 0.15-5% by weight, preferably in the range of 0.25-4.75% by weight, more preferably in the range of 0.3-4.5% by weight, even more preferably in the range of 0.4-4.25% by weight and especially in the range of 0.5-4% by weight, based on the hydrogenated nitrile rubber, in a first step by hydrogenation.

### Hydrogenation Catalyst:

In the catalytic hydrogenation reaction of the process according to the invention, at least one phosphine or diphosphine is present:

In a first embodiment, this phosphine and/or diphosphine is present as a ligand in the hydrogenation catalyst used. No separate addition of a phosphine or diphosphine is required.

In a second embodiment, a phosphine or diphosphine is added as what is called a cocatalyst alongside the phosphine or diphosphine ligand-containing hydrogenation catalyst in the hydrogenation reaction.

In a third embodiment, any desired hydrogenation catalyst that does not contain any phosphine or diphosphine can be used, and the phosphine or diphosphine is added as a cocatalyst.

In a preferred embodiment, the hydrogenation is performed using at least one catalyst having at least one phosphine or diphosphine ligand.

Preference is additionally given to hydrogenation using at least one catalyst having at least one phosphine or diphosphine ligand, and additionally in the presence of at least one phosphine or diphosphine as a cocatalyst.

In all embodiments, the hydrogenation catalysts are typically based on the noble metals rhodium, ruthenium, osmium, palladium, platinum or iridium, preference being given to rhodium, ruthenium and osmium. The catalysts specified hereinafter are usable in all the embodiments.

It is possible to use rhodium complex catalysts of the general formula (A)

Rh(X)ₙ(L)ₘ (A)
where
X are the same or different and are hydrogen, halogen, pseudohalogen, SnCl₃ or carboxylate,
n is 1, 2 or 3, preferably 1 or 3,
L are the same or different and represent mono- or bidentate ligands based on phosphorus, arsenic or antimony,
m is 2, 3 or 4 if L represents monodentate ligands, or is 1 or 1.5 or 2 or 3 or 4 if L represents bidentate ligands.

In the general formula (A), X are the same or different and are preferably hydrogen or chlorine. L in the general formula (A) is preferably a phosphine or diphosphine corresponding to the general formulae (I-a) and (I-b) shown above, including the general, preferred and particularly preferred definitions given there.

Particularly preferred catalysts of the general formula (A) are tris(triphenylphosphine)rhodium(III) chloride, tris(triphenylphosphine)rhodium(III) chloride, tris(dimethyl sulphoxide)rhodium(III) chloride, hydridorhodiumtetrakis(triphenylphosphine) and the corresponding compounds in which triphenylphosphine has been replaced wholly or partly by tricyclohexylphosphine.

It is also possible to use ruthenium complex catalysts. These are described, for example, in DE-A 39 21 264 and EP-A-0 298 386. They typically have the general formula (B)

RuXₙ[(L¹)ₘ(L¹)₅₋ₓ] (B)
in which
X are the same or different and are hydrogen, halogen, SnCl₃, CO, NO or R⁶—COO,
L¹ are the same or different and are hydrogen, halogen, R⁶—COO, NO, CO or a cyclopentadienyl ligand of the following general formula (2):

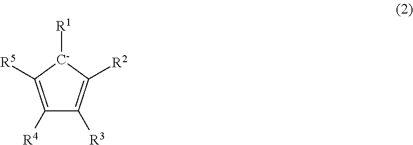

in which
R¹ to R⁵ are the same or different and are each hydrogen, methyl, ethyl, propyl, butyl, hexyl or phenyl or, alternatively, two adjacent radicals from R¹ to R⁵ are bridged, so as to result in an indenyl or fluorenyl system,
L² is a phosphine, diphosphine or arsine and
n is 0, 1 or 2,
m is 0, 1, 2 or 3,
z is 1, 2, 3 or 4, and

R⁶ is a radical which has 1 to 20 carbon atoms and may be branched or unbranched, bridged or unbridged and/or partly aromatic, and is preferably C₁-C₄ alkyl.

Examples of L¹ ligands in the general formula (B) of the cyclopentadienyl ligand type of the general formula (2) include cyclopentadienyl, pentamethylcyclopentadienyl, ethyltetramethylcyclopentadienyl, pentaphenylcyclopentadienyl, dimethyltriphenylcyclopentadienyl, indenyl and fluorenyl. The benzene rings in the L¹ ligands of the indenyl and fluorenyl type may be substituted by C₁-C₆-alkyl radicals, especially methyl, ethyl and isopropyl, C₁-C₄-alkoxy radicals, especially methoxy and ethoxy, aryl radicals, especially phenyl, and halogens, especially fluorine and chlorine. Preferred L¹ ligands of the cyclopentadienyl type are the respectively unsubstituted cyclopentadienyl, indenyl and fluorenyl radicals.

In the L¹ ligand in the general formula (B) of the (R⁶—COO) type, R⁶ includes, for example, straight-chain or branched, saturated hydrocarbyl radicals having 1 to 20, preferably 1 to 12 and especially 1 to 6 carbon atoms, cyclic saturated hydrocarbyl radicals having 5 to 12 and preferably 5 to 7 carbon atoms, and also aromatic hydrocarbyl radicals having 6 to 18 and preferably 6 to 10 carbon atoms, or aryl-substituted alkyl radicals having preferably a straight-chain or branched C₁-C₆ alkyl radical and a C₆-C₁₈ aryl radical, preferably phenyl.

The above-elucidated R⁶ radicals in (R⁶—COO) in the ligand L¹ of the general formula (B) may optionally be substituted by hydroxyl, C₁-C₆-alkoxy, C₁-C₆-carbalkoxy, fluorine, chlorine or di-C₁-C₄-alkylamino, the cycloalkyl, aryl and aralkyl radicals additionally by C₁-C₆-alkyl; alkyl, cycloalkyl and aralkyl groups may contain keto groups. Examples of the R⁶ radical are methyl, ethyl, propyl, isopropyl, tert-butyl, cyclohexyl, phenyl, benzyl and trifluoromethyl. Preferred R⁶ radicals are methyl, ethyl and tert-butyl.

The L² ligand in the general formula (B) is preferably a phosphine or diphosphine according to the general formulae (I-a) and (I-b) shown above, including the general, preferred and particularly preferred definitions given there, or is an arsine of the general formula (3)

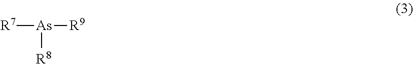

Preferred ligands L² of the general formula (3) are triphenylarsine, ditolylphenylarsine, tris(4-ethoxyphenyl)arsine, diphenylcyclohexylarsine, dibistylphenylarsine and diethylphenylarsine.

Preferred ruthenium catalysts of the general formula (B) are selected from the group which follows, where “Cp” represents cyclopentadienyl, i.e. C₅H₄⁻, “Ph” represents phenyl, “Cy” represents cyclohexyl and “dppe” represents 1,2-bis(diphenylphosphino)ethane: RuCl₂(PPh₃)₃; RuHCl(PPh₃)₃; (RuH₂(PPh₃)₃; RuH₃(PPh₃)₄; RuH₄(PPh₃)₃; RuH(CH₃COO)(PPh₃)₃; RuH(C₂H₅COO)(PPh₃)₃; RuH(CH₃COO)₂(PPh₃)₂; RuH(NO)₂(PPh₃)₂; Ru(NO)₂(PPh₃)₃; RuCl(Cp(PPh₃)₂; RuH(Cp)(PPh₃)₂; Ru(SnCl₃)(Cp)(PPh₃)₃; RuCl(μ³-C₉H₇)(PPh₃)₂; RuH(μ⁵-C₉H₇)(PPh₃)₂; Ru(SnCl₃)(μ⁵-C₉H₇)(PPh₃)₃; RuCl(μ⁵-C₁₃H₉)(PPh₃)₃; RuH(μ⁵-C₁₃H₉)(PPh₃)₂; Ru(SuCl₃)μ⁵-C₁₃H₉)(PPh₃)₂; RuCl(μ⁵-C₉H₇)(dppe); RuHCl(CO)(PCy₃); RuH(NO)(CO)(PCy₃)₃; RuHCl(CO)₂(PPh₃)₂; RuCl₂(CO)(dppe) RuHCl(CO)(PCy₃), RuHCl(CO)(dppe)₂, RuH(CH₃COO)(PPh₃)₃; RuH(CH₃COO)₂(PPh₃)₂; and RuH(CH₃COO)(PPh₃)₃.

Suitable catalysts are also those of the general formula (C)

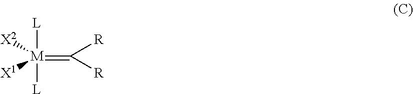

in which
M is osmium or ruthenium,
X¹ and X² are the same or different and are two ligands, preferably anionic ligands,
L are identical or different ligands, preferably uncharged electron donors,
R are the same or different and are hydrogen, alkyl, preferably C₁-C₃₀alkyl, cycloalkyl, preferably C₃-C₂₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀alkenyloxy, alkynyloxy, preferably C₂-C₂₀-aralkynyloxy, aryloxy, preferably C₆-C₂₄-aryloxy, alkoxycarbonyl, preferably C₂-C₂₀alkoxycarbonyl, alkylamino, preferably C₁-C₃₀-alkylamino, alkylthio, preferably C₁-C₃₀-alkylthio, arylthio, preferably C₆-C₂₄-arylthio, alkylsophonyl, preferably C₁-C₂₀-alkylsulphonyl, or alkylsulphinyl, preferably C₁-C₂₀-alkylsulphinyl, where all these radicals may each optionally be substituted by one or more alkyl, halogen, alkoxy, aryl or heteroaryl radicals, or alternatively both R radicals, with incorporation of the common carbon atom to which they are bonded, are bridged to form a cyclic group which may be aliphatic or aromatic in nature, is optionally substituted and may contain one or more heteroatoms.

In one embodiment of the catalysts of the general formula (C), one R radical is hydrogen and the other R radical is C₁-C₂₀-alkyl, C₃-C₁₀-cycloalkyl, C₂-C₂₀-alkenyl, C₂-C₂₀-alkynyl, C₅-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl or C₁-C₂₀-alkylsulphinyl, where all these radicals may each be substituted by one or more alkyl, halogen, alkoxy, aryl or heteroaryl radicals.

In the catalysts of the general formula (C), X¹ and X² are the same or different and are two ligands, preferably anionic ligands.

X³ and X² may, for example, be hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₂₀-alkylsulphonyl, C₁-C₂₀-alkylsulphinyl, mono- or dialkylamide, mono- or dialkylcarbamate, mono- or dialkylthiocarbamate, mono- or dialkyldithiocarbamate or mono- or dialkylsulphonamide radicals.

The aforementioned X¹ and X² radicals may also be substituted by one or more further radicals, for example by halogen, preferably fluorine, C₁-C₁₀-alkyl, C₁-C₁₀-alkoxy or C₆-C₂₄-aryl, where these radicals too may optionally in turn be substituted by one or more substituents selected from the group comprising halogen, preferably fluorine, C₁-C₅-alkyl, C₁-C₅-alkoxy and phenyl.

In a further embodiment, X¹ and X² are the same or different and are each halogen, especially fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a further embodiment, X¹ and X² are identical and are each halogen, especially chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (CH₃SO₃) or CF₃SO₃ (trifluoromethanesulphonate).

In the general formula (C), L are identical or different ligands and are preferably uncharged electron donors.

The two L ligands may, for example, each independently be a phosphine, sulphonated phosphine, phosphate, phosphinite, phosphonite, arsine, stibine, ether, amine, amide, sulphoxide, carboxyl, nitrosyl, pyridine, thioether, an imidazoline or an imidaxolidine ligand.

Preferably, the two L ligands are each independently a C₆-C₂₄-aryl-, C₁-C₁₀-alkyl- or C₃-C₂₀-cycloalkylphosphine ligand, a sulphonated C₆-C₂₄-aryl- or sulphonated C₁-C₁₀-alkylphosphine ligand, a C₆-C₂₄-aryl- or C₁-C₁₀-alkylphosphinite ligand, a C₆-C₂₄-aryl- or C₁-C₁₀-alkylphosphonite ligand, a C₆-C₂₄-aryl- or C₁-C₁₀-alkylphosphite ligand, a C₆-C₂₄-aryl- or C₁-C₁₀-alkylarsine ligand, a C₆-C₂₄-aryl, or C₁-C₁₀-alkylamine ligand, a pyridine ligand, a C₆-C₂₄-aryl- or C₁-C₁₀-alkyl sulphoxide ligand, a C₆-C₂₄-aryl or C₁-C₁₀-alkyl ether ligand or a C₆-C₂₄-aryl- or C₁-C₁₀-alkylamide ligand, all of which may each be substituted by a phenyl group which is in turn either unsubstituted or substituted by one or more halogen, C₁-C₅-alkyl or C₁-C₅-alkoxy radical(s).

The term “phosphine” includes, for example, PPh₃, P(p-Tol)₃, PPh(CH₃)₂, P(CF₃)₃, P(CF₃)₃, P(p-FC₆H₄)₃, P(p-CF₃C₆H₄)₃, P(C₆H₄-SO₃Na)₃, P(CH₂C₆H₄—SO₃Na)₃, P(iospropyl)₃, (P(CHCH₃(CH₂CH₃))₃, P(cyclopentyl)₃, P(cyclohexyl)₃, P(neopentyl)₃ and (P(neophenyl)₃, where “Ph” represents phenyl and “Tol” represents tolyl.

The term “phosphinite” includes, for example, triphenylphosphinite, tricyclohexylphosphinite, triisopropylphosphinite and methyldiphenylphosphinite.

The term “phosphite” includes, for example, triphenylphosphite, tricyclohexylphosphite, tri-tert-butylphosphite, triisopropylphosphite and methyldiphenylphosphite.

The term “stibine” includes triphenylstibine, tricyclohexylstibine and trimethyistibine.

The term “sulphonate” includes, for example, trifkoromethanesalphonate, tosylate and mesylate.

The term “sulphoxide” includes, for example, (CH₃)₂S(═O) and (C₆H₅)₂S═O.

The term “thioether” includes, for example, CH₃SCH₃, C₆H₅SCH₃, CH₃OCH₂CH₃SCH₃ and tetrahydrothiophene.

The term “pyridine” shall be understood in the context of this application as an umbrella term for all pyridine-based ligands, as specified, for example, by Grubbs in WO-A-03/011455. These include pyridine, and pyridine having mono- or polysubstitution in the form of the picolines (α-, β-, and γ-picoline),and lutidines (2,3-, 2,4-. 2,5-, 2,6-, 3,4- and 3,5-lutidine), collidine (2,4,6-trimethylpyridine), trifluoromethylpyridine, phenylpyridine, 4-(dimethylamino)pyridine, chloropyridines, bromopyridines, nitropyridines, quinoline, pyrimidine, pyrrole, imidazole and phenylimidaxole.

If one or both of the L ligands in formula (C) is an imidazoline and/or imidazoline radical (also referred to collectively hereinafter as “Im” ligand(s)), the latter typically has a structure of the general formula (4a) or (4b)

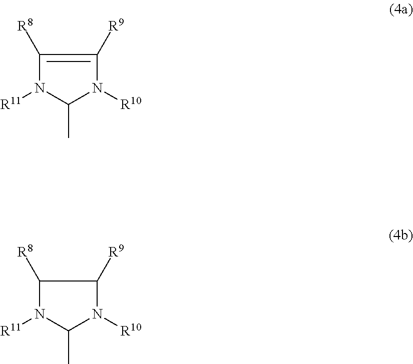

in which
R⁸, R⁹, R¹⁰, R¹¹ are the same or different and are each hydrogen, straight-chain or branched C₁-C₃₀-alkyl, C₃-C₃₀-cycloalkyl, C₂-C₂₀-alkenyl, C₂-C₂₀-alkynyl, C₆-C₂₄-aryl, C₁-C₃₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkythio, C₆-C₂₀-arylthio, C₁-C₂₀-alkylsulfonyl, C₁-C₂₀-alkylsulphonate, C₆-C₂₀-arylsulphonate or C₁-C₂₀-alkylsulphinyl.

Optionally, one or more of the R⁸, R⁹, R¹⁰, R¹¹ radicals may each independently be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents may in turn be substituted by one or more radicals, preferably selected from the group of halogen, especially fluorine, chlorine or bromine, C₁-C₅-alkyl, C₁-C₅-alkoxy and phenyl.

Merely for clarification, it should be added that the structures shown in the general formulae (4a) and (4b) in the context of this application are equivalent to the structures (4a′) and (4b′) frequently also encountered in the literature for this radical, which emphasize the carbene character of the radical. This also applies analogously to the corresponding preferred structures (5a)-(5f) shown below. These radicals are all referred to collectively hereinafter as “Im” radical.

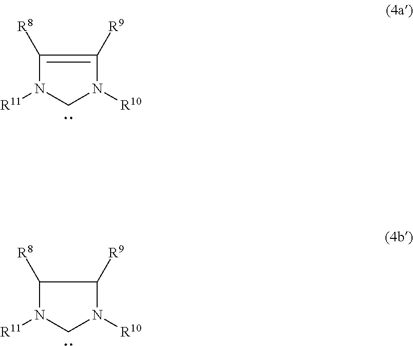

In a preferred embodiment of the catalysts of the general formula (C), R⁸ and R⁹ are each independently hydrogen, C₆-C₂₄-aryl, more preferably phenyl, straight-chain or branched C₁-C₁₀-alkyl, more preferably propyl or butyl or form, together with the carbon atoms to which they are bonded, a cycloalkyl or aryl radical, where all the aforementioned radicals may optionally be substituted in turn by one or more further radicals selected from the group comprising straight-chain or branched C₁-C₁₀-alkyl, C₁-C₁₀-alkoxy, C₆-C₂₄-aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

In a preferred embodiment of the catalysts of the general formula (C), the R¹⁰ and R¹¹ radicals are additionally the same or different and are each straight-chain or branched C₁-C₁₀-alkyl, more preferably methyl, isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen, especially fluorine, chlorine and bromine.

More particularly, the R¹⁰ and R¹¹ radicals may be the same or different and are each isopropyl, neopentyl, adamantyl, mesityl (2,4,6-trimethylphenyl), 2,6-difluorophenyl, 2,4,6-trifluorophenyl or 2,6-diisopropylphenyl.

Particularly preferred Im radicals have the structures (5a) to (5f) below, where Ph in each case is a phenyl radical, Bu is a butyl radical and Mes in each case is a 2,4,6-trimethylphenyl radical, or Mes alternatively in all cases is 2,6-diisopropylphenyl.

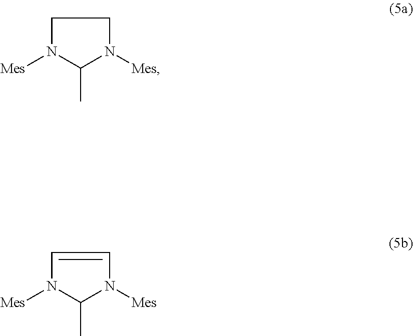

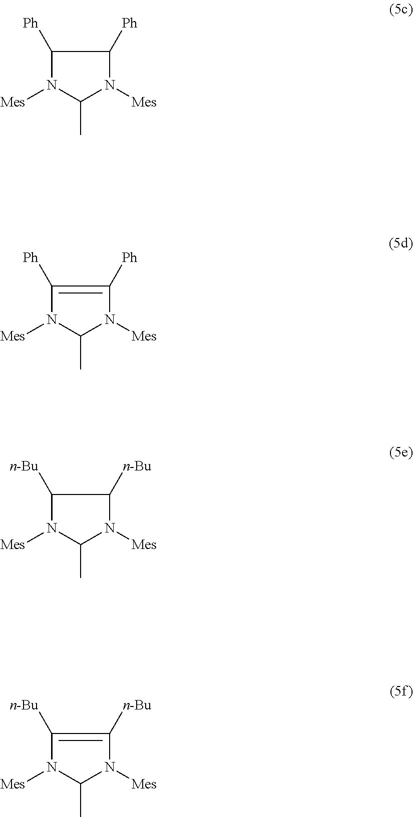

A wide variety of different representatives of the catalysts of the formula (C) is known in principle, for example from WO-A-96/94289 and WO-A-97/06185.

As an alternative to the preferred Im radicals, one or both L ligands in the general formula (C) are preferably also identical or different trialkylphosphine ligands in which at least one of the alkyl groups is a secondary alkyl group or a cycloalkyl group, preferably isopropyl, isobutyl, sec-butyl, neopentyl, cyclopentyl or cyclohexyl.

More preferably, in the general formula (C), one or both L ligands are a trialkylphosphine ligand in which at least one of the alkyl groups is a secondary alkyl group or a cycloalkyl group, preferably isopropyl, isobutyl, sec-butyl, neopentyl, cyclopentyl or cyclohexyl.

Particular preference is given to catalysts which are covered by the general formula (C) and have the structures (6) (Grubbs (I) catalyst) and (7) (Grubbs (II) catalyst), where Cy is cyclohexyl.

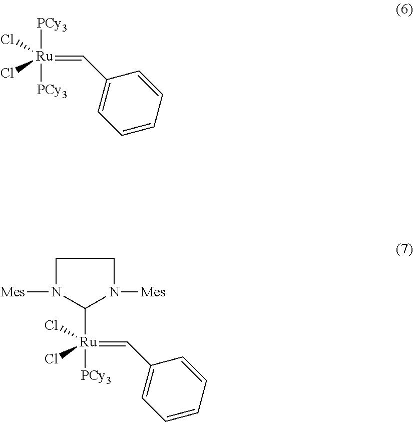

Suitable catalysts are also preferably those of the general formula (C1)

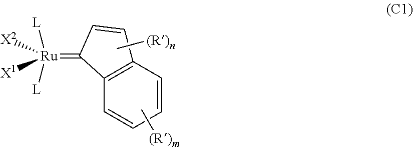

in which
X¹, X² and L may have the same general, preferred and particularly preferred definitions as in the general formula (C),
n is 0, 1 or 2,
m is 0, 1, 2, 3 or 4 and

R′ are the same or different and are each alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each be substituted by one or more alkyl, halogen, alkoxy, aryl or heteroaryl radicals.

As preferred catalysts covered by the general formula (C1), it is possible to use, for example, those of the formulae (8a) and (8b), where each Mes is 2,4,6-trimethylphenyl and Ph is phenyl.

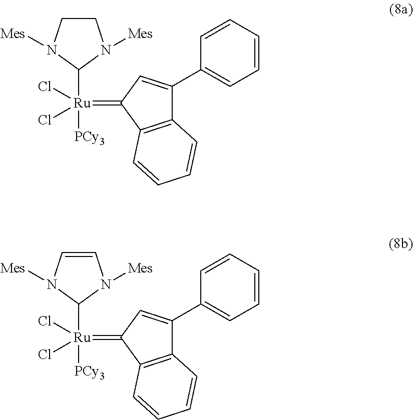

These catalysts are known, for example, from WO-A-2004/112951. Catalyst (8a) is also referred to as the Nolan catalyst.

Suitable catalysts are also preferably those of the general formula (D)

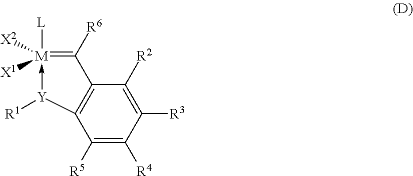

in which
M is ruthenium or osmium,
X¹ and X² are identical or different ligands, preferably anionic ligands,
Y is oxygen (O), sulphur (S), an N—R¹ radical or a P-R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
R², R³, R⁴ and R⁵ are the same or different and are each hydrogen or organic or inorganic radicals,
R⁶ is hydrogen or an alkyl, alkenyl, alkynyl or aryl radical and
L is a ligand as defined for the formula (C).

The catalysts of the general formula (D) are known in principle and are described, for example, by Hoveyda et al. in US 2002/0107138 A1 and Angew. Chem. Int. Ed. 2003, 42, 4592, and by Grela in WO-A-2004/035596, Eur. J. Org. Chem 2003, 963-966 and Angew. Chem. Int. Ed. 2002, 41, 4038, and also in J. Org. Chem. 2004, 69, 6894-96 and Chem. Eur. J. 2004, 18, 777-784, and also in US 2007/043180. The catalysts are commercially available or can be prepared according to the references cited.

In the catalysts of the general formula (D), L is a ligand which typically has an electron donor function and may assume the same general, preferred and particularly preferred definitions as L in the general formula (C). In addition, L in the general formula (D) is preferably a P(R⁷)₃ radical where R⁷ are independently C₁-C₆ alkyl, C₃-C₈-cycloalkyl or aryl, or else an optionally substituted imidazoline or imidazolidine radical (“Im”).

C₁-C₆-Alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl comprises cyclopropyl, cyclobutyl, cyclopentyl, cyclohexyl, cycloheptyl and cyclooctyl.

Aryl comprises an aromatic radical having 6 to 24 skeleton carbon atoms, preferably mono-, bi- or tricyclic carbocyclic aromatic radicals having 6 to 10 skeleton carbon atoms, especially phenyl, biphenyl, naphthyl, phenanthrenyl or anthracenyl.

The imidazoline or imidazolidine radical (Im) has the same general, preferred and particularly preferred structures as the catalysts of the general formula (C).

Particularly suitable catalysts of the general formula (D) are those in which the R¹⁰ and R¹¹ radicals are the same or different and are each straight-chain or branched C₁-C₁₀-alkyl, more preferably isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, or C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

More particularly, the R¹⁰ and R¹¹ radicals may be the same or different and are each isopropyl, neopentyl, adamantyl or mesityl.

Particularly preferred imidazoline or imidazolidine radicals (Im) have the structures (5a-5f) already specified above, where Mes in each case is 2,4,6-trimethylphenyl.

In the catalysts of the general formula (D), X¹ and X² have the same general, preferred and particularly preferred definitions as the catalysts of the general formula (C).

In the general formula (D), the R¹ radical is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals.

Typically, the R¹ radical is a C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₃₀-alkenyloxy, C₂-C₂₀-alkynyloxy, C-C₂₄-aryloxy, C₂-C₂₀-alkoxycarbonyl, C₁-C₂₀-alkylamino, C₁-C₃₀-alkylthio, C₆-C₂₄-arylthio, C₁-C₂₀-alkylsulphonyl or C₁-C₂₀-alkylsulphinyl radical, all of which may each optionally be substituted by one or more alkyl, halogen, alkoxy, aryl or heteroaryl radicals.

Preferably, R¹ is a C₃-C₂₀-cycloalkyl radical, a C₆-C₂₄-aryl radical or a straight-chain or branched C₁-C₃₀-alkyl radical, where the latter may optionally be interrupted by one or more double or triple bonds or else one or more heteroatoms, preferably oxygen or nitrogen. More preferably, R¹ is a straight-chain or branched C₁-C₁₂-alkyl radical.

The C₃-C₂₀-cycloalkyl radical comprises, for example, cyclopropyl, cyclobutyl, cyclopentyl, cyclohexyl, cycloheptyl and cyclooctyl.

The C₁-C₁₂-alkyl radical may, for example, be methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, n-heptyl, n-octyl, n-decyl or n-dodecyl. More particularly, R¹ is methyl or isopropyl.

The C₆-C₂₄-aryl radical is an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

In the general formula (D), the R², R³, R⁴ and R⁵ radicals are the same or different and may each be hydrogen or organic or inorganic radicals.

In a suitable embodiment, R², R³, R⁴, R⁵ are the same or different and are each hydrogen, halogen, nitro, CF₃, alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each optionally be substituted by one or more alkyl, alkoxy, halogen, aryl or heteroaryl radicals.

Typically, R², R³, R⁴, R⁵ are the same or different and are each hydrogen, halogen, preferably chlorine or bromine, nitro, CF₃, C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radicals, all of which may each optionally be substituted by one or more C₁-C₃₀-alkyl, C₁-C₂₀-alkoxy, halogen, C₆-C₂₄-aryl or heteroaryl radicals.

Its a particularly proven embodiment, R², R³, R⁴, R⁵ are the same or different and are each nitro, straight-chain or branched C₁-C₃₀-alkyl, C₅-C₂₀-cycloalkyl, straight-chain or branched C₁-C₂₀-alkoxy radicals or C₆-C₂₄-aryl radicals, preferably phenyl or naphthyl. The C₁-C₃₀-alkyl radicals and C₁-C₂₀-alkoxy radicals may optionally be interrupted by one or more double or triple bonds or else one or more heteroatoms, preferably oxygen or nitrogen.

In addition, two or more of the R², R³, R⁴ or R⁵ radicals may also be bridged via aliphatic or aromatic structures, R³ and R⁴ may, for example, including the carbon atoms to which they are bonded in the phenyl ring of the formula (D), form a fused-on phenyl ring so as to result overall in a naphthyl structure.

In the general formula (B), the radical is hydrogen or an alkyl, alkenyl, alkynyl or aryl radical, preferably hydrogen or a C₁-C₃₀-alkyl, a C₂-C₂₀-alkenyl, a C₂-C₂₀-alkynyl or a C₆-C₂₄-aryl radical. More preferably, R⁶ is hydrogen.

Other suitable catalysts are catalysis of the general formula (D1)

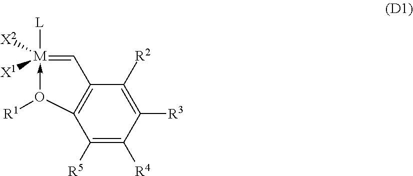

in which M, L, X¹, X², R¹, R², R³, R⁴ and R⁵ may each have the general, preferred and particularly preferred definitions givers for the general formula (D).

The catalysts of the general formula (D1) are known in principle, for example, from US 2002/0107138 A1 (Hoveyda et al,) and can be obtained by preparation processes specified therein.

Particularly suitable catalysts are those of the general formula (D1) where
M is ruthenium,
X¹ and X² are both halogen, especially both chlorine,
R¹ is a straight-chain or branched C₁-C₁₂ alkyl radical,
R², R³, R⁴, R⁵ each have the general and preferred definitions given for the general formula (D) and
L has the general and preferred definitions given for the general formula (D).

Especially suitable catalysts are those of the general formula (D1) where
M is ruthenium,
X¹ and X² are both chlorine,
R¹ is an isopropyl radical,
R², R³, R⁴, R⁵ are all hydrogen and
L is an optionally substituted imidazolidine radical of the formula (4a) or (4b),

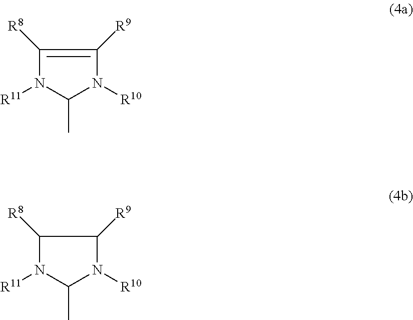

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₃₀-alkoxycarbonyl, C₁-C₂₀-alkylthio, C₆-C₂₄-arylthio, C₁-C₂₀-alkylsulphonyl, C₁-C₃₀-alkylsulphonate, C₆-C₂₄-arylsulphonate or C₁-C₃₀-alkylsulphinyl, where the aforementioned radicals may each be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents too may in turn be substituted by one or more radicals, preferably selected from the group of halogen, especially chlorine or bromine, C₁-C₅-alkyl, C₁-C₅-alkoxy and phenyl.

A very particularly suitable catalyst is one which is covered by the general structural formula (D1) and has the formula (9), where each Mes is 2,4,6-trimethylphenyl.

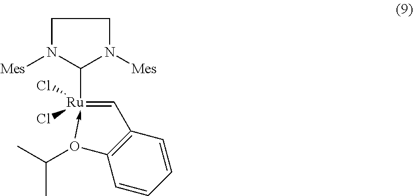

This catalyst (9) is also referred to in the literature as “Hoveyda catalyst”.

Further suitable catalysts are those which are covered by the general structural formula (D1) and have one of the following formulae; (10), (11), (12), (13), (14), (15), (16) and (17), where each Mes is 2,4,6-trimethylphenyl.

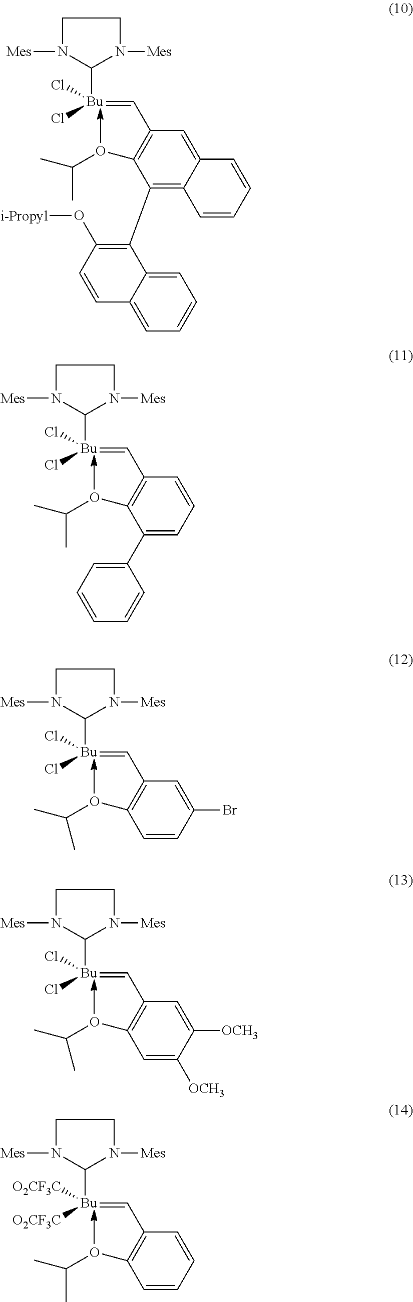

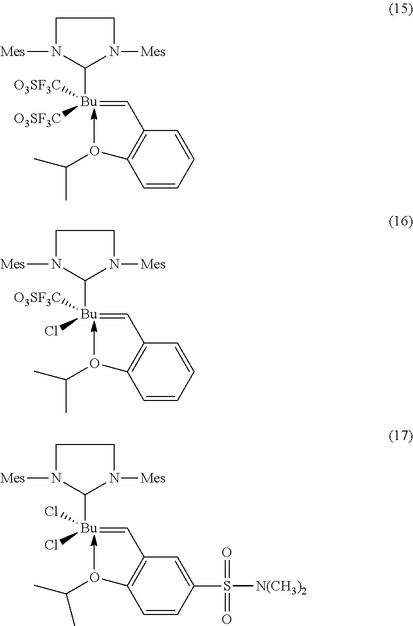

A further suitable catalyst is a catalyst of the general formula (D2)

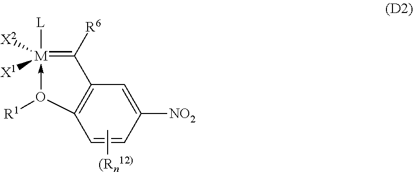

in which
M, L, X³, X², R¹ and R⁶ each have the general and preferred definitions given for the formula (D),
R¹² are the same or different and have the general and preferred definitions given for R², R³, R⁴ and R⁵ in formula (D),excluding hydrogen, and
n is 0, 1, 2 or 3,

The catalysts of the general formula (D2) are known in principle, for example, from WO-A-2004/035596 (Grela) and can be obtained by preparation processes specified therein.

Particularly suitable catalysts are those of the general formula (D2) in which
M is ruthenium,
X¹ and X² are both halogen, especially both chlorine,
R¹ is a straight-chain or branched C₁-C₁₂ alkyl radical,
R¹² is as defined for the general formula (D2),
n is 0, 1, 2 or 3,
R⁶ is hydrogen and
L is as defined for the general formula (D),

Especially suitable catalysts are those of the general formula (D2) in which
M is ruthenium,
X¹ and X² are both chlorine,
R¹ is an isopropyl radical,
n is 0 and
L is an optionally substituted imidazoline radical of the formula (4a) or (4b) in which R⁸, R⁹, R¹⁰, R¹¹ are the same or different and are each as defined for the especially preferred catalysts of the general formula (D1).

Particularly suitable catalysts are those of the structures (18) (“Grela catalyst”) and (19) below, where each Mes is 2,4,6-trimethylphenyl

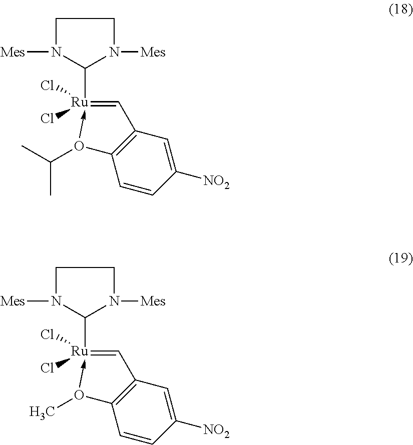

Another suitable catalyst is a dendritic catalyst of the general formula (D3)

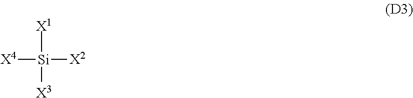

in which X¹, X², X³ and X⁴ each have a structure of the general formula (20) bonded to the silicon of the formula (D3) via the methylene group shown on the right and

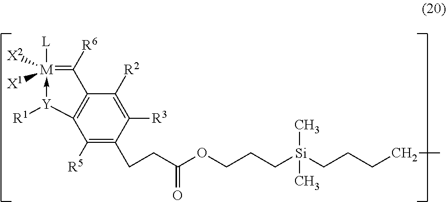

in which
M, L, X¹, X², R¹, R², R³, R⁵ and R⁶ may each have the general and preferred definitions given for the general formula (D),

The catalysts of the general formula (D3) are known from US 2002/0107138 A1 and can be prepared according to the details given therein.

Another suitable catalyst is a catalyst of the formula (D4)

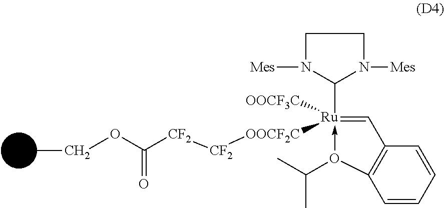

in which the symbol represents a support.

The support is preferably a poly(styrene-divinylbenzene) copolymer (PS-DVB).

The catalysts according to formula (D4) are known in principle from Chem, Eur. J. 2004 10, 777-784 and are obtainable by preparation methods described therein.

All the aforementioned catalysts of the (D), (D1), (D2), (D3) and (D4) types can either be used as such in the hydrogenation reaction or else they can be applied to a solid support and immobilized. Suitable solid phases or supports are those materials which are firstly inert with respect to the metathesis reaction mixture and secondly do not impair the activity of the catalyst. The catalyst can be immobilized using, for example, metals, glass, polymers, ceramic, organic polymer beads or else inorganic sol-gels, carbon black, silica, silicates, calcium carbonate and barium sulphate.

Other suitable catalysts are catalysts of the general formula (E)

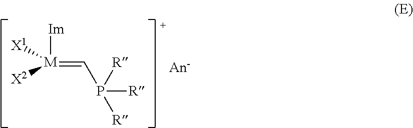

where
M is ruthenium or osmium,
X¹ and X² are the same or different and are each anionic ligands,
R″ are the same or different and are each organic radicals,
Im is an optionally substituted imidazoline or imidazoline radical and
An is an anion.

The catalysts of the general formula (E) are known in principle (see, for example, Angew, Chem. Int. Ed. 2004, 43, 6161-6165).

X¹ and X² in the general formula (E) may have the same general, preferred and particularly preferred definitions as in the formulae (C) and (D).

The Im radical typically has a structure of the general formula (4a) or (4b) which has already been specified for the catalyst type of the formulae (C) and (D) and may also have any of the structures specified there as preferred, especially those of the formulae (5a)-(5f).

The R″ radicals in the general formula (E) are the same or different and are each a straight-chain or branched C₁-C₃₀-alkyl, C₅-C₃₀-cycloalkyl or aryl radical, where the C₁-C₃₀-alkyl radicals may optionally be interrupted by one or more double or triple bonds or else one or more heteroatoms, preferably oxygen or nitrogen.

Aryl comprises art aromatic radical having 6 to 24 skeleton carbon atoms. Preferred mono-, bi- or tricyclic carbocyclic aromatic radicals having 5 to 10 skeleton carbon atoms include, for example, phenyl, biphenyl, naphthyl, phenanthrenyl or anthracenyl.

The R″ radicals in the general formula (E) are preferably the same and are each phenyl, cyclohexyl, cyclopentyl, isopropyl, o-tolyl, o-xylyl or mesityl.

Other suitable catalysts are catalysts of the general formula (F)

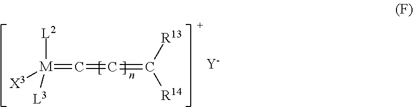

in which
M is ruthenium or osmium,
R¹³ and R¹⁴ are each independently hydrogen, C₁-C₂₀-alkyl, C₂-C₂₀-alkenyl, C₂-C₃₀-alkynyl, C₆-C₂₄-aryl, C₁-C₂₀-carboxylate, C₃-C₂₀-alkoxy, C₂-C₃₀-alkenyloxy, C₂-C₂₀-alkynyloxy, C₆-C₂₄-aryloxy, C₂-C₂₀-alkoxycarbonyl, C₁-C₃₀-alkylthio, C₁-C₂₀-alkylsulphonyl or C₁-C₂₀-alkylsulphinyl,
X³ is an anionic ligand,
L² is an uncharged π-bonded ligand, no matter whether mono- or polycyclic,
L³ is a ligand from the group of the phosphines, sulphonated phosphines, fluorinated phosphines. functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines, stibines, ethers, amines, amides, imines, sulphoxides, thioethers and pyridines,
Y is a noncoordinating anion and
n is 0, 1, 2, 3, 4 or 5.

Other suitable catalysts are catalysts of the general formula (G)

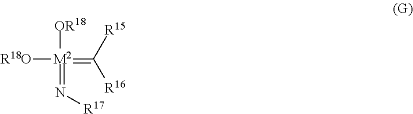

in which
M² is molybdenum,
R¹⁵ and R¹⁶ are the same or different and are each hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
R¹⁷ and R¹⁸ are the same or different and are each a substituted or halogen-substituted C₁-C₂₀-alkyl, C₆-C₂₄-aryl, C₆-C₃₀-aralkyl radical or silicone-containing analogues thereof.

Further suitable catalysts are catalysis of the general formula (H)

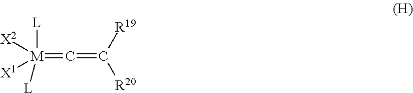

in which
M is ruthenium or osmium,
X¹ and X² are the same or different and are each anionic ligands which may assume all definitions of X¹ and X² given in the general formulae (C) and (D),

L represents identical or different ligands which may assume all definitions of L given in the general formulae (C) and (D),
R¹⁹ and R²⁰ are the same or different and are each hydrogen or substituted or unsubstituted alkyl.

Further suitable catalysts are catalysts of the general formula (K), (N) or (Q)

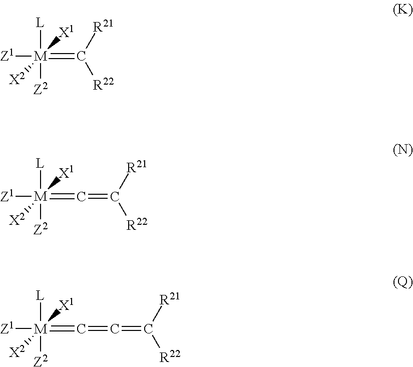

where
M is osmium or ruthenium,
X¹ and X³ are the same or different and are two ligands, preferably anionic ligands,

L is a ligand, preferably an uncharged electron donor,

Z¹ and Z² are the same or different and are each uncharged election donors,

R²¹ and R²² are each independently hydrogen, alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl, each of which is substituted by one or more radicals selected from alkyl, halogen, alkoxy, aryl and heteroaryl.

The catalysts of the general formulae (K), (N) and (Q) are known in principle, for example from WO 2003/011455 A1, WO 2003/087167 A2, Organometallics 2001, 20, 5314 and Angew. Chem. Int, Ed. 2002, 41, 4038. The catalysts are commercially available or else can be synthesized by the preparation methods specified in the aforementioned references.

In the catalysts of the general formulae (K), (N) and (Q), Z¹ and Z² are the same or different and are each uncharged electron donors. These ligands are typically weakly coordinating. They are typically optionally substituted heterocyclic groups. These may be five- or six-membered monocyclic groups having 1 to 4, preferably 1 to 3 and more preferably 1 or 2 heteroatoms or bi- or polycyclic structures composed of 2, 3, 4 or 5 of such five- or six-membered monocyclic groups, where each of the aforementioned groups may optionally be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals, each of which may again be substituted by one or more groups, preferably selected from the group consisting of halogen, especially chlorine or bromine, C₁-C₅-alkyl, C₁-C₅-alkoxy and phenyl.

Examples of Z¹ and Z² include nitrogen-containing heterocycles such as pyridines, pyridazines, bipyridines, pyrimidines, pyrazines, pyrazolidines, pyrrolidines, piperazines, indazoles, quinolines, purines, acridines, bisimidazoles, picolylimines, imidazolidines and pyrroles.

Z¹ and Z² may also be bridged to one another to form a cyclic structure. In this case, Z¹ and Z² are a single bidentate ligand.

In the catalysts of the general formulae (K), (H) and (Q), L may assume the same general, preferred and particularly preferred definitions as L in the general formulae (C) and (D).

In the catalysts of the general formulae (K), (N) and (Q), R²¹ and R²² are the same or different and are each alkyl, preferably C₁-C₃₀-alkyl, more preferably C₁-C₂₀-alkyl, cycloalkyl, preferably C₃-C₂₀-cycloalkyl, more preferably C₃-C₈-cycloalkyl, alkenyl, preferably C₂-C₂₀-alkenyl, more preferably C₂-C₁₆-alkenyl, alkynyl, preferably C₂-C₂₀-alkynyl, more preferably C₂-C₁₆-alkynyl, aryl, preferably C₆-C₃₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where the aforementioned substituents may be substituted by one or more alkyl, halogen, alkoxy, aryl or heteroaryl radicals.

In the catalysts of the general formulae (K), (N) and (Q), X¹ and X² are the same or different and may have the same general, preferred and particularly preferred definitions as specified above for X¹ and X² in the general formula (C).

Particularly suitable catalysts are those of the general formulae (K), (N) and (Q) in which
M is ruthenium,
X¹ and X² are both halogen, especially chlorine,
R¹ and R² are the same or different and are each five- or six-membered monocyclic groups having 1 to 4, preferably 1 to 3 and more preferably 1 or 2 heteroatoms or bi- or polycyclic structures composed of 2, 3, 4 or 5 of such five- or six-membered monocyclic groups, where each of the aforementioned groups may be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals,
R²¹ and R²² are the same or different and are each C₁-C₃₀-alkyl, C₃-C₂₀-cycloalkyl, C₂-C₂₀-alkenyl, C₃-C₂₀-alkynyl, C₆-C₂₄-aryl, C₁-C₂₀-carboxylates, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl, C₁-C₂₀-alkylsulphinyl, and
L has a structure of the general formula (4a) or (4b) already described above, especially of the formulae (5a) to (5f).

A very particularly suitable catalyst is one which is covered by the general formula (K) and has the structure (21)

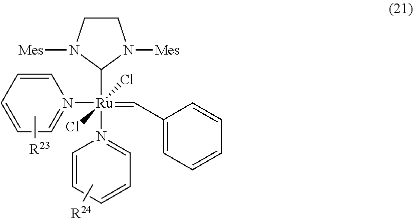

in which
R²³ and R²⁴ are the same or different and are each H, halogen, straight-chain or branched C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl nitro, nitrogen heterocycles, preferably pyridine, piperidine and pyrazine, carboxyl, alkylcarbonyl, halocarbonyl, carbamoyl, thiocarbamoyl, carbamido, thioformyl, amino, dialkylamino, trialkylsilyl and trialkoxysilyl.

The aforementioned C₁-C₂₀-alkyl, C₁-C₂₀-heteroalkyl, C₁-C₁₀-haloalkyl, C₁-C₁₀-alkoxy, C₆-C₂₄-aryl radicals, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, trialkylsilyl and trialkoxysilyl, may again each be substituted by one or more halogen, preferably fluorine, chlorine or bromine, C₁-C₅-alkyl, C₁-C₅-alkoxy or phenyl radicals.

A very particularly suitable catalyst is one in which R²³ and R²⁴ are each hydrogen (“Grubbs III catalyst”).

Also very particularly suitable are catalysts of the structure (22a) or (22b) where R²³ and R²⁴ have the same definitions as in the formula (21), except for hydrogen.

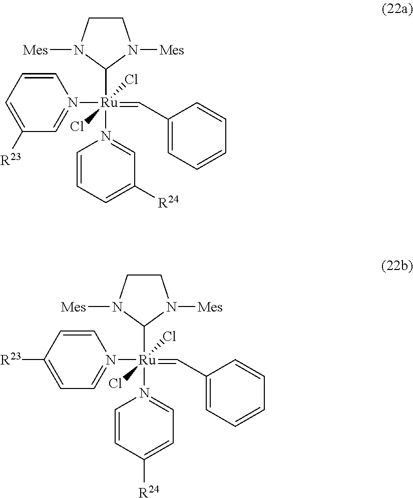

Suitable catalysts covered by the general formulae (K), (N) and (Q) have the structural formulae (23) to (34) below, where each Mes is 2,4,6-trimethylphenyl.

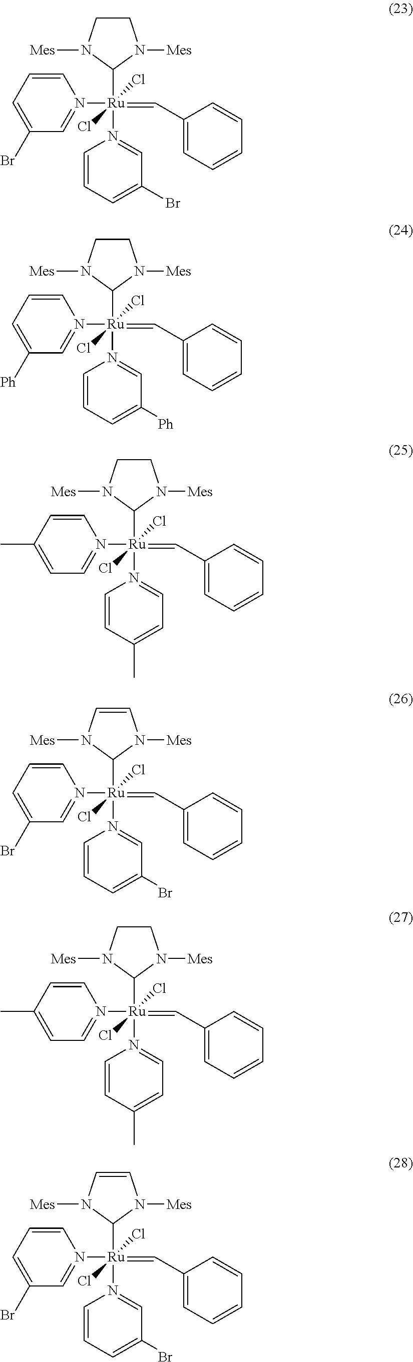

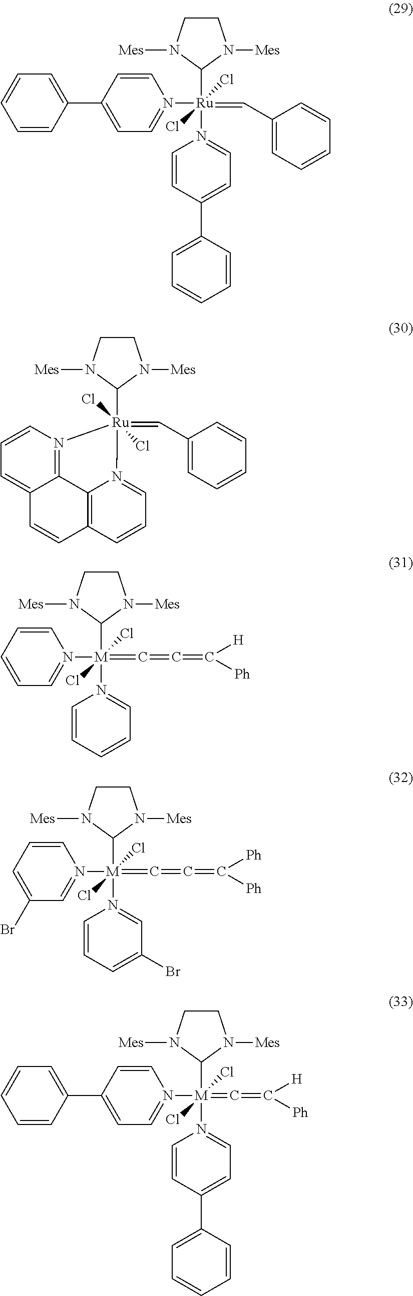

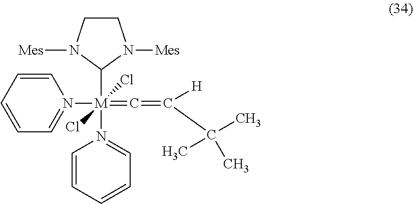

Also suitable are catalysts (E) having the general structural element (R1), where the carbon atom identified by “*” is bonded to the catalyst base skeleton via one or more double bonds,

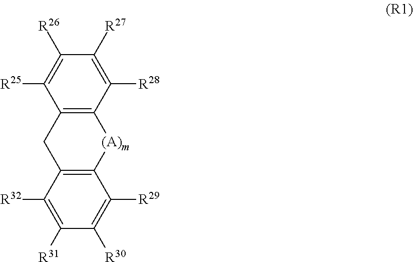

and in which
R²⁵-R³² are the same or different and mean each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻, or are each alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where all these radicals may each optionally be substituted by one or more alkyl, halogen, alkoxy, aryl or heteroaryl radicals, or alternatively two directly adjacent radicals in each case from the group of R²⁵-R³², including the ring carbon atoms to which they are bonded, are bridged to form a cyclic group, preferably an aromatic system, or alternatively R⁸ is optionally bridged with another ligand of the ruthenium- or osmium-carbene complex catalyst,
m is 0 or 1 and
A is oxygen, sulphur, C(R³³R³⁴), N—R³⁵, —C(R³⁶)═C(R³⁷)—, —C(R³⁶)(R³⁸)—C(R³⁷)(R³⁹)—, in which R³³-R³⁹ are the same or different and may each have the same definitions as the radicals.

The inventive catalysts have the structural element of the general formula (R1), where the carbon atom identified by “*” is bonded to the catalyst base skeleton via one or more double bonds. When the carbon atom identified by “*” is bonded to the catalyst base skeleton via two or more double bonds, these double bonds may be cumulated or conjugated.

Catalysts (R) of this kind are described in EP-A-2-027 920. The catalysts (R) with a structural element of the general formula (R1) include, for example, those of the following general formulae (R2a) and (R2b)

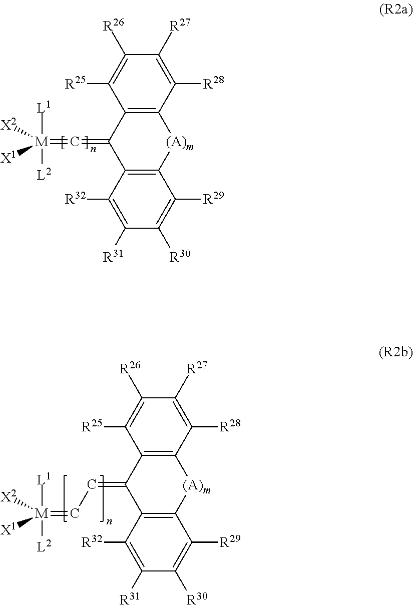

in which
M is ruthenium or osmium,
X¹ and X² are the same or different and are two ligands, preferably anionic ligands,
L¹ and L² are identical or different ligands, preferably uncharged electron donors, where L² may alternatively also be bridged to the R⁸ radical,
n is 0, 1, 2 or 3, preferably 0, 1 or 2,

n′ is 1 or 2, preferably 1, and
R²⁵-R³², m and A each have the same definitions as in the general formula (R1).

In the catalysts of the general formula (R2a), the structural element of the general formula (R1) is bonded to the central metal of the complex catalyst via a double bond (n−0) or via 2, 3 or 4 cumulated double bonds (in the case that n=1, 2 or 3). In the inventive catalysts of the general formula (R2b), the structural element of the general formula (R1) is bonded to the metal of the complex catalyst via conjugated double bonds. In both cases, there is a double bond in the direction of the central metal of the complex catalyst on the carbon atom identified by “*”.

The catalysts of the general formulae (R2a) and (R2b) thus include catalysts in which the following general structural elements (R3)-(R9)

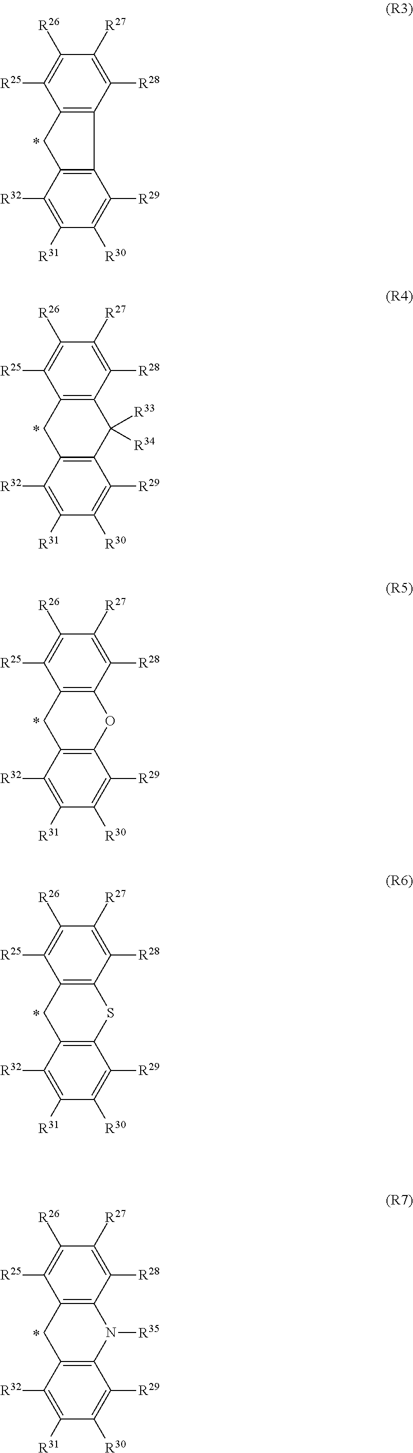

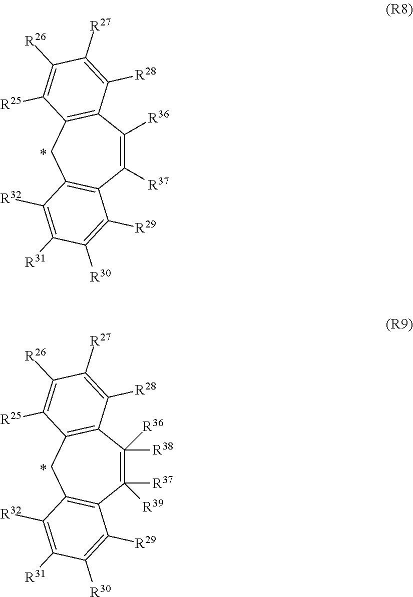

are bonded via the carbon atom identified by “*”, via one or more double bonds, to the catalyst base skeleton of the general formula (R10a) or (R10b)

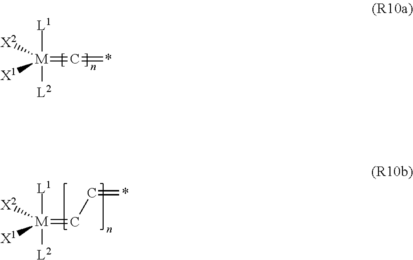

where X¹ and X², L¹ and L², n, n′ and R²⁵-R³⁹ are each as defined for the general formulae (R2a) and (R2b).

Typically, these ruthenium- or osmium-carbene catalysts are pentacoordinated.

In the structural element of the general formula (R1),
R¹⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻, or are alkyl, preferably C₁-C₂₀-alkyl, especially C₁-C₆-alkyl, cycloalkyl, preferably C₃-C₂₀-cycloalkyl, especially C₃-C₈-cycloalkyl, alkenyl, preferably C₂-C₂₀-alkenyl, alkynyl, preferably C₂-C₂₀-alkynyl, aryl, preferably C₆-C₂₄-aryl, especially phenyl, carboxylase, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, alkylsulphinyl, preferably C₁-C₂₀-alkylsulphinyl, dialkylamino, preferably di(C₁-C₂₀-alkyl)amino, alkylsilyl, preferably C₁-C₂₀-alkylsilyl, or alkoxysilyl, preferably C₁-C₂₀-alkoxysilyl, radicals, where all these radicals may optionally each be substituted by one or more alkyl, halogen, alkoxy, aryl or heteroaryl radicals, or alternatively also any two directly adjacent radicals from the group of R²⁵-R³², with inclusion of the ring carbon atoms to which they are bonded, may form a cyclic group by bridging, preferably an aromatic system, or alternatively R⁸ is optionally bridged with another ligand of the ruthenium- or osmium-carbene complex catalyst,
m is 0 or 1 and
A is oxygen, sulphur, C(R³³)(R³⁴), N—R³⁵, —C(R³⁶)═C(R³⁷)—, in which R³³-R³⁹ are the same or different and may each have the same preferred definitions as the R¹-R⁸ radicals.

C₁-C₆-Alkyl in the structural element of the general formula (R1) is, for example, methyl, ethyl, propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl in the structural element of the general formula (R1) is, for example, cyclopropyl, cyclobutyl, cyclopentyl, cyclohexyl, cycloheptyl and cyclooctyl.

C₆-C₂₄-Aryl in the structural element of the general formula (R1) comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The X¹ and X² radicals in the structural element of the general formula (R1) have the same general, preferred and particularly preferred definitions which are specified for catalysts of the general formula (C).

In the general formulae (R2a) and (R2b) and analogously (R10a) and (R10b), the L¹ and L² radicals are identical or different ligands, preferably uncharged electron donors, and may have the same general, preferred and particularly preferred definitions which are specified for the catalysts of the general formula (C).

Preference is given to catalysts of the general formula (R2a) or (R2b) with a general structural unit (N1)
where
M is ruthenium,
X¹ and X² are both halogen,
n is 0, 1 or 2 in the general formula (R2a) or
n′ is 1 in the general formula (R2b)
L¹ and L² are the same or different and have the general or preferred definitions specified for the general formulae (R2a) and (R2b),
R²⁵-R³² are the same or different and have the general or preferred definitions specified for the general formulae (R2a) and (R2b),
m is either 0 or 1,
and, when m=1,
A is oxygen, sulphur, C(C₁-C₁₀alkyl)₃, —C(C₁-C₁₀-alkyl)₂—C(C₁-C₁₀-alkyl)₂—, —C(C₁-C₁₀-alkyl)═C(C₁-C₁₀-alkyl)— or —N(C₁-C₁₀-alkyl)— or —N(C₁-C₁₀-alkyl).

Very particular preference is given to catalysts of the formula (R2a) or (R2b) with a general structural unit (R1) where
M is ruthenium,
X¹ and X² are both chlorine,
n is 0, 1 or 2 in the general formula (R2a) or

n′ is 1 in the general formula (R2b)
L¹ is an imidazoline radical of the formulae (5a) to (5f),
L² is a sulphonated phosphine, phosphate, phosphinite, phosphorite, arsine, stibine, ether, amine, amide, sulphoxide, carboxyl, nitrosyl, or pyridine radical, an imidazoline or imidazolidine radical of the formulae (5a) to (5f) or a phosphine ligand, especially PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃,
R²⁵-R³² have the general or preferred definitions specified for the general formulae (R2a) and (R2b),
m is either 0 or 1,
   and, when m=1,
A is oxygen, sulphur, C(C₁-C₁₀-alkyl)₂, —C(C₁-C₁₀-alkyl)₂—C(C₁-C₁₀-alkyl)₂—, —C(C₁-C₁₀-alkyl)═C(C₁-C₁₀- alkyl)— or —N(C₁-C₁₀-alkyl).

In the case that the R²⁵ radical is bridged with another ligand of the catalyst of the formula R, for example for the catalysts of the general formulae (R2a) and (R2b), this gives rise to the following structures of the general formulae (R13a) and (R13b)

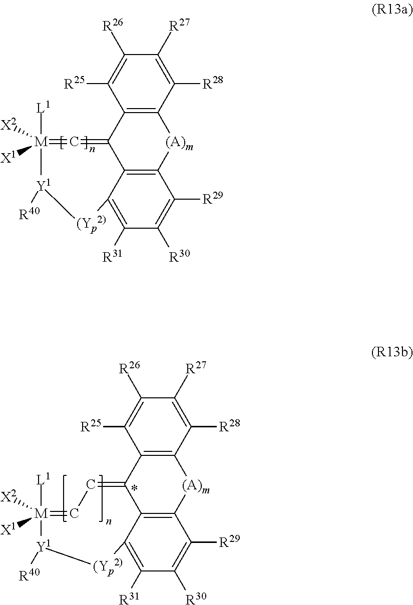

in which
Y¹ is oxygen, sulphur, an N—R⁴¹ radical or a P—R⁴¹ radical, where R⁴¹ is as defined below,
R⁴⁰ and R⁴¹ are the same or different and are each an alkyl, cycloalkyl, alkenyl, alkynyl. aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
p is 0 or 1 and
Y² when p=1 is —(CH₂)ᵣ—where r=1, 2 or 3, —C(═O)—CH₂—, —C(═O)—, —N═CH—, —N(H)—C(═O)—, or else alternatively the overall structural unit “—Y¹(R⁴⁰)—(Y²)ₚ—” is (—N(R⁴⁰)═CH—CH₂—), (—N(R⁴⁰, R⁴¹)═CH—CH₂—), and
   where M, X¹, X², L¹, R²⁵—R³², A, m and n have the same definitions as in the general formulae (R10a) and (R10b).

Examples of catalysts of the general formula (R) include the following structures (35) to (45):

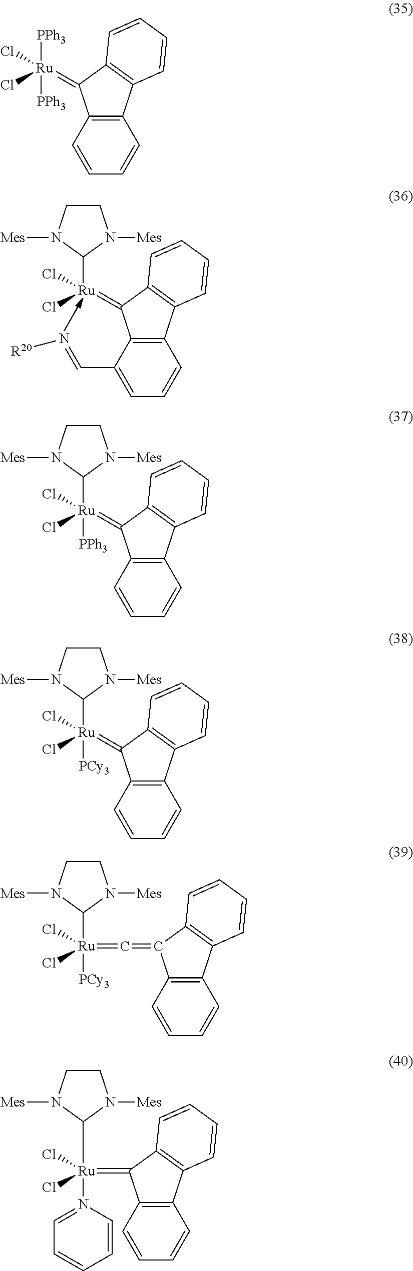

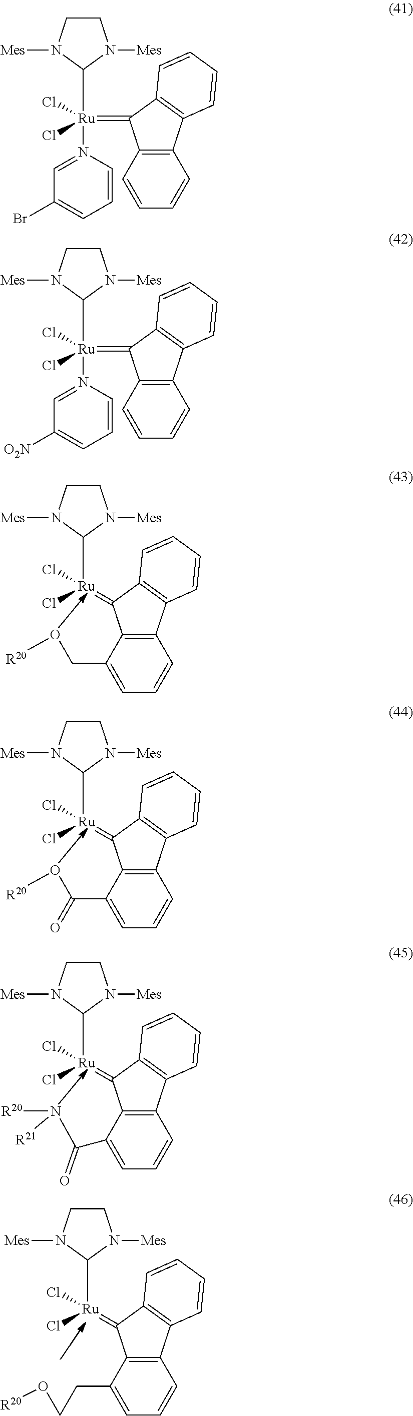

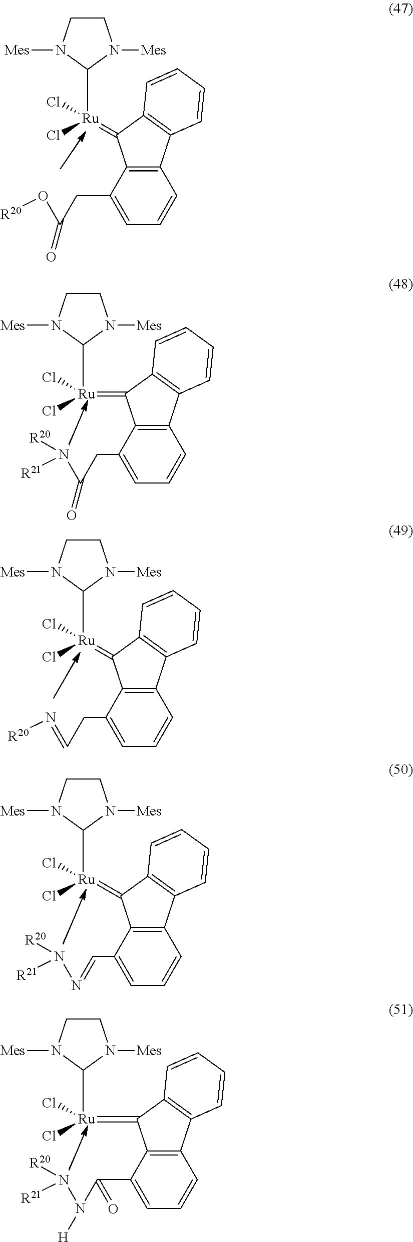

The preparation of catalysis of the general formula (R) is known from EP-A-2 027 920.

Additionally suitable are catalysts according to the general formula (T)

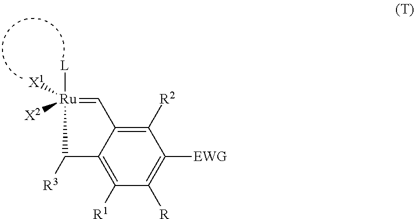

in which:
X¹ and X² are the same or different and are each anionic ligands, or alternatively are joined to one another via carbon-carbon and/or carbon-heteroatom bonds,
Y is an uncharged two-electron donor selected from O, S, N and P,
R are H, halogen, alkyl, alkoxy, aryl, aryloxy, alkylcarbonyl, arylcarbonyl, alkoxycarbonyl, aryloxycarbonyl, heteroaryl, carboxyl (RCO₃⁻), cyano, nitro, amido, amino, aminosulphonyl, N-heteroarylsulphonyl, alkylsulphonyl, arylsulphonyl, alkylsulphinyl, arylsulphinyl, alkythio, arylthio or sulphonamide,
R¹ and R² are each H, Br, I, alkyl, alkoxy, aryl, aryloxy, alkylcarbonyl, arylcarbonyl, alkoxycarbonyl, aryloxycarbonyl, carboxyl, amido, amino, heteroaryl, alkylthio, arylthio, or sulphonamido,
R³ are alkyl, aryl, heteroaryl, alkylcarbonyl, arylcarbonyl, thiocarbonyl, or aminocarbonyl,
EWG is an electron-withdrawing group selected from the group consisting of aminosulphonyl, amidosulphonyl, N-heteroarylsulphonyl, arylsulphonyl, arylsulphinyl, arylcarbonyl, alkylcarbonyl, aryloxycarbonyl, aminocarbonyl, amido, sulphonamido, chlorine, fluorine, H, or haloalkyl and
L is an electron-donating ligand which can be joined to X¹ via carbon-carbon and/or carbon-heteroatom bonds.

These catalysts of the general formula (T) are known from US 2007/0043180 (Zannan).

Preference is given to catalysts of the general formula (T) in which X¹ and X² are selected from an ionic ligand in the form of halides, carboxylates and aryl oxides. More preferably, X¹ and X² are both halides, especially both chlorides. In the general formula (T), Y is preferably oxygen, R is preferably H, halogen, alkoxycarbonyl, aryloxycarbonyl, heteroaryl, carboxyl, amido, alkylsulphonyl, arylsulphonyl, alkylthio, arylthio or sulphonamido. More particularly, R is H, Cl, F or a C₁₋₈ alkoxycarbonyl group, R¹ and R² are the same or different and are preferably each H, alkoxy, aryl, aryloxy, alkoxycarbonyl, amido, alkylthio, arylthio or a sulphonamido group. More particularly, R¹ is H or an alkoxy group and R² is hydrogen. In the general formula (T), R³ is preferably an alkyl, aryl, heteroaryl, alkylcarbonyl or arylcarbonyl group. More preferably, R³ is isopropyl, sec-butyl and methoxyethyl, in the general formula (T), EWG is preferably an aminosulphonyl, amidosulphonyl, N-heteroarylsulphonyl, arylsulphortyl, aminocarbonyl, arylsulphonyl, alkylcarbonyl, aryloxycarbonyl, halogen or haloalkyl group. More preferably, EWG is a C₁₋₁₂ N-alkylaminosulphonyl, C₂₋₁₂ N-heteroaryl sulphonyl, C₁₋₁₂ aminocarbonyl, C₆₋₁₂ arylsulphonyl, C₁₋₁₂ alkylcarbonyl, C₆₋₁₂ arylcarbonyl, C₆₋₁₂ aryloxycarbonyl, Cl, F or trifluoromethyl group. In the general formula (T), L is an electron-donating ligand selected from phosphines, amino, aryl oxides, carboxylates and heterocyclic carbene radicals which may be bonded to X¹ via carbon-carbon and/or carbon-heteroatom bonds.

A particularly suitable catalyst is one of the general formula (T) in which L is a heterocyclic carbene ligand or a phosphine (P(R⁸)₂(R⁹) having the following structures:

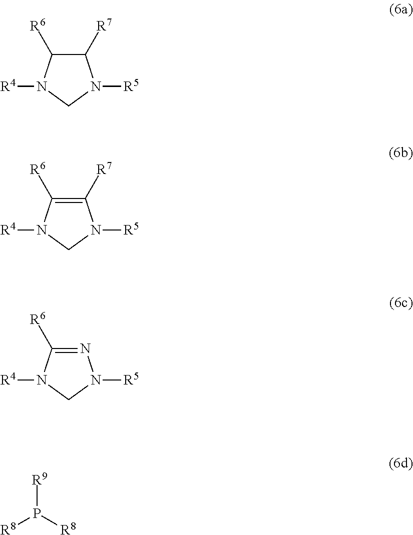

in which
R⁴ and R⁵ are the same or different and are each C₆₋₁₂ aryl and
R⁶ and R⁷ are the same or different and are each H, halogen, alkyl, alkoxy, aryl, aryloxy, alkylcarbonyl, arylcarbonyl, alkoxycarbonyl, aryloxycarbonyl, heteroaryl, carboxyl, cyano, nitro, amido, amino, alkylsulphonyl, arylsulphonyl, alkylsulphinyl, arylsulphinyl, alkylthio or sulphonamido and
R⁸ and R⁹ are the same or different and are each C₁₋₈ alkyl or C₆₋₁₂ aryl.

Additionally suitable are bimetallic complexes of the general formula (I)

M¹ₐM²_{b}Xₘ(L¹)ₙ (U)
in which
M¹ is rhodium (Rh) or ruthenium (Ru),
M² ruthenium (Ru) or a lanthanide,
   where, when M¹ is rhodium (Rh), M² is ruthenium (Ru) or a lanthanide and, when M¹ is ruthenium (Ru), M² is a lanthanide,
X are the same or different and are each H, Cl or Br,
L¹ is an organophosphine (PR¹R²R³), diphosphine (R¹R²P(CH₂)ₙPR³R⁴), organoarsine (AsR¹R²R²) or other organic compounds containing nitrogen, sulphur, oxygen atoms or mixtures thereof, where R¹, R², R³ and R⁴ are the same or different and are each C₁-C₆ alkyl, C₆-C₁₂ cycloalkyl, aryl, C₂-C₁₂ aralkyl or aryloxy groups,
1≦a≦4,
1≦b≦2,
3≦m≦6 and
6≦n≦15.

These catalysts of the general formula (U) are known in principle from U.S. Pat. No. 6,084,033.

Particularly suitable catalysts are those of the general formula (U) in which M¹ is rhodium and M² is ruthenium. Other particularly suitable catalysts are those of the general formula (U) in which M² is a lanthanide, especially Ce or La. In particularly suitable catalysts of the general formula (U), X are the same or different and are each H or Cl. Particularly suitable catalysts of the general formula (U) are those in which L¹ is selected from trimethylphosphine, triethylphosphine, triphenylphosphine, triphenoxyphosphine, tri(p-methoxyphenyl)phosphine, diphenylethylphosphine, 1,4-di(diphenylphosphano)butane, 1,2-di(diphenylphosphano)ethane, triphenylamine, dibutylphenylamine, diphenylethylamine, triphenylamine, triethylamine, N,N-dimethylaniline, diphenyl thioether, dipropyl thioether, N,N′-tetramethylethylenediamine, acetylacetone, diphenyl ketones and mixtures thereof.

Further catalysts which can be used are described in the following documents: U.S. pat. No. 3,700,637, DE-A-24 39 132, EP-A 134 023, DE-A 35 41 689, DE 3540918, EP-A-0 298 386, DE-A 3529252, DE-A 3433 392, U.S. Pat. No. 4,464,515, U.S. Pat. No. 4,503,196 and EP-A-1 720 920.

Amount of Hydrogenation Catalyst:

For the hydrogenation of the nitrile rubber, the hydrogenation catalyst can be used within a wide range of amounts. Typically, the catalyst is used in an amount of 0.001 to 1.0% by weight, preferably from 0.01 to 0.5% by weight, especially 0.05 to 0.3% by weight, based on the nitrile rubber to be hydrogenated.

Other hydrogenation conditions:

The practical performance of the hydrogenation is sufficiently well known to those skilled in the art, inter alia, for example, from U.S. Pat. No. 6,683,136A.

Solvent:

The hydrogenation is typically effected in a solvent, preferably an organic solvent. Suitable organic solvents are, for example, acetone, methyl ethyl ketone, ethyl acetate, tetrahydrofuran, 1,3-dioxane, benzene, toluene, methylene chloride, chloroform, monochlorobenzene and dichlorobenzene. Monochlorobenzene has been found to be particularly useful, since it is a good solvent both for nitrile rubbers having different nitrile contents and for the corresponding resulting hydrogenated nitrile rubbers.

Nitrile rubber concentration:

For the hydrogenation, nitrile rubber is typically dissolved in at least one solvent. The concentration of the nitrile rubber in the hydrogenation is generally in the range of 1-30% by weight, preferably in the range of 5-25% by weight, more preferably in the range of 7-20% by weight.

The pressure in the hydrogenation is typically within the range from 0.1 bar to 250 bar, preferably from 5 bar to 200 bar, more preferably from 50 bar to 150 bar. The temperature is typically within the range from 0° C. to 180° C. preferably from 20° C. to 160° C., more preferably from 50° C. to 150° C. The reaction time is generally 2 to 10 h.

In the course of the hydrogenation, the double bonds present in the nitrile rubber used are hydrogenated to the extent desired and as already disclosed in the preceding parts of the application.

The hydrogenation was monitored online by determining the hydrogen absorption or by Raman spectroscopy (EP-A-0 897 933) or IR spectroscopy (U.S. Pat. No. 6,522,408). A suitable IR method for offline determination of the hydrogenation level is additionally described by D. Brück in Kautschuke+Gummi, Kunststoffe, Vol. 42. (1989), No. 2, p. 107-110 (part 1) and in Kautschuke+Gummi, Kunststoffe, Vol. 42. (1989), No. 3, p. 194-197.

On attainment of the desired hydrogenation level, the reactor is decompressed. Residual amounts of hydrogen are typically removed by nitrogen purging.

Before the isolation of the hydrogenated nitrile rubber from the organic phase, the hydrogenation catalyst can be removed. A preferred process for rhodium recovery is described, for example, in U.S. Pat. No. 4,985,540.

If the hydrogenation in the process according to the invention is effected with addition of a phosphine or diphosphine, these are typically used in amounts of 0.1 to 10% by weight, preferably of 0.25 to 5% by weight, more preferably 0.5 to 4% by weight, even more preferably 0.75 to 3.5% by weight and especially 1 to 3% by weight, based on the nitrile rubber to be hydrogenated.

Based on 1 equivalent of the hydrogenation catalyst, the phosphine or diphosphine, in a tried and tested manner, is used in an amount in the range from 0.1 to 10 equivalents, preferably in the range from 0.2 to 5 equivalents and more preferably in the range from 0.3 to 3 equivalents.

The weight ratio of the added phosphine or diphosphine to the hydrogenation catalyst is typically (1-100):1, preferably (3-30):3, especially (5-15):1.

On completion of the hydrogenation, a hydrogenated nitrile rubber having a Mooney viscosity (ML 1+4 @ 100° C.), measured to ASTM Standard D 1646, in the Hinge of 1-50 is obtained. This corresponds roughly to a weight-average molecular weight Mw in the range of 2000-400 000 g/mol. Preferably, the Mooney viscosity (ML 1+4 @100° C.) is in the range from 5 to 30. This corresponds roughly to a weight-average molecular weight Mw in the range of about 20 000-200 000. The hydrogenated nitrile rubbers obtained also have a polydispersity PDI=M_{w}-Mₙ, where M_{w} is the weight-average and Mₙ the number-average molecular weight, in the range of 1-5 and preferably in the range of 1.5-3.

It is also possible to subject the nitrile rubber to a metathesis reaction before the hydrogenation, in order to lower the molecular weight of the nitrile rubber. The metathesis of nitrile rubbers is sufficiently well known to those skilled in the art. If a metathesis is effected, it is also possible to conduct the subsequent hydrogenation in situ, i.e. in the same reaction mixture in which the metathesis degradation has also been effected beforehand and without the need to isolate the degraded nitrile rubber. The hydrogenation catalyst is simply added to the reaction vessel.

### Step 2:

Phosphine- or diphosphine-containing hydrogenated nitrile rubber is contacted with the sulphur donor having at least two sulphur atoms covalently bonded directly to one another. This results in formation of the phosphine sulphide or diphosphine sulphide from the phosphine or diphosphine and hence in reduction extending as far as the complete removal of the amount of phosphine or diphosphine.

The phosphine- or diphosphine-containing hydrogenated nitrile rubber may either be in dissolved form or in solid form on contact with the sulphur donor.

The two following alternative embodiments, for example, have been found to be useful:

In a first embodiment, the sulphur donor can be added after the end of the hydrogenation and before or during the isolation of the hydrogenated nitrile rubber from the hydrogenation reaction mixture. Suitable methods for the isolation of the hydrogenated nitrile rubber from the organic solution are the vaporization of the organic solvent by the action of heat or of reduced pressure or by steam distillation. Preference is given to effecting a steam distillation. In this case, the subsequent removal of the rubber crumbs from the aqueous dispersion is effected by sieving and final mechanical and/or thermal drying. Preference is given to steam distillation. Depending on the pressure employed, the latter is conducted at a reaction temperature of typically 80 to 120° C., preferably about 100° C.

It has been found to be useful to add the sulphur donor in organic or aqueous solution before or during the isolation of the hydrogenated nitrile rubber.

If the sulphur donor is oil-soluble, the sulphur donor is added to the hydrogenation reaction mixture, in dissolved form, in which case the solvent for the solution of the sulphur donor is appropriately identical to the solvent in which the phosphine- or diphosphine-containing hydrogenated nitrile rubber is present. If the sulphur donor is water-soluble, the sulphur donor is added to the hydrogenation reaction mixture as an aqueous solution and mixed well therewith.

Optionally, the addition of the sulphur donor may be preceded by a catalyst recovery.

In a second embodiment, the phosphine- or diphosphine-containing hydrogenated nitrile rubber can be admixed and converted in the solid state with at least one above-defined sulphur donor, In this form, it can be obtained by isolation from the hydrogenation reaction mixture. In that case, the phosphine- or diphosphine-containing hydrogenated nitrile rubber is in a substantially solvent-free state. Useful equipment for this embodiment has been found to be roll mills, internal mixers or extruders. Preference is given to using a roll mill or an internal mixer. A typical, commercially available roll mill is thermostatable and has two contra-rotating rolls. The sulphur donor is incorporated with selection of a suitable roll temperature, for example in the range of 10-30° C., preferably at 20° C.+/−3° C., and of a suitable rotation speed, preferably in the range of 25 to 30 min⁻¹, of a suitable roll nip, for example in the region of a few millimetres, and of a suitable rolling time, which is generally a few minutes. The milled rubber sheet obtained is subsequently typically cut and folded over and optionally applied to the roll once again.

In this embodiment, the sulphur donor is typically also used in solid form.

The reaction of the phosphines or diphosphines with the sulphur donor to give phosphine sulphides or diphosphine sulphides is effected at suitable temperatures depending on the reactivity of the sulphur donor used. The reaction temperatures are preferably within the range from 10° C. to 150° C., more preferably within the range from 80° C. to 120° C. and especially within the range from 90° C. to 110° C. The reaction time for the reaction is typically within the range from 1 min to 5 h and can be determined by the person skilled in the art depending on the temperature selected.

The sulphur donors for use in the process according to the invention contain at least two sulphur atoms covalently bonded directly to one another.

Suitable sulphur donors have, for example, the following general formulae (5a)-(5e):

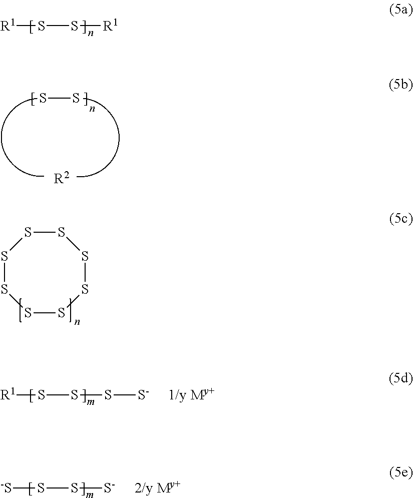

in which
M^{y+} is a y-valently charged cation where y is 1, 2, 3 or 4, preferably an alkali metal cation, an alkaline earth metal cation, NH₄⁺ or N(R³)₄⁺ in which R³ is the same or different and is a linear, branched, aliphatic, bridged, cycloaliphatic or wholly or partly aromatic radical,
n is a number in the range from 1 to 1000,
m is a number in the range from 0 to 998,
R¹ is hydrogen or a radical having 1 to 20 carbon atoms, where this radical may contain up to five heteroatoms selected from the group consisting of N, P, S, O and Si, and may be linear, branched, aliphatic, bridged, cycloaliphatic and/or wholly or partly aromatic,
R² is a divalent radical which has 1 to 20 carbon atoms and may contain up to 5 heteroatoms selected from the group consisting of N, P, S and O, and may be linear, branched, aliphatic, bridged, cycloaliphatic and/or wholly or partly aromatic,

In a preferred embodiment, at least one sulphur donor selected from compounds of the general formulae (5a)-(5e) is used,
in which
M^{y+} is a lithium, sodium or potassium cation with y=1, a magnesium, calcium or barium cation with y=2, NH₄⁺ or N(R³)₄⁺ in which R³ is the same or different and is a linear or branched C₁-C₁₈-alkyl radical,
n is a number in the range from 1 to 100,
m is a number in the range from 0 to 98,
R¹ is C₁-C₁₈-alkyl, especially methyl, ethyl, n-propyl, isopropyl, n-butyl, tert.-butyl, n-hexyl, phenyl, naphthyl, n-dodecyl, tert dodecyl or stearyl, —(C═S)—NR₂; —(C═O)—NR₂; —(C═O)—OR; —(C═S)—OR; —(P═S)(OR)₂; —(P═S)(SR)₂; —(C═NH)—NR₂; —(C═NR)—OR; —(C═NR)—SR or —SO₃⁻, in which each R is the same or different and is C₁-C₁₄-alkyl or C₅-C₁₄-aryl and is unsubstituted or mono- or polysubstituted,
R² is a straight-chain or branched alkanediyl, alkenediyl or alkynediyl group, more preferably a straight-chain or branched C₁-C₂₀-alkanediyl, C₃-C₂₀-alkenediyl or C₂-C₂₀-alkynediyl group, especially preferably a straight-chain or branched C₁-C₈-alkanediyl, C₂-C₆-alkenediyl or C₂-C₆-alkynediyl group.

C₁-C₈-Alkanediyl is a straight-chain or branched alkanediyl radical having 1 to 8 carbon atoms. Particular preference is given to a straight-chain or branched alkanediyl radical having 1 to 6 carbon atoms, especially having 2 to 4 carbon atoms. Preference is given to methylene, ethylene, propylene, propane-1,2-diyl, propane-2,2-diyl, butane-1,3-diyl, butane-2,4-diyl, pentane-2,4-diyl and 2-methyl-pentane-2,4-diyl,
C₂-C₆-Alkenediyl is a straight-chain or branched alkenediyl radical having 2 to 6 carbon atoms. Preference is given to a straight-chain or branched alkenediyl radical having 2 to 4, more preferably having 2 to 3, carbon atoms. Preference is given to vinylene, allylene, prop-1-ene-1,2-diyl and but-2-ene-1,4-diyl.
C₂-C₆-Alkynediyl is a straight-chain or branched alkynediyl radical having 2 to 6 carbon atoms. Preference is given to a straight-chain or branched alkynediyl radical having 2 to 4, more preferably having 2 to 3, carbon atoms. Preference is given to ethynediyl and propynediyl.

In one embodiment, it has been found to be useful to use at least one sulphur donor of the general formula (5a) having the general substructure (5a-1)

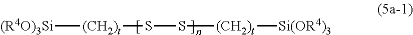

in which
n is a number in the range from 1 to 100, preferably 1 to 20, more preferably 1 to 10,
t is the same or different and is an integer in the range from 1 to 20, preferably 1 to 10, more preferably 1 to 8 and
R⁴ are the same or different, preferably the same, and are each linear or branched C₁-C₁₈—, preferably C₁-C₁₀— and more preferably C₁-C₆-alkyl radicals.

Preferred sulphur donors which can be used in accordance with the invention are selected from the group consisting of elemental sulphur in the form of S₈ rings or in the form of polymeric sulphur, which may be in crystalline, semi-crystalline or amorphous form, diphenyl disulphide, di(n-dodecyl) disulphide, di(tert-dodecyl) disulphide, tetraethylthiuram disulphide, tetrabutylthiuram disulphide, dipentamethylenethiuram tetrasulphide, dimorpholyl disulphide, diethylxanthogen disulphide, diisopropylxanthogen disulphide, di-n-butylxanthogen disulphide, ammonium polysulphide, sodium polysulphide, potassium polysulphide, bis[(5-ethyl-1,3-dioxan-5-yl)methyl]xanthogen disulphide, dibenzothiazyl disulphide, 2-morpholinodithiobenzothiazole, bis(triethoxysilylpropyl) polysulphides in which the chain length of the sulphur is in the range from 2 to 4, and bis(silatranylalkyl) polysulphides (see, for example, WO-A-2008/084885).

The amount of sulphur donor used is calculated on the basis of the amount of phosphine or diphosphine present in the hydrogenation of the nitrile rubber. The molar amount of sulphur donor (calculated as S) is preferably 5 to 300%, preferably 50 to 150%, more preferably 75 to 125%, of the molar amount of the phosphine or diphosphine present in the hydrogenation beforehand. Thus, for Sₛ rings, for example, ⅛ of the molar percentage given should be used. The aforementioned molar amounts of the sulphur donor also apply, however, in relation to the amount of phosphine or diphosphine present in the hydrogenated nitrile rubber before the inventive conversion.

In % by weight, the sulphur donor, again calculated as sulphur, is added after the hydrogenation preferably in an amount of 5 to 25% by weight, preferably 7 to 20% by weight, especially 10 to 15% by weight, based on 300% by weight of the phosphine or diphosphine present in the hydrogenation beforehand. The aforementioned percentages by weight of the sulphur donor also apply, however, in relation to the amount of phosphine or diphosphine present in the hydrogenated nitrile rubber before the inventive conversion.

The process according to the invention converts the phosphines or diphosphines to phosphine sulphides and diphosphine sulphides typically to an extent of at least 50 mol %, preferably to an extent of at least 80 mol %, and more preferably to an extent of at least 95 mol % up to 100 mol %. It is especially possible to conduct the conversion of the phosphine/diphosphine virtually quantitatively or even quantitatively.

Correspondingly, the content of phosphines or diphosphines, based on the sum total of (i) phosphine sulphides or diphosphine sulphides and (ii) phosphine or diphosphine in the hydrogenated nitrile rubber, is typically less than 50 mol %, preferably less than 20 mol % and more preferably less than 5 mol % down to 0 mol %. More particularly, complete removal of the phosphine or diphosphine is also possible.

The determination of the triphenylphosphine (TPP) and triphenylphosphine sulphide (TPP-S) content in the hydrogenated nitrile rubber is effected by the methodology specified in the examples.

Even without addition of sulphur donors after the hydrogenation, small traces of phosphine sulphides may form in individual cases, but these are below 0.075% by weight, based on the hydrogenated nitrile rubber. As is also apparent from the examples, the controlled addition of sulphur donors to the hydrogenated nitrile rubber leads to the advantages of the invention through the conversion of phosphines or diphosphines to phosphine sulphides and diphosphine sulphides.

The present invention further provides vulcanizable mixtures comprising the inventive hydrogenated nitrile rubbers and at least one crosslinking system. In addition, the vulcanizable mixtures may also comprise one or more further customary rubber additives.

These vulcanizable mixtures are typically produced by mixing the inventive hydrogenated nitrile rubbers (i) with at least one crosslinking system (ii) and optionally one or more further additives.

The crosslinking system comprises at least one crosslinker and optionally one or more crosslinking accelerators.

Typically, the inventive hydrogenated nitrile rubber is first mixed with all the additives selected, and the crosslinking system composed of at least one crosslinker and optionally a crosslinking accelerator is the last to be mixed in.

Useful crosslinkers include, for example, peroxide crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)-3-hexyne.

It may be advantageous to use, as well as these peroxidic crosslinkers, also further additions which can help to increase the crosslinking yield: suitable examples thereof include triallyl isocyanurate, triallyl cyanurate, trimethylolpropane tri(meth)acrylate, triallyltrimellitate, ethylene glycol dimethacrylate, butanediol dimethacrylate, trimethylolpropane trimethacrylate, zinc acrylate, zinc diacrylate, zinc methacrylate, zinc dimethacrylate, 1,2-polybutadiene or N,N′-m-phenylenedimaleimide.

The total amount of the crosslinker(s) is typically in the range from 1 to 20 phr, preferably in the range from 1.5 to 15 phr and more preferably in the range from 2 to 10 phr, based on the fully or partly hydrogenated nitrile rubber.

The crosslinkers used may also be sulphur in elemental soluble or insoluble form, or sulphur donors. Useful sulphur donors include, for example, dimorpholyl disulphide (DTDM), 2-morpholinodithiobenzothiazole (MBSS), caprolactam disulphide, dipentamethylenethiuram tetrasulphide (DPTT) and tetramethylthiuram disulphide (TMTD).

It is also possible to use further additions which can help to increase the crosslinking yield in the sulphur vulcanization of the inventive hydrogenated nitrile rubbers. In principle, the crosslinking can also be effected with sulphur or sulphur donors alone.

Suitable additions which can help to increase the crosslinking yield are, for example, dithiocarbamates, thiurams, thiazoles, sulphenamides, xanthogenates, guanidine derivatives, dithiophosphates, caprolactams and thiourea derivatives.

Dithiocarbamates used may be, for example: ammonium dimethyldithiocarbamate, sodium diethyldithiocarbamate (SDEC), sodium dibutyldithiocarbamate (SDBC), zinc dimethyldithiocarbamate (ZDMC), zinc diethyldithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate.

Thiurams used may be, for example: tetraethylthiuram disulphide (TMTD), tetraethylthiuram monosulphide (TMTM), dimethyldiphenylthiuram disulphide, tetrabenzylthiuram disulphide, dipentamethylenethiuram tetrasulphide and tetraethylthiuram disulphide (TETD).

Thiazoles used may be, for example: 2-mercaptobenzothiazole (MET), dibenzothiazyl disulphide (MBTS), zinc mercaptobenzothiazole (ZMBT) and copper 2-mercaptobenzothiazole.

Sulphenamide derivatives used may be, for example: N-cyclohexyl-2-benzothiazylsulphenamide (CBS), N-tert-butyl-2-benzothiaxylsulphenamide (TBBS), N,N′-dicyclohexyl-2-benzothiazylsulphenamide (DCBS), 2-morpholinothiobenzothiazole (MBS), N-oxydiethylenethiocarbamyl-N-tert-butylsulphenamide and oxydiethylenethiocarbamyl-N-oxyethylenesulphenamide.

Xanthogenates used may be, for example; sodium dibutylxanthogenate, zinc Isopropyldibutylxanthogenate and zinc dibutylxanthogenate.

Guanidine derivatives used may be, for example: diphenylguanidine (DFG), di-o-tolylguanidine (DOTG) and o-tolylbiguanide (OTBG).

Dithiophosphates used may be, for example: zinc di(C₂-C₁₆)alkyldithiophosphates, copper di(C₂-C₁₆)alkyldithiophosphates and dithiophosphoryl polysulphide.

A caprolactam used may be, for example, dithiobiscaprolactam.

Thiourea derivatives used may be, for example, N,N′-diphenylthiourea (DFTU), diethylthiourea (DETU) and ethylenethiourea (ETU).

Crosslinking is also possible with crosslinkers having at least two isocyanate groups—either in the form of at least two free isocyanate groups (—NCO) or else in the form of protected isocyanate groups from which the —NCO groups are released in situ under the crosslinking conditions.

Equally suitable as additions are, for example: zinc diaminodiisocyanate, hexamethylenetetramine, 1,3-bis(citraconimidomethyl)benzene and cyclic disulphanes.

The additions and also the crosslinking agents mentioned can be used either individually or in mixtures. Preference is given to using the following substances for the crosslinking of the inventive hydrogenated nitrile rubbers: sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkyldithiophosphate, dimorpholyl disulphide, tellurium diethyldithiocarbamate, nickel dibutyldithiocarbamate, zinc dibutyldithiocarbamate, zinc dimethyldithiocarbamate and dithiobiscaprolactam.

The crosslinking agents and additions mentioned can each be used in amounts of about 0.05 to 10 phr, preferably 0.1 to 8 phr, especially 0.5 to 5 phr (single dose, based in each case on the active substance) based on the fully or partly hydrogenated nitrile rubber.

In the case of sulphur crosslinking, it may also be appropriate, in addition to the crosslinking agents and abovementioned additions, also to use further inorganic or organic substances as well, for example: zinc oxide, zinc carbonate, lead oxide, magnesium oxide, calcium oxide, saturated or unsaturated organic fatty acids and zinc salts thereof, polyalcohols, amino alcohols, for example triethanolamine, and amines, for example dibutylamine, dicyclohexylamine, cyclohexylethylamine and polyether amines.

If the inventive hydrogenated nitrile rubbers are those including repeating units of one or more termonomers containing carboxyl groups, crosslinking can also be effected via the use of a polyamine crosslinker, preferably in the presence of a crosslinking accelerator. The polyamine crosslinker is not restricted, provided that it is either (1) a compound that contains two or more amino groups (optionally also in salt form) or (2) a species that forms a compound that contains two or more amino groups in situ during the crosslinking reaction. Preference is given to using an aliphatic or aromatic hydrocarbon compound in which at least two hydrogen atoms are replaced either by amino groups or else by hydrazide structures (the latter being a “—C(═O)NHNH₂” structure).

Examples of such polyamine crosslinkers (ii) are:
aliphatic polyamines, preferably hexamethylenediamine, hexamethylenediamine carbamate, tetramethylenepentamine, hexamethylenediamine-cinnamaldehyde adduct or hexamethylenediamine dibenzoate;
aromatic polyamines, preferably 2,2-bis(4-(4-aminophenoxy)phenyl)propane, 4,4′-methylenedianiline, m-phenylenediamine, p-phenylenediamine or 4,4′-methylenebis(o-chloroaniline);
compounds having at least two hydrazide structures, preferably isophthalic dihydrazide, adipic dihydrazide or sebacic dihydrazide.

Particular preference is given to hexamethylenediamine and hexamethylenediamine carbamate.

The amount of the polyamine crosslinker in the vulcanizable mixture is typically in the range from 0.2 to 20 parts by weight, preferably in the range from 1 to 15 parts by weight and more preferably in the range from 1.5 to 10 parts by weight, based on 100 parts by weight of the hydrogenated nitrile rubber.

Crosslinking accelerators used in combination with the polyamine crosslinker may be any known to those skilled in the art, preferably a basic crosslinking accelerator. Usable examples include, for example, tetramethylguanidine, tetraethylguanidine, diphenylguanidine, di-o-tolylguanidine (DOTG), o-tolylbiguanidine and di-o-tolylguanidine salt of dicatecholboric acid. Additionally usable are aldehyde amine crosslinking accelerators, for example n-butylaldehydeaniline. More preferably at least one bi- or polycystic aminic base is used as crosslinking accelerator. These are known to those skilled in the art. The. following are especially suitable: 1,8-diazabicyclo[5.4.1]undec-7-ene (DBU), 1,5-diaxabicyclo[4.3.0]-5-nonene (DBN), 1,4-diazabicyclo[2.2.2]octane (DABCO), 1,5,7-triazabicyclo[4.4.0]dec-6-ene (TBD), 7-methyl-1,5,7-triazabicyclo[4.4.0]dec-5-ene (MTBD).

The amount of the crosslinking accelerator in this case is typically within a range from 0.5 to 10 parts by weight, preferably 1 to 7.5 parts by weight, especially 2 to 5 parts by weight, based on 100 parts by weight of the hydrogenated nitrile rubber.

The vulcanizable mixture based on the inventive hydrogenated nitrile rubber may in principle also contain scorch retardants, which differ between vulcanization with sulphur and with peroxides:

In the case of vulcanization with sulphur, the following are used: cyclohexylthiophthalimide (CTP), N,N′-dinitrosopentamethylenetetramine (DNPT), phthalic anhydride (PTA) and diphenylnitrosamine. Preference is given to cyclohexylthiophthalimide (CTP).

In the case of vulcanization with peroxides, scorch is retarded using compounds as specified in WO-A-97/01597 and U.S. Pat. No. 4,857,571. Preference is given to sterically hindered p-dialkylaminophenois, especially Ethanox 703 (Sartomer).

The further customary rubber additives include, for example, the typical substances known to those skilled in the art, such as fillers, filler activators, scorch retardants, antiozonants, ageing stabilizers, antioxidants, processing aids, extender oils, plasticizers, reinforcing materials and mould release agents.

Fillers used may, for example, be carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form), or silicates. The fillers are typically used in amounts in the range front 5 to 350 parts by weight, preferably from 5 to 300 parts by weight, based on 100 parts by weight of the hydrogenated nitrile rubber.

Useful filler activators include organic silanes in particular, for example vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane. isooctyltrimethoxysilane, isooctyltriethoxysilane, hexadecyltrimethoxysilane or (octadecyl)methyldimethoxysilane. Further filler activators are, for example, interface-active substances such as triethanolamine and ethylene glycols with molecular weights of 74 to 10 000 g/mol. The amount of filler activators is typically 0 to 10 phr, based on 100 phr of the inventive hydrogenated nitrile rubber.

Ageing stabilizers added to the vulcanizable mixtures may, for example, be the following: polymerized 2,2,4-trimethyl-1,2-dihydroquinoline (TMQ), 2-mercaptobenzimidazole (MBI), methyl-2-mercaptobenzimidazole (MMBI) or zinc methylmercaptobenzimidazole (ZMMBI). Alternatively, it is also possible to use the following, though less preferred, ageing stabilizers: aminic ageing stabilizers, for example in the form of mixtures of diaryl-p-phenylenediamines (DTPD), octylated diphenylamine (ODPA), phenyl-α-naphthylamine (PAN) and/or phenyl-β-naphthylamine (PBN), Preference is given to using those based on phenylenediamine. Examples of phenylenediamines are N-isopropyl-N′-phenyl-p-phenylenediamine, N-1,3-dimethylbutyl-N′-phenyl-α-phenylenediamine (6PPD), N-1,4-dimethylpentyl-N′-phenyl-p-phenylenediamine (7PPD) and N,N′-bis-1,4-(1,4-dimethylpentyl)-p-phenylenediamine (7PPD).

The ageing stabilizers are typically used in amounts of up to 10 parts by weight, preferably up to 5 parts by weight, more preferably 0.25 to 3 parts by weight, especially 0.4 to 1.5 parts by weight, based on 100 parts by weight of the hydrogenated nitrile rubber.

Examples of useful mould release agents include saturated or partly unsaturated fatty acids and oleic acids and derivatives thereof (fatty acid esters, fatty acid salts, fatty alcohols, fatty acid amides), which are preferably used as a mixture constituent, and also products applicable to the mould surface based on low molecular weight silicone compounds, products based on fluoropolymers and products based on phenol resins.

The mould release agents are typically used in amounts from about 0 to 10 parts by weight, preferably 0.5 to 5 parts by weight, based on 100 parts by weight of the inventive hydrogenated nitrile rubber.

Another possibility is reinforcement with strengthening agents (fibres) made of glass, according to the teaching of U.S. Pat. No. 4,826,721, and another is reinforcement by cords, woven fabrics, fibres made of aliphatic and aromatic polyamides (Nylon®, Aramid®), polyesters and natural fibre products.

The mixing of the components for the purpose of producing the vulcanizable mixtures is typically effected either in an internal mixer or on a roll. Internal mixers used are typically those having what is called an intermeshing rotor geometry. At the starting point, the internal mixer is charged with the inventive hydrogenated nitrile rubber. This is typically in bale form and in that case is first comminuted. After a suitable period, which can be fixed by the person skilled in the art without difficulty, the addition of the additives and typically, at the end, of the crosslinking system is effected. The mixing is effected under temperature control, with the proviso that the mixture remains at a temperature in the range from 100 to 150° C. for a suitable time. After a suitable mixing period, the internal mixer is vented and the shaft is cleaned. After a further period, the internal mixer is emptied to obtain the vulcanizable mixture. All the aforementioned periods are typically in the region of a few minutes and can be fixed by the person skilled in the art without difficulty as a function of the mixture to be produced. If rolls are used as mixing units, it is possible to proceed in an analogous manner and sequence in the metered addition.

The invention further provides a process for producing vulcanizates based on the inventive hydrogenated nitrile rubbers, characterized in that the vulcanizable mixture comprising the inventive hydrogenated nitrile rubber is subjected to vulcanization. Typically, the vulcanization is effected at temperatures in the range from 100° C. to 200° C., preferably at temperatures of 120° C. to 190° C. and most preferably of 130° C. to 180° C.

The vulcanization is preferably effected in a shaping process.

For this purpose, the vulcanizable mixture is processed further by means of extruders, injection moulding systems, rolls or calenders. The preformed mass thus obtainable is typically then vulcanized to completion in presses, autoclaves, hot air systems, or in what are called automatic mat vulcanization systems, and useful temperatures have been found to be in the range from 100° C. to 200° C., preferably 140° C. to 191° C. The vulcanization time is typically 1 minute to 24 hours and preferably 2 minutes to 1 hour. Depending on the shape and size of the vulcanizates, a second vulcanization by reheating may be necessary to achieve complete vulcanization.

The invention therefore likewise provides the vulcanizate, preferably in the form of a moulding, which is obtainable by the aforementioned vulcanization process. These vulcanizates feature a reduced compression set and elevated moduli.

These vulcanizates may take the form of a drive belt, of roller coverings, of a seal, of a cap. of a stopper, of a hose, of floor covering, of sealing mats or sheets, profiles or membranes. Specifically, the vulcanizates may be an O-ring seal, a flat seal, a shaft sealing ring, a gasket sleeve, a sealing cap, a dust protection cap, a connector seal, a thermal insulation hose (with or without added PVC), an oil cooler hose, an air suction hose, a power steering hose, a shoe sole or parts thereof, or a pump membrane.

Surprisingly, the phosphine sulphide or diphosphine sulphide formed in the hydrogenated nitrile rubber in the process according to the invention by the reaction of phosphines or diphosphines with the specific sulphur donors disrupt neither the vulcanization characteristics thereof nor the vulcanizate properties of the hydrogenated nitrile rubber. In this respect, the present invention makes it possible to conduct the catalytic hydrogenation of nitrile rubber with a high reaction rate and simultaneously small amounts of catalyst and at lower pressure with hydrogenation catalysts having at least one phosphine or diphosphine ligand, and/or with phosphines/diphosphines as cocatalysts, and nevertheless to obtain hydrogenated nitrile rubbers and hence vulcanizates having the desired profile of properties.

### EXAMPLES

1. Analysis

Determination of the Triphenylphosphine (“TPP”) Content and Triphenylphosphine Sulphide (“TPP=S” or “TPPS”) Content

The triphenylphosphine and triphenylphosphine sulphide consents in the hydrogenated nitrile rubber were determined by means of gas chromatography using an internal standard. For the determination, 2 to 3 g±0.01 g of HNBR in each case were weighed into a small test tube and dissolved with 25 ml of acetone, a known amount of an internal standard (docosane from Sigma-Aldrich; CA: 629-97-0) was added and, after mixing thoroughly, precipitation was effected by adding 50 ml of methanol. The precipitation serum was separated by means of gas chromatography using a capillary column (e.g.: HP-5, 0.25 μm film, 30 m×0.32 mm ID).

Injection volume: 1 μl

Injection temperature: 300° C.

Oven temperature programme: Adjustment to 150° C.: then heating to 300° C. within 10 min and maintenance of this temperature for 5 min.

Detector temperature: 300° C.

For detection, a flame ionization detector (FID) was used.

Under the given conditions, TPP, TPP=S and the internal standard have the following retention times:

TPP: 8.47 min

Docosane: 8.65 min

TPP=S: 12.13 min

For quantitative determination of the amounts of TPP and TPP=S present in HNBR, response factors of TPP/n-docosane and of TPP=S/docosane were used, which had been determined beforehand in independent measurements relating to the linear calibration range.

Where “<0.01% by wt.” is reported under TPP contents in the tables which follow, this means that (any) TPP content was below the analytical detection limit.

Determination of the Hydrogenation Level;

The exact hydrogenation levels were determined after the hydrogenation of the nitrile rubber had ended by the methods described in Kautschuk+Gummi, kunststoffe, vol 42 (1989), no. 2, 107-110 and Kautschuk+Gummi. Kunststoffe, vol, 42 (1989), no. 3, 194-197.

2. Reactions

Nitrile Rubber Used:

The nitrile rubber used for all the hydrogenations described hereinafter was produced according to EP-A-1 369 436, Example 2. It had the following characteristic parameters;
Acrylonitrile content: 34.5% by weight
Mooney viscosity [ML1+4@100° C.]:

Experiment Series 1, 2, 3 and 6

The hydrogenated nitrile rubbers used in Experiment Series 1, 2, 3 and 6 were obtained by hydrogenation in 17.5% by weight solution at a hydrogen pressure of 190 bar at a temperature of 120° C. to 130° C. , using the amounts of TPP given in the tables which follow. In each of the hydrogenations, 5.25 kg of the abovementioned nitrile rubber were dissolved in 24.25 kg of chlorobenzene in a 40 l autoclave. Before the hydrogenation, each polymer solution was successively contacted once with nitrogen (20 bar) and twice with hydrogen (20 bar) while stirring (170 rpm), and then decompressed. After injecting hydrogen to 190 bar, the amounts of TPP specified in the tables (Merck Schachardt OHG; cat. no. 8.08270) were each metered in as a solution in 250 g of chlorobenzene. The hydrogenation was started by adding, as a catalyst, 0.1% by weight (based on nitrile rubber) of tris(triphenylphosphine)rhodium(I) chloride (Evonik Industries AG) as a solution in 250 g of chlorobenzene. The course of the hydrogenation was observed online by determining the hydrogen absorption. Each hydrogenation was stopped at hydrogenation levels of 99.5±0.3% by cooling the reaction mixture. Subsequently, the mixtures were decompressed. Residual amounts of hydrogen were removed by means of passage of nitrogen.

Experimental Series 4 (a and b):

For Experiment Series 4a and 4b, the abovementioned nitrile rubber was likewise used. The hydrogenation was conducted in analogy to Experiment Series 1, 2, 3 and 6 under the following boundary conditions:
NBR concentration in chlorobenzene: 12% by weight.
Hydrogen pressure: 80 bar
Stirrer speed: 600 min⁻¹
Reaction temperature: 138° C.
Tris(triphenylphosphine)rhodium(I) chloride: 0.08 phr
Triphenylphosphine: 1 phr

The hydrogenation was stopped at a hydrogenation level of 94.5% by cooling the reaction mixture. Subsequently, the mixtures were decompressed. Residual amounts of hydrogen were removed by passing nitrogen through.

Experiment Series 5:

For Experiment Series 5, the abovementioned nitrile rubber was likewise used. Before the hydrogenation, a metathesis degradation of the nitrile rubber was conducted according to WO-A-02/100905 using 0.05 phr of Grubbs-II catalyst (purchased from Materia, Pasadena) and 2.0 phr of 1-hexene in chlorobenzene solution at 80° C. The subsequent hydrogenation was conducted in analogy to Experiment Series 1, 2, 3 and 6 under the following boundary conditions:
NBR concentration in chlorobenzene: 12% by weight
Hydrogen pressure: 80 bar
Stirrer speed: 600 min⁻¹
Reaction temperature: 138° C.
Tris(triphenylphosphine)rhodium(I) chloride: 0.08 phr
Triphenylphosphine: 3 phr

The hydrogenation was stopped at a hydrogenation level of 96% by cooling the reaction mixture. Subsequently, the mixtures were decompressed. Residual amounts of hydrogen were removed by passing nitrogen through.

Catalyst Recovery:

In Experiment Series 1, 2, 3, 4a and 6, there was no removal of the rhodium used in the hydrogenation. In Experiment Series 4b and 5, the catalyst was removed after the hydrogenation as described in Example 5 of U.S. Pat. No. 4,985,540, using the thiourea-containing ion exchange resin from this Example 5. For the removal of rhodium, the polymer solution was diluted to a solids concentration of 5% by weight.

Sulphur Donors

The sulphur donors used were the compounds A-G specified in Table I:

TABLE I
Sulphur Donors

| Sulphur | | Provenance and | Molar mass |
|---|---|---|---|
| donor | | characteristics | [g/mol] |
| A | elemental sulphur | 90/95 ground sulphur, Chancel; (Deutsche Solvay-Werke) | 32 |
| B | potassium polysulphide (abbreviated as KPS hereinafter) | Sigma-Aldrich, cat. no.: 12665; CAS 37199-66-9; K₂Sₓ with x = 2-6 | — |
| C | tetraethylthiuram disulphide (abbreviated hereinafter as “TETD”) 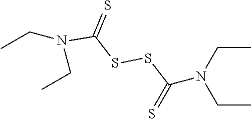 [SMILES: CCN(CC)C(=S)SSC(=S)N(CC)CC] | Rhenogran ® TETD (RheinChemie, Mannheim) | 297 |
| D | bis[(5-ethyl-1,3-dioxan-5-yl)methyl]-xanthogen disulphide (abbreviated hereinafter as “MTX”) 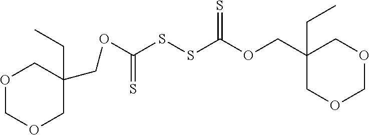 [SMILES: CCC1(COC(=S)SSC(=S)OCC2(CC)COCOC2)COCOC1] | Preparation according to EP 0 053 319 A1, Example 4a), free sulphur content: 1.0% by weight | 443 |
| E | bis(pentamethylene)thiuram tetrasulphide (abbreviated hereinafter as “DPTT”) 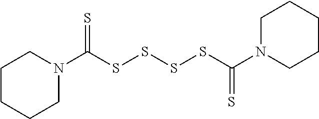 [SMILES: S=C(SSSSC(=S)N1CCCCC1)N1CCCCC1] | Rhenogran ® DPTT-70 (RheinChemie Rheinau GmbH; active ingredient content of 70% by weight) | 385 |
| F | bis(triethoxysilylpropyl) polysulphide (abbreviated hereinafter as “Si 69 ®”) 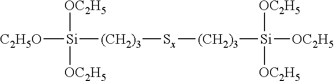 | Si69 ® (Evonik Industries AG) according to manufacturer data the mean length of the sulphur bridge: <x> = 3.75 | 539 |
| G | bis(triethoxysilylpropyl) polysulphide (abbreviated hereinafter as “Si 75 ®”) 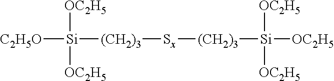 | Si75 ® (Evonik Industries AG) according to manufacturer data the mean length of the sulphur bridge: <x> = 2.35 | 475 |

In Experiment Series 2, 3, 4a and 4b, the sulphur donor was added prior so the performance of the steam distillation, with addition of sulphur donors A, C, D, E, F and G directly to the chlorobenzene solution of the hydrogenated nitrile rubber. The water-soluble sulphur donor B was dissolved in distilled water ( 1/10 of the total amount of chlorobenzene solution of the hydrogenated nitrile rubber) and added to the solution of the hydrogenated nitrile rubber with stirring.

The removal of she chlorobenzene was effected batchwise by steam distillation. The steam was introduced at standard pressure via a ring nozzle at the base of the stripping vessel. In the course of this, the vapours consisting of chlorobenzene and steam distilled off at a top temperature of 102° C. The vapours were condensed and separated into a chlorobenzene phase and an aqueous phase. As soon as chlorobenzene no longer separated out of the vapours (after about 3 h), the steam distillation was stopped. The hydrogenated nitrile rubber, which was in the form of relatively coarse lumps, was isolated and dried to constant weight in a vacuum drying cabinet at 70° C. and a gentle air stream.

In Experiment Series 5a and 5b and Experiment Series 6a and 6b, the sulphur donors or triphenylphosphine sulphide were mixed in in solid form on a roll. A detailed description of the procedure is given for the respective experimental series.

Rubber Mixtures and Vulcanization:

To assess the processing characteristics and to determine the vulcanization rate and the vulcanizate properties, the hydrogenated nitrile rubbers obtained in the experiment series were mixed with constituents listed in Table II.

TABLE II
Composition of the vulcanizable mixtures

| | Name of the commercial product | Amount |
|---|---|---|
| Mixture constituent | (manufacturer/supplier) | [parts by wt.] |
| isolated hydrogenated nitrile rubber | | 100 |
| produced according to the Experiment | | |
| Series | | |
| zinc oxide | Zinkweiss Rotsiegel; | 2.0 |
| | (Grillo Zinkoxid GmbH) | |
| magnesium oxide | Maglite ® DE (Merck & Co. Inc. USA) | 2.0 |
| octylated diphenylamine | Rhenofit ® DDA-70 | 1.43 |
| | (RheinChemie Rheinau GmbH) | |
| zinc salt of 2-mercaptobenzimidazole | Vulkanox ® ZMB-2 | 0.4 |
| | (Lanxess Deutschland GmbH) | |
| carbon black | Corax ® N 550 (Evonik Industries AG) | 45 |
| triallyl isocyanurate | Kettlitz-TAIC 50 | 3.0 |
| | (Kettlitz Chemie GmbH) | |
| bis(tert-butylperoxyisopropyl)benzene | Perkadox ® 14-40 K-PD | 7 |
| (40%) | (Akzo-Nobel Chemicals GmbH) | |

The mixture was produced in a laboratory kneader of capacity 1.5 1 (GK 1.5 E from Werner & Pfleiderer, Stuttgart), with intermeshing kneading elements (PS 5A—paddle geometry), which had been preheated to 50° C. The mixture constituents were added in the sequence specified in Table II.

Properties of the Unvulcanized Rubber Mixtures:

To assess the processing characteristics of the unvulcanized rubber mixtures, Mooney viscosities after 1 min of heating time and after 4 minutes of measuring time at 100° C. (ML1+4#100° C.), and at 120° C. (ML1+4#120° C.), were determined to ASTM D1646. Low values for both the mixture viscosity and the Mooney relaxation are indications of good processibility of the rubber mixtures.

The vulcanization characteristics of the mixtures were determined to ASTM D 5289-95 at 180° C. Both a Bayer-Frank vulcameter (front Agfa) and a moving die rheometer (MDR2000 from Alpha Technology) were used for this purpose (see experiment series). Characteristic vulcameter values such as Fₘᵢₙ, Fₘₐₓ, Fₘₐₓ−Fₘᵢₙ are obtained in the dimension cN in the case of the Bayer-Frank vulcameter, and in the dimension dNm in the case of the moving die rheometer. Characteristic times such as t₁₀, t₅₀, t₉₀ and t₉₅ are determined in minutes (min) or seconds (sec) irrespective of the test method.

According to DIN 53 529, Part 3, the following characteristics have the following meanings:
Fₘᵢₙ: vulcameter value at the minimum of the crosslinking isotherm
Fₘₐₓ: vulcameter value at the maximum of the crosslinking isotherm
Fₘₐₓ−Fₘᵢₙ: difference in the vulcameter values between maximum and minimum
t₁₀: time at which 10% of the final conversion has been attained
t₅₀: time at which 50% of the final conversion has been attained
t₉₀: time at which 90% of the final conversion has been attained
t₉₅: time at which 95% of the final conversion has been attained

The specimens used for ihe vulcanizate characterization were produced in a press at a hydraulic pressure of 120 bar. The vulcanization times and temperatures are given in the experiment series. The vulcanizates of some experiment series were subjected to a heat treatment at 150° C. for 6 hours prior to the characterization (see experiment series).

Using the vulcanizates, the following properties were determined in the standards specified in each case:
DIN 53505: Shore A hardness at 23° C. and 70° C. (“Shore A/23 C” and “Shore A/70° C”)
DIN 53512: Resilience at 23° C. and 70° C.
DIN 53504: Stress values at 10%, 25%, 50%, 100%, 200% and 300% strain (σ₁₀, σ₂₅, σ₅₀, σ₁₀₀, σ₂₀₀ and σ₃₀₀), tensile strength and elongation at break (ε_{b})
DIN 53516: Abrasion

In a Goodrich flexameter, in accordance with DIN 53533, the increase in temperature was determined after dynamic stress. The measurements were conducted at 100° C., a prestress of 1.0 MPa, a stroke of 4.00 mm and a stress time of 25 min. The lower the temperature increase (heat buildup), the better the quality of the vulcanizate.

The compression set (CS) was determined to DIN 53517, by compressing a cylindrical specimen by 25% and storing it in the compressed state for the periods and at the temperatures specified in the tables (e.g. 70 h/23° C. or 70 h/150° C.). After relaxation of the samples, the lasting deformation (compression set) of the sample was determined. For the determination, cylindrical specimens having the following dimensions were used: height: 6.3; diameter: 13 mm; (specimen 1). The lower the lasting deformation, the better the compression set of a sample; in other words, 0% lasting deformation is very good and 100% is very poor.

Experiment Series 1 (Comparison):

In Experiment Series 1a, the amount of TPP used in the hydrogenation was varied. The properties of the hydrogenated nitrile rubber which were determined after the isolation of the hydrogenated nitrile rubber from the chlorobenzene solution (contents of TTP, TTT═S and Mooney values) are summarized in Table 1a.

It is apparent that the hydrogenation times are shortened by the addition of TPP (up to 3.0% by weight based on nitrile rubber). With increasing amount of TPP remaining in the hydrogenated nitrile rubber, there is a deterioration in the modulus values, i.e. the stress values at particular elongations, and in the compression set values of the vulcanizates. The noninventive hydrogenated nitrile rubbers of Experiment Series 1a had TPP contents up to 2.6% by weight and TPP-S contents up to 0.023% by weight.

The hydrogenated nitrile rubbers of Experiment Series 1a were used to produce rubber mixtures having the composition specified in Table II, and vulcanized. Using the vulcanizates, the values reported in Table 1b were determined.

Experiment Series 2 (Inventive Apart from Example 2.1)

In Experiment Series 2, aliquots of various chlorobenzene solutions of hydrogenated nitrile rubbers obtained in Experiment Series 1a were admixed with different amounts of elemental sulphur (at constant molar TPP/sulphur ratio) and worked up (Experiment Series 2a). In Experiment 2.2 the chlorobenzene solution from Experiment 1.3 was used, in Experiment 2.3 the chlorobenzene solution from Experiment 1.4 and in Experiment 2.4 the chlorobenzene solution from Experiment 1.6. This gave hydrogenated nitrile rubbers which had the properties summarized in Table 2a (contents of TPP, TPP=S and Mooney viscosity).

On the basis of the hydrogenated nitrile rubbers of Experiment Series 2a, rubber mixtures having the compositions specified in Table II were produced and vulcanized. Using the vulcanizates, the values reported in Table 2b were determined.

It can be seen that it is surprisingly possible to compensate for the harmful influence of rising contents of TPP on the vulcanizate properties by the addition of elemental sulphur (molar TPP/sulphur ratio=1/1). The content of TPP-S in the inventive hydrogenated nitrile rubbers of Experiment Series 2 was in the range from 0.95 to 3.25% by weight.

Experiment Series 3 (Inventive Apart from Experiment 3.1)

In Experiment Series 3a, the HNBR solution obtained in Experiment 1.3 was converted to aliquots and admixed with different amounts of sulphur. The analytical contents of TPP and TPP=S determined after the isolation of the hydrogenated nitrile rubber from the chlorobenzene solution are compiled in Table 3a.

On the basis of the hydrogenated nitrile rubbers obtained in Experiment Series 3a, rubber mixtures having the compositions specified in Table II were produced and vulcanized. The values obtained using the vulcanizates are summarized in Table 3b.

It was shown that the content of TPP to the hydrogenated nitrile rubber, wish use of 1.0 phr of TPP in the preparation thereof, is reduced by different amounts of added sulphur (molar TPP/sulphur ratio from 0.4/1 to 1.23/1), and the modulus and compression set level of the vulcanized hydrogenated nitrile rubbers is improved. In the inventive examples of Experiment Series 3, the content of TPP=S is in the range from 0.4 to 1.05% by weight.

Experiment Series 4 (Inventive)

In Experiment Series 4a, chlorobenzene solutions of hydrogenated nitrile rubber were reacted with different types and amounts of sulphur donors with variation of the reaction time. The basis for the examples conducted in Experiment Series 4 was a fully hydrogenated nitrile rubber which, was obtained by hydrogenation with addition of 1.2 phr of triphenylphosphine under the boundary conditions employed in Experiment Series 1 (Experiment 4.0).

After the isolation of the hydrogenated nitrile rubbers from the chlorobenzene solutions, the contents of TPP and TPP=S compiled in Tables 4a and 4b were measured. In Experiment Series 4a the rhodium present in the solution was left in the solution; in Experiment Series 4b, in contrast, it was removed prior to addition of the sulphur donors.

It was shown that addition of various sulphur donors to the HNBR solution in chlorobenzene achieves a reduction in the TPP content and an increase in the TPP=S content.

The inventive hydrogenated nitrile rubbers of Experiment Series 4a (4.1* to 4.16*) and 4b (4.17* to 4.21*) have TPP contents in the range up to 0.52% by weight and TPP=S contents in the range up to 1.18% by weight.

Experiment Series 5 (Inventive)

A partly hydrogenated nitrile rubber was used, the molecular weight of which had been reduced beforehand by means of metathesis, before the hydrogenation was conducted in the presence of 3% by weight of TPP. In Experiment Series 5, the sulphur donor used was elemental sulphur or DPTT, which was added to the hydrogenated nitrite rubber without the use of solvents. For this purpose, a temperature-controllable roll mill with two contra-rotating rolls was used (from Schwabenthan: model: Polymix 110; roll diameter 110 mm). Each experimental setting was conducted twice with 450 g each time of hydrogenated nitrile rubber. Before the addition of elemental sulphur or DPTT, the hydrogenated nitrile rubber, in the 1st step, was rolled out to a milled sheet at rotational speeds of 25 and 30 min⁻¹ at a roll nip of 3 mm. The elemental sulphur or DPTT was incorporated by repeatedly cutting into and folding over of the milled sheet under the conditions employed in Table 5a. After the incorporation of the sulphur or DPTT, 2 milled sheets each having identical experimental settings were mixed on the roll, such that a total amount of 900 g of each experimental setting was obtained. Using these samples, the contents of triphenylphosphine and triphenylphosphine sulphide were determined (Experiment Series 5a).

Thereafter, in a laboratory kneader of capacity 1.5 l (GK 1,5 E from Werner & Pfleiderer, Stuttgart) having intermeshing kneading elements (PS 5A—paddle geometry), which had been preheated to 50° C., the mixture constituents specified in Table II were added and mixed in in the sequence specified therein.

On the basis of the rubber mixtures obtained in this way, the properties in the unvulcanized and vulcanized state were determined. The results are summarized in Table 5b.

It was shown that the conversion of TPP to TPP=S is possible even after the isolation of the hydrogenated nitrile rubber from the organic solution. The addition of the sulphur donors in Inventive Examples 5.2*, 5.3*, 5.4*, 5.5* and 5.6* achieved an improvement in the modulus and compression set level. Moreover, in the Goodrich flexometer test, a reduction in the heat buildup was measured.

The inventive hydrogenated nitrile rubbers of Experiment Series 5 contained TPP in the range up to 0.13% by weight and TPP=S in the range from 2.86 to 3.04% by weight.

Experiment Series 6: (Inventive)

In Experiment Series 6a and 6b, the influence of TPP=S on the vulcanizate properties was examined. For this purpose, different amounts of TPP=S (see Experiment Series 6a) were added to the hydrogenated nitrile rubber from Experiment Series 1.1 (=6.1) on a temperature-controllable roll mill with two contra-rotating rolls (from Schwabenthan; model: Polymix 110; roll diameter; 110 mm) in the preparation of mixtures according to Table II. Each experimental setting was conducted twice with 450 g of rubber each time. The incorporation of TPP=S was effected at a roll nip of 3 mm (rotational speeds 25 and 30 min⁻¹) at a roil temperature of 20° C. and a milled sheet temperature of 40° C. by repeatedly cutting into and folding over the milled sheet within a period of 5 min. After the incorporation of the TPP=S, the two milled sheets having the same experimental setting were mixed on the roll, such that a total amount of 900 g was obtained for each experimental setting. Using these samples, the contents of TPP and TPP=S (Table 6a) were determined.

Thereafter, in a laboratory kneader of capacity 1.5 l (GK 1,5 E from Werner & Pfleiderer, Stuttgart) having intermeshing kneading elements (PS 5A—paddle geometry), which had been preheated to 50° C. the mixture constituents specified in Table II) were mixed in. The mixture constituents were added in the sequence specified in Table II).

On the basis of the rubber mixtures obtained in this way, the properties in the unvulcanized and vulcanized state were determined. The results are summarized in Table 6b.

It was shown that the modulus level and compression set of HNBR vulcanizates are not adversely affected by additions of TPP=S.

In the inventive hydrogenated nitrile rubbers, TPP was no longer detectable analytically and the TPP=S content was in the range from 0.99 to 2.97% by weight.

All the results of the experiment series are summarized in the tables which follow. Inventive examples are each indicated by “*”.

TABLE 1a
Experiment Series 1a (comparative examples)
Variation in the amount of TPP in the hydrogenation and the TPP and TPP = S
content in the fully hydrogenated nitrile rubber; no addition of sulphur donor

| | | Experiment No. | | | | | |
|---|---|---|---|---|---|---|---|
| | | 1.1 | 1.2 | 1.3 | 1.4 | 1.5 | 1.6 |
| TPP added in hydrogenation | % by wt. | 0 | 0.50 | 1.0 | 2.0 | 2.5 | 3.0 |
| Hydrogenation time | h | 7.5 | 6.5 | 5.0 | 4.5 | 4.3 | 4.0 |
| Hydrogenation level | % | 99.3 | 99.5 | 99.4 | 99.3 | 99.6 | 99.7 |
| TPP content in the HNBR after | % by wt. | <0.01 | 0.47 | 0.71 | 1.7 | 2.1 | 2.6 |
| workup | | | | | | | |
| TPP = S content in the HNBR | % by wt. | <0.01 | 0.016 | 0.021 | 0.021 | 0.020 | 0.019 |
| after workup | | | | | | | |
| ML1 + 4 @100° C. | MU | 61 | — | 57 | 55 | — | 54 |

TABLE 1b
Experiment Series 1b (comparative examples)
Influence of TPP on the mixture and vulcanizate properties of peroxi-
dically vulcanized hydrogenated nitrile rubbers from Experiment Series 1a

| | | | | |
|---|---|---|---|---|
| Experiment No. | 1.1 | 1.3 | 1.4 | 1.6 |

Mixture properties

| | | | | | |
|---|---|---|---|---|---|
| ML1 + 4 @ 100° C. | MU | 110 | 105 | 102 | 99 |
| ML1 + 4 @ 120° C. | MU | 75 | 71 | 70 | 68 |

Vulcameter at 180° C. (Bayer-Frank vulcameter)

| | | | | | |
|---|---|---|---|---|---|
| t₁₀ | mm | 1.4 | 1.5 | 1.5 | 1.6 |
| t₉₀ | min | 6.9 | 7.2 | 7.3 | 7.4 |
| t₉₀ − t₁₀ | min | 5.5 | 5.7 | 5.8 | 5.8 |
| Fₘᵢₙ | cN | 195 | 179 | 171 | 162 |
| Fₘₐₓ | cN | 4994 | 4450 | 3922 | 3419 |
| Fₘₐₓ − Fₘᵢₙ | cN | 4799 | 4271 | 3751 | 3257 |

Vulcanizate properties (vulcanization at 180° C. for 15 min;
heal treatment at 150° C. for 6 h)

| | | | | | |
|---|---|---|---|---|---|
| Shore A hardness (23° C.) | | 72 | 70 | 70 | 69 |
| Shore A hardness (70° C.) | | 70 | 68 | 66 | 64 |
| Resilience at 23° C. | % | 36 | 37 | 37 | 38 |
| Resilience at 70° C. | % | 56 | 54 | 53 | 52 |
| σ₅₀ | MPa | 2.6 | 2.7 | 2.2 | 2.1 |
| σ₁₀₀ | MPa | 5.7 | 5.5 | 4.5 | 4.2 |
| σ₂₀₀ | MPa | 16.0 | 15.3 | 12.3 | 11.1 |
| σ₃₀₀ | MPa | — | 22.7 | 19.7 | 17.2 |
| Tensile strength | MPa | 24.6 | 24.4 | 24.2 | 22.5 |
| ε_{b} | % | 300 | 345 | 390 | 460 |
| CS (70 h/23° C.) | % | 12.3 | 13.4 | 15.7 | 19.3 |
| specimen 1 | | | | | |
| CS (70 h/150° C.) | % | 29.4 | 29.4 | 32.4 | 36.4 |
| specimen 1 | | | | | |

TABLE 2a
Experiment Series 2a (inventive apart from Example 2.1)
TPP and TPP═S content in the hydrogenated nitrile rubber after
addition of elemental sulphur (molar sulphur/TPP ratio = 1/1)

| Experiment No. | | 2.1 = 1.1 | 2.2* | 2.3* | 2.4* |
|---|---|---|---|---|---|
| TPP addition in | % by wt. | 0 | 1.0 | 2.0 | 3.0 |
| hydrogenation | | | | | |
| Sulphur addition | % by wt. | 0 | 0.122 | 0.244 | 0.367 |
| Molar sulphur | mol/mol | — | 1/1 | 1/1 | 1/1 |
| donon:TPP ratio | | | | | |
| TPP content in | % by wt. | <0.01 | <0.01 | <0.01 | <0.01 |
| HNBR after workup | | | | | |
| TPP═S content in | % by wt. | <0.01 | 0.95 | 2.30 | 3.25 |
| HNBR after workup | | | | | |
| ML1 + 4 @ 100° C. | ME | 61 | 60 | 62 | 59 |

TABLE 2b
Experiment Series 2b (inventive apart from Example 2.1)
Properties of mixtures or vulcanizates based on
hydrogenated nitrile rubber from Experiment Series 2a

| | | | | |
|---|---|---|---|---|
| Experiment No. | 2.1 = 1.1 | 2.2* | 2.3* | 2.4* |

Mixture properties

| | | | | | |
|---|---|---|---|---|---|
| ML1 + 4 @ 120° C. | ME | 75 | 68 | 68 | 69 |

Vulcameter at 180° C. (Bayer-Frank vulcameter)

| | | | | | |
|---|---|---|---|---|---|
| t₁₀ | min | 1.4 | 1.4 | 1.4 | 1.4 |
| t₉₀ | min | 6.9 | 7.6 | 7.6 | 7.5 |
| t₉₀ − t₁₀ | min | 5.5 | 6.2 | 6.2 | 6.1 |
| Fₘᵢₙ | cN | 195 | 114 | 129 | 139 |
| Fₘₐₓ | cN | 4994 | 4752 | 4921 | 5021 |
| Fₘₐₓ − Fₘᵢₙ | cN | 4799 | 4638 | 4792 | 4882 |

Vulcanizate properties (vulcanization at 180° C.
for 15 min; heat treatment at 150° C. for 6 h)

| | | | | | |
|---|---|---|---|---|---|
| Shore A hardness | | 72 | 73 | 72 | 73 |
| (23° C.) | | | | | |
| Shore A hardness | | 70 | 71 | 71 | 72 |
| (70° C.) | | | | | |
| Resilience at 23° C. | % | 36 | 37 | 37 | 36 |
| Resilience at 70° C. | % | 56 | — | — | — |
| σ₁₀₀ | MPa | 5.7 | 6.4 | 6.5 | 7.4 |
| σ₂₀₀ | MPa | 16.0 | 17.3 | 17.3 | 18.8 |
| Tensile strength | MPa | 24.6 | 24.7 | 25.0 | 24.3 |
| ε_{b} | % | 300 | 290 | 295 | 265 |
| CS (70 h/23° C.) of | % | 12.3 | 11.8 | 12.3 | 11.2 |
| specimen 1 | | | | | |
| CS (70 h/150° C.) of | % | 29.4 | 31.1 | 27.7 | 28.3 |
| specimen 1 | | | | | |

TABLE 3a
Experiment Series 3a (inventive apart from Example 3.1)
TPP and TPP = S content in the hydrogenated nitrile rubber with variation of the
molar sulphur danor:TPP ratio

| | | Experiment No. | | | | |
|---|---|---|---|---|---|---|
| | | 3.1 = 1.3 | 3.2* | 3.3* | 3.4* | 3.5* |
| TPP addition in hydrogenation | phr | 1.0 | 1.0 | 1.0 | 1.0 | 1.0 |
| Sulphur addition | phr | — | 0.05 | 0.1 | 0.12 | 0.15 |
| Molar sulphiar donor:TPP ratio | mol/mol | — | 0.41/1 | 0.81/1 | 0.98/1 | 1.23/1 |
| TPP content in HNBR after | % by wt. | 0.71 | 0.25 | 0.14 | <0.01 | <0.01 |
| workup | | | | | | |
| TPP = S content in HNBR after | % by wt. | 0.021 | 0.4 | 0.83 | 0.95 | 1.05 |
| workup | | | | | | |

TABLE 3b
Experiment Series 3b (inventive apart from Example 3.1)
Properties of mixtures or vulcanizates based on hydrogenated nitrile rubber
from Experiment Series 3a

| Experiment No. | | | | |
|---|---|---|---|---|
| 3.1 = 1.3 | 3.2* | 3.3* | 3.4* | 3.5* |

Mixture properties

| | | | | | | |
|---|---|---|---|---|---|---|
| ML1 + 4 @ 120° C. | ME | 71 | 68 | 77 | 76 | 77 |

Vulcameter at 180° C. (Bayer-Frank vulcameter)

| | | | | | | |
|---|---|---|---|---|---|---|
| t₁₀ | min | 1.5 | 1.4 | 1.4 | 1.4 | 1.4 |
| t₉₀ | min | 7.2 | 7.6 | 7.6 | 7.5 | 7.3 |
| t₉₀ − t₁₀ | min | 5.7 | 6.2 | 6.2 | 6.1 | 5.9 |
| Fₘᵢₙ | cN | 179 | 114 | 154 | 144 | 149 |
| Fₘₐₓ | cN | 4450 | 4752 | 5453 | 5561 | 5843 |
| Fₘₐₓ − Fₘᵢₙ | cN | 4271 | 4638 | 5299 | 5417 | 5694 |

Vulcanizate properties (vulcanization at 180° C. for 15 min;
heat treatment at 150° C. for 6 h)

| | | | | | | |
|---|---|---|---|---|---|---|
| Shore A hardness (23° C.) | | 70 | 73 | 75 | 75 | 75 |
| Shore A hardness (70° C.) | | 68 | 71 | 73 | 73 | 73 |
| Resilience at 23° C. | % | 37 | 37 | 37 | 37 | 37 |
| σ₁₀₀ | MPa | 5.5 | 6.4 | 7.5 | 7.7 | 8.0 |
| σ₂₀₀ | MPa | 15.3 | 17.3 | 19.3 | 21.2 | 20.8 |
| Tensile strength | MPa | 24.4 | 24.7 | 25.5 | 26.1 | 26.2 |
| ε_{b} | % | 345 | 290 | 270 | 265 | 260 |
| CS (70 h/23° C.) of specimen 1 | % | 13.4 | 11.8 | 10.2 | 9.8 | 9.6 |
| CS (70 h/150° C.) of specimen 1 | % | 29.4 | 26.2 | 25.8 | 23.1 | 22.8 |

TABLE 4a
Experiment Series 4a (inventive apart from Example 4.0)
Reduction in the amount of TPP by addition of various sulphur donors before the
isolation of the hydrogenated nitrile rubber from the chlorobenzene solution
(without removal of rhodium)

| | | | | Molar | | Contents in | |
|---|---|---|---|---|---|---|---|
| | Sulphur donor | | | sulphur- | Reaction | HNBR after | |
| | (based on 100 g HNBR) | | | donor:TPP | time at | workup | |
| | | Amount | Amount | ratio | 90° C. | TPP | TPP = S |
| No. | Type | [mg] | [mmol] | [mol/mol] | [min] | [% by wt.] | [% by wt.] |
| 4.0 | — | — | — | — | | 0.83 | 0.02 |
| 4.1* | sulphur | 30.8 | 0.96 | 0.25/1 | 60 | 0.39 | 0.32 |
| 4.2* | sulphur | 46.2 | 1.43 | 0.4/1 | 30 | 0.25 | 0.40 |
| 4.3* | sulphur | 61.6 | 1.90 | 0.5/1 | 20 | 0.13 | 0.53 |
| 4.4* | sulphur | 121.6 | 3.80 | 1.0/1 | 10 | <0.01 | 0.95 |
| 4.5* | sulphur | 152.4 | 4.75 | 1.25/1 | 60 | <0.01 | 1.18 |
| 4.6* | sulphur | 183.2 | 5.75 | 1.5/1 | 30 | <0.01 | 1.1 |
| 4.7* | KPS | 996 | — | — | 10 | <0.01 | 0.84 |
| 4.8* | KPS | 504 | — | — | 10 | 0.26 | 0.62 |
| 4.9* | KPS | 252 | — | — | 10 | 0.52 | 0.29 |
| 4.10* | TETD | 1128 | 3.80 | 1.0/1 | 30 | <0.01 | 0.52 |
| 4.11* | MTX | 1684 | 3.80 | 1.0/1 | 30 | 0.49 | 0.08 |
| 4.12* | DPTT | 528 | 0.95 | 0.25/1 | 60 | <0.01 | 0.89 |
| 4.13* | DPTT | 1056 | 1.90 | 0.5/1 | 5 | <0.01 | 0.88 |
| 4.14* | Si 69 | 2048 | 3.80 | 1.0/1 | 10 | <0.01 | 0.79 |
| 4.15* | Si 69 | 516 | 0.96 | 0.25/1 | 10 | 0.12 | 0.54 |
| 4.15* | Si 75 | 1804 | 3.80 | 1.0/1 | 60 | 0.11 | 0.43 |
| 4.16* | Si 75 | 456 | 0.96 | 0.25/1 | 20 | 0.42 | 0.16 |

TABLE 4b
Experiment Series 4b (inventive apart from Example 1.0)
Reduction in the amount of TPP by addition of various sulphur donors
before the isolation or the hydrogenated nitrile rubber from the
chlorobenzene solution with prior removal of rhodium

| | | | | | Contents in | |
|---|---|---|---|---|---|---|
| | Sulphur donor | | | Molar | HNBR after | |
| | (based on 100 g HNBR) | | | sulphur | workup | |
| | | Amount | Amount | donor:TPP | TPP | TPP = S |
| No.: | Type | [mg] | [mmol] | ratio | [% by wt.] | [% by wt.] |
| 4.0 | — | — | — | — | 0.82 | 0.06 |
| 4.17* | sulphur | 30.8 | 0.96 | 0.25/1 | 0.27 | 0.36 |
| 4.18* | sulphur | 61.6 | 1.90 | 0.5/1 | 0.08 | 0.65 |
| 4.19* | sulphur | 121.6 | 3.80 | 1.0/1 | <0.01 | 0.87 |
| 4.20* | sulphur | 152.4 | 4.75 | 1.25/1 | <0.01 | 0.79 |
| 4.21* | sulphur | 183.2 | 5.75 | 1.5/1 | <0.01 | 0.88 |
| 4.22* | TETD | 1128 | 3.80 | 1.0/1 | <0.01 | 0.47 |
| 4.23* | MTX | 1684 | 3.80 | 1.0/1 | <0.01 | 0.68 |

TABLE 5a
Experiment Series 5a (inventive apart from Example 5.1)
TPP and TPP = S contents of hydrogenated nitrile rubber after addition of
sulphur donors on the roll (hydrogenation with 3.0% by weight of TPP,
corresponding to 11.44 mmol/100 g)

| | | | | Reaction | | Contents in | |
|---|---|---|---|---|---|---|---|
| Sulphur donor | | | Molar | conditions | | HNBR | |
| (based on 100 g HNBR) | | | sulphur | Temperature | | TPP | TPP = S |
| | Amount | Amount | donor:TPP | [° C.] | Time | [% by | [% by |

| No.: | Type | [mg] | [mmol] | ratio | Roll | Sheet | [min.] | wt.] | wt.] |
|---|---|---|---|---|---|---|---|---|---|
| 5.1 | — | — | — | | 20 | 45 | 10.0 | 2.65 | 0.02 |
| 5.2* | sulphur | 292 | 9.13 | 0.80/1 | 80 | 85 | 10.0 | 0.13 | 2.86 |
| 5.3* | sulphur | 328 | 10.25 | 0.90/1 | 50 | 65 | 5.0 | <0.01 | 3.01 |
| 5.4* | sulphur | 365 | 11.41 | 1.0/1 | 20 | 45 | 4.0 | <0.01 | 3.02 |
| 5.5* | DPTT | 1426 | 3.70 | 0.32/1 | 50 | 65 | 5.0 | <0.01 | 3.04 |
| 5.6* | DPTT | 1584 | 4.11 | 0.36/1 | 20 | 45 | 5.0 | <0.01 | 2.94 |

TABLE 5b
Experiment Series 5b (inventive apart from Example 5.1)
Properties of the mixtures and vulcanizates based on the partly hydrogenated
nitrile rubbers from Experiment Series 5a

| Experiment No.: | | | | | |
|---|---|---|---|---|---|
| 5.1 | 5.2* | 5.3* | 5.4* | 5.5* | 5.6* |

Mixture properties

| | | | | | | | |
|---|---|---|---|---|---|---|---|
| ML1 + 4 @ 120° C. | ME | 51.5 | 55.5 | 59.1 | 60.6 | — | — |

Vulcameter at 180° C. (Monsanto die rheometer)

| | | | | | | | |
|---|---|---|---|---|---|---|---|
| t₁₀ | sec | 41 | 40 | 39 | 37 | 35 | 31 |
| t₅₀ | sec | 130 | 122 | 118 | 114 | 104 | 88 |
| t₉₀ | sec | 381 | 347 | 335 | 324 | 301 | 270 |
| t₉₅ | sec | 498 | 447 | 427 | 412 | 382 | 340 |
| t₉₀ − t₁₀ | sec | 340 | 307 | 311 | 287 | 266 | 239 |
| Fₘᵢₙ | dNm | 1.37 | 1.49 | 1.63 | 1.70 | 2.10 | 2.72 |
| Fₘₐₓ | dNm | 19.58 | 26.50 | 26.16 | 25.48 | 24.16 | 23.60 |
| Fₘₐₓ − Fₘᵢₙ | dNm | 18.21 | 25.01 | 24.53 | 23.78 | 22.06 | 20.88 |

Vulcanizate properties (vulcanization at 180° C. for 20 min; no heat treatment at 150° C. for
6 h)

| | | | | | | | |
|---|---|---|---|---|---|---|---|
| Shore A hardness (23° C.) | | 63.8 | 67.5 | 67.7 | 67.2 | 66.2 | 65.7 |
| Shore A hardness (70° C.) | | 59.5 | 63.5 | 64.8 | 64.8 | 63.0 | 61.5 |
| Resilience at 23° C. | % | 45.6 | 45.8 | 46.1 | 46.1 | 47.9 | 48.4 |
| Resilience at 70° C. | % | 55.3 | 60.3 | 59.9 | 59.6 | 59.8 | 60.2 |
| σ₁₀ | MPa | 0.6 | 0.7 | 0.7 | 0.7 | 0.7 | 0.7 |
| σ₂₅ | MPa | 1.1 | 1.2 | 1.2 | 1.2 | 1.1 | 1.2 |
| σ₅₀ | MPa | 1.7 | 2.0 | 2.0 | 2.0 | 1.7 | 1.8 |
| σ₁₀₀ | MPa | 3.9 | 5.6 | 5.4 | 5.1 | 3.9 | 4.1 |
| σ₂₀₀ | MPa | 12.8 | 18.7 | 18.0 | 17.1 | 13.3 | 13.5 |
| σ₃₀₀ | MPa | 21.4 | — | — | — | 23.5 | 23.2 |
| Tensile strength | MPa | 23.4 | 23.6 | 21.6 | 21.8 | 26.4 | 27.4 |
| ε_{b} | % | 330 | 245 | 231 | 239 | 330 | 335 |
| CS (70 h/23° C.) of specimen 1 | % | 15.4 | 9.5 | 10.0 | 10.9 | 13.0 | 14.7 |
| CS (70 h/150° C.) of specimen 1 | % | 24.0 | 12.0 | 21.0 | 22.6 | — | — |
| Goodrich Flexometer/temperature | ° C. | 32.8 | 28.9 | 26.4 | 31.4 | 30.0 | 32.1 |
| increase | | | | | | | |

TABLE 6a
Experiment Series 6a (inventive apart from Example 6.1)
TPP and TPP═S contents after addition of TPP═S on the roll

| Experiment No.: | | 6.1 = 1.1 | 6.1* | 6.2* | 6.3* |
|---|---|---|---|---|---|
| TPP addition in | phr | 0 | 0 | 0 | 0 |
| hydrogenation | | | | | |
| TPP═S addition in mixture | phr | 0 | 1.0 | 2.0 | 3.0 |
| production | | | | | |
| TPP content in HNBR after | % by wt. | <0.01 | <0.01 | <0.01 | <0.01 |
| mixing-in on the roll | | | | | |
| TPP═S content in HNBR | % by wt. | <0.01 | 0.99 | 1.81 | 2.97 |
| after mixing-in on the roll | | | | | |

TABLE 6b
Experiment Series 6b (inventive apart from Example 6.1)
Properties of the mixtures and vulcanizates based on the
hydrogenated nitrile rubbers from Experiment Series 6a

| | | | | |
|---|---|---|---|---|
| Experiment No.: | 6.1 = 1.1 | 6.1* | 6.2* | 6.3* |

Mixture properties

| | | | | | |
|---|---|---|---|---|---|
| ML1 + 4 @ 120° C. | ME | 75 | 73 | 71 | 67 |

Vulcameter at 180° C. (Bayer-Frank vulcameter)

| | | | | | |
|---|---|---|---|---|---|
| t₁₀ | min | 1.4 | 1.4 | 1.5 | 1.4 |
| t₉₀ | min | 6.9 | 7.5 | 7.5 | 7.3 |
| t₉₀ − t₁₀ | min | 5.5 | 6.4 | 6.0 | 5.9 |
| Fₘᵢₙ | cN | 195 | 134 | 149 | 129 |
| Fₘₐₓ | cN | 4994 | 5210 | 5180 | 5160 |
| Fₘₐₓ − Fₘᵢₙ | cN | 4799 | 5076 | 5031 | 5031 |

Vulcanizate properties (vulcanization at 180° C. for 20 min;
then heat treatment at 150° C. for 6 h)

| | | | | | |
|---|---|---|---|---|---|
| Shore A hardness | | 72 | 73 | 73 | 72 |
| (23° C.) | | | | | |
| Shore A hardness | | 70 | 73 | 73 | 72 |
| (70° C.) | | | | | |
| Resilience at 23° C. | % | 36 | 36 | 36 | 36 |
| Resilience at 70° C. | % | 56 | — | — | — |
| σ₁₀₀ | MPa | 5.7 | 6.3 | 6.0 | 6.1 |
| σ₂₀₀ | MPa | 16.0 | 16.5 | 17.0 | 16.4 |
| σ₃₀₀ | MPa | — | — | — | — |
| Tensile strength | MPa | 24.6 | 23.7 | 25.2 | 25.6 |
| ε_{b} | % | 300 | 270 | 295 | 290 |
| CS (70 h/23° C.) of | % | 12.3 | 11.5 | 11.3 | 11.9 |
| specimen 1 | | | | | |
| CS (70 h/150° C.) of | % | 29.4 | 28.7 | 28.9 | 28.4 |
| specimen 1 | | | | | |

The experimental series show that the harmful influence of triphenylphosphine which is used as 3 cocatalyst in the hydrogenation of nitrile rubber on the modulus and compression set values of vulcanized hydrogenated nitrile rubber can be compensated for by addition of sulphur donors. The sulphur donors are added both to the organic solution of the hydrogenated nitrile rubber prior to isolation by steam distillation and to the solid hydrogenated nitrile rubber after the isolation, and show their positive effect in different molar ratios.

1. Hydrogenated nitrile rubbers comprising:
i) 0 to 1.0 wt % of phosphines, diphosphines or mixtures thereof based on the hydrogenated nitrite rubber, and
ii) 0.075 to 10 wt % of phosphine sulphides, diphosphine sulphides or mixtures thereof based on the hydrogenated nitrile rubber.

2. The hydrogenated nitrile rubbers according to claim 1, wherein the nitrile rubber comprises greater than 0 to 1.0 wt % of the phosphines, the diphosphines, or the mixture thereof, and component (i) comprises:
a phosphine of the general formula (1-a), 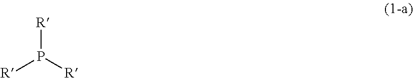
in which
R are the same or different and are each alkyl, alkenyl, alkadienyl, alkoxy, aryl, heteroaryl, cycloalkyl, cycloalkenyl, cycloalkadienyl, halogen or trimethylsilyl, and/or
a diphosphine of the general formula (1-b), 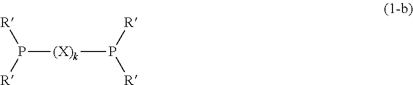
in which
R′ are the same or different and are each alkyl, alkenyl, alkadienyl, alkoxy, aryl, heteroaryl, cycloalkyl, cycloalkenyl, cycloalkadienyl, halogen or trimethylsilyl,
k is 0 or 1, and
X is a straight-chain or branched alkanediyl, alkenediyl or alkynediyl group.

3. The hydrogenated nitrile rubbers according to claim 2, wherein:
the phosphines of the general formula (1-a) are selected from the group consisting of PPh₃, P(p-Tol)₃, P(p-Tol)₃, PPh(CH₃)₂, P(CF₃)₃, P(p-FC₆H₄)₃, P(p-CF₃C₆H₄)₃, P(C₅H₄—SO₃Na)₃, P(CH₂C₆H₄—SO₃Na)₃, P(iso-Pr)₃, P(CHCH₃(CH₂CH₃))₃, P(cyclopentyl)₃, P(cyclohexyl)₃, P(neopentyl)₃, P(C₆H₅CH₂)(C₆H₅)₂, P(NCCH₂CH₂)₂(C₆H₅), P[(CH₃)₃C]₂Cl, P[(CH₃)₃C]₂(CH₃), P(tert-Bu)₂(biph), P(C₆H₁₁)₂Cl, P(CH₃)(OCH₂CH₃)₂, P(CH₂═CHCH₂)₃, P(C₄H₃O)₃, P(CH₂OH)₃, P(m-CH₃OC₆H₄)₃, P(C₆F₅)₃, P[(CH₃)₃Si]₃, and P[(CH₃O)₃C₆H₂]₃, and
the diphosphines of the general formula (1-b) are selected from the group consisting of Cl₂PCH₂CH₂PCl₂, (C₆H₁₁)₂PCH₂P(C₆H₁₁), (CH₃)₂PCH₂CH₂P(CH₃)₂, (C₆H₅)₂PCCP(C₆H₅)₂, (C₆H₅)₂PCH═CHP(C₆H₅)₂, (C₆F₅)₂P(CH₂)₂P(C₆F₅)₂, (C₆H₅)₂P(CH₂)₂P(C₆H₅)₂, (C₆H₅)₂P(CH₂)₃P(C₆H₅)₂, (C₆H₅)₂P(CH₂)₄P(C₆H₅)₂, (C₆H₅)₂P(CH₂)₅P(C₆H₅)₂, (C₆H₅)₂PCH(CH₃)CH(CH₃)P(C₆H₅)₂ and (C₆H₅)₂PCH(CH₃)CH₂P(C₆H₅)₂,
where Ph is phenyl, Tol is tolyl, biph is biphenyl, Bu is butyl and Pr is propyl.

4. The hydrogenated nitrile rubbers according to claim 1, wherein the phosphine component (i) triphenylphosphine.

5. The hydrogenated nitrite rubbers according to claim 1, wherein the phosphine sulphide or diphosphine sulphide component (ii) comprises:
sulphides of phosphines of the general formula (1a) 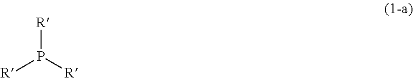
in which
R′ are the same or different and are each alkyl, alkenyl, alkadienyl, alkoxy, aryl, heteroaryl, cycloalkyl, cycloalkenyl, cycloalkadienyl, halogen or trimethylsilyl, and/or
sulphides of diphosphines of the general formula (1-b) 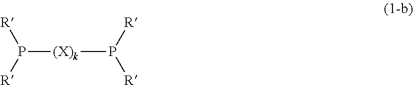
in which
R′ are the same or different and are each alkyl, alkenyl, alkadienyl, alkoxy, aryl, heteroaryl, cycloalkyl, cycloalkenyl, cycloalkadienyl, halogen or trimethylsily,
k is 0 or 1, and
X is a straight-chain or branched alkanediyl, alkenediyl or alkynediyl group.

6. The hydrogenated nitrite rubbers according to claim 1, wherein the phosphine sulphide component (II) is triphenylphosphine sulphide.

7. The hydrogenated nitrile rubbers according to claim 1, wherein the hydrogenated nitrite rubber has repeating units derived from at least acrylonitrile and 1,3-butadiene.

8. A process for producing the hydrogenated nitrile rubbers according to claim 1, the process comprising contacting:
a hydrogenated nitrite rubber having 0.15-5 wt % of phosphines, diphosphines or mixtures thereof based on the hydrogenated nitrile rubber, and
at least one sulphur donor having at least two sulphur atoms covalently bonded directly to one another.

9. The process according to claim 8, wherein at least one of the sulphur donors is a sulphur donor of the general formulae (5a)-(5e) 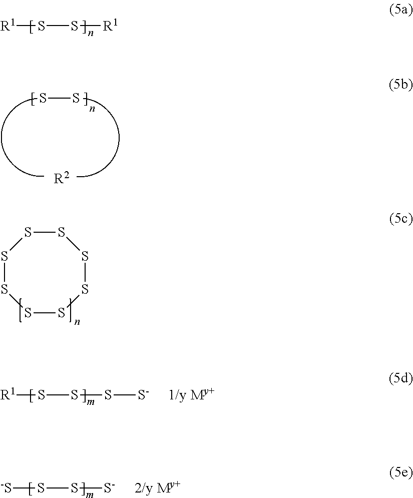
in which
M^{y+} is a y-valently charged cation where y is 1, 2, 3 or 4, and the cation is an alkali metal cation, an alkaline earth metal cation, NH₄⁺ or N(R³)₄⁺ in which R³ is the same or different and is a linear, branched, aliphatic, bridged, cycloaliphatic or wholly or partly aromatic radical,
n is a number from 1 to 1000,
m is a number from 0 to 998,
R¹ is hydrogen or a radical having 1 to 20 carbon atoms, where this radical may contain up to five heteroatoms selected from the group consisting of N, P, S, O and Si, and may be linear, branched, aliphatic, bridged, cycloaliphatic and/or wholly or partly aromatic, and
R² is a divalent radical which has 1 to 20 carbon atoms and may contain up to 5 heteroatoms selected from the group consisting of N, P, S and O, and may be linear, branched, aliphatic, bridged, cycloaliphatic and/or wholly or partly aromatic.

10. The process according to claim 8, wherein the at least one sulphur donor is selected from the group consisting of elemental sulphur in the form of S₈ rings or in the form of polymeric sulphur, which may be in crystalline, semi-crystalline or amorphous form, diphenyl disulphide, di(n-dodecyl) disulphide, di-(tert-dodecyl) disulphide, tetraethylthiuram disulphide, tetrabutylthiuram disulphide, dipentamethylenethiuram tetrasulphide, dimorpholyl disulphide, diethylxanthogen disulphide, diisopropylxanthogen disulphide, di-n-butylxanthogen disulphide, ammonium polysulphide, sodium polysulphide, potassium polysulphide, bis[(5-ethyl-1,3-dioxan-5-yl)methyl]xanthogen disulphide, dibenzothiazyl disulphide, 2-morpholinodithiobenzothiazole, bis(triethoxysilylpropyl) polysulphides in which the chain length of the sulphur is from 2 to 4, and bis(silatranylalkyl) polysulphides.

11. The process according to claim 8, wherein the molar amount of sulphur donor (calculated as S) is 5 to 300% of the molar amount of the phosphine or diphosphine.

12. The process according to claim 8, wherein at least 50 mol % of the phosphines or diphosphines are converted to phosphine sulphides or diphosphine sulphides.

13. The process according to claim 8, further comprising:
(1) catalytically hydrogenating a nitrile rubber in organic solution and in the presence of a phosphine or diphosphine, wherein the phosphine or diphosphine (a) is present as a ligand in the hydrogenation catalyst without further addition of phosphine or diphosphine as a cocatalyst, or (b) is present as a ligand in the hydrogenation catalyst and additionally is added as a cocatalyst, or (c) is added as a cocatalyst, but with no phosphine or diphosphine present as ligand(s) in the hydrogenation catalyst, and
(2) contacting the hydrogenated nitrile rubber obtained, before, during or after isolation of the hydrogenated nitrile rubber, with the at least one sulphur donor separate mixing operation.

14. The process according to claim 13, wherein the hydrogenation is done in the presence of a hydrogenation catalyst selected from the group consisting of tris(triphenylphosphine)rhodium(I) chloride, tris(triphenylphosphine)rhodium(III) chloride, tris(dimethyl sulphoxide)rhodium(III) chloride, hydridorhodiumtetrakis(triphenylposphine) and corresponding compounds in which triphenylphosphine has been replaced wholly or partly by tricyclohexylphosphine.

15. Vulcanizable mixtures comprising at least one hydrogenated nitrile rubber according to claim 1 and at least one crosslinking system comprising at least one crosslinker and optionally one or more crosslinking accelerators.

16. A process for producing vulcanizates, the process comprising vulcanizing the vulcanizable mixture according to claim 15 in the course of a shaping process, at a temperature of 100° C. to 200° C.

17. Vulcanizates obtained by the process according to claim 16.

18. The nitrile rubber according to claim 2, wherein:
the nitrile rubber comprises greater than 0 to 0.8 wt % of component (i), and 0.2 to 8 wt % of component (ii), based on the hydrogenated nitrile rubber;
the phosphines of component (i) and the phosphine of the phosphine sulfides of component (ii) are selected from the group consisting of PPh₃, P(p-Tol)₃, P(o-Tol)₃, PPh(CH₃)₂, P(CF₃)₃, P(p-FC₆H₄)₃, P9p-CF₃C₆H₄)₃, P(C₆H₄—SO₃Na)₃, P(CH₂C₆H₄—SO₃Na)₃, P(iso-PR)₃, P(CHCH₃(CH₂CH₃))₃, P(cyclopentyl)₃, P(cyclohexyl)₃, P(neopentyl)₃, P(C₆H₅CH₂)(C₆H₅)₂, P(NCCH₂CH₂)₂(C₆H₅), P[(CH₃)₃C]₂Cl, P[(CH₃)₃C]₂(CH₃), P(tert-Bu)₂(biph), P(C₆H₁₁)₂Cl, P(CH₃)(OCH₂CH₃)₂, P(CH₂═CHCH₂)₃, P(C₄H₃O)₃, P(CH₂OH)₃, P(m-CH₃OC₆H₄)₃, P(C₆F₅)₃, P[(CH₃)₃Si]₃, and P[(CH₃O)₃C₆H₂]₃, and
the diphosphines of component (i) and the diphosphines of the diphosphine sulfides of component (ii) are selected from the group consisting of Cl₂PCH₂CH₂PCl₂, (C₆H₁₁)₂PCH₂P(C₆H₁₁), (CH₃)₂PCH₂CH₂P(CH₃)₂, (C₆H₅)₂PCCP(C₆H₅)₂, (C₆H₅)₂PCH═CHP(C₆H₅)₂, (C₆F₅)₂P(CH₂)₂P(C₆F₅)₂, (C₆H₅)₂P(CH₂)₂P(C₆H₅)₂, ((C₆H₅)₂P(CH₂)₃P(C₆H₅)₂, (C₆H₅)₂P(CH₂)₄P(C₆H₅)₂, (C₆H₅)₂P(CH₂)₅P(C₆H₅)₂, (C₆H₅)₂PCH(CH₃)CH(CH₃)P(C₆H₅)₂, and (C₆H₅)₂PCH(CH₃)CH₂P(C₆H₅)₂,
where Ph is phenyl, Tol is tolyl, biph is biphenyl, Bu is butyl and Pr is propyl.

19. The nitrile rubber according to claim 18, wherein:
the nitrile rubber comprises greater than 0 to 0.4 wt % of component (i), and 0.4 to 5 wt % of component (ii), based on the hydrogenated nitrile rubber;
the phosphine component (i) is triphenylphosphine;
the phosphine sulphide component (ii) is triphenylphosphine sulphide; and
the hydrogenated nitrile rubber has repeating units derived from acrylonitriie and 1,3-butadiene, or from acrylonitrile, 1,3-butadiene and one or more α,β-unsaturated mono- or dicarboxylic acid(s), or esters or amides thereof.

20. The nitrile rubber according to claim 19, wherein the hydrogenated nitrile rubber has repeating units derived from acrylonitrile, 1,3-butadiene, and one or more alkyl esters of an α,β-unsaturated carboxylic acid selected from the group consisting of methyl (meth)acrylates ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate and lauryl (meth)acrylate.
